(19) United States
(12) Patent Application Publication
(10) Pub. No.: US 2009/0027603 A1
(43) Pub. Date: Jan. 29, 2009

(54) Low Surface Energy Polymeric Material for Use in Liquid Crystal Displays

(76) Inventors: Edward T. Samulski, Chapel Hill, NC (US); Joette Russell Tanner, Durham, NC (US); Ginger Denison Rothrock, Durham, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 11/883,304

(22) PCT Filed: Feb. 3, 2006
(86) PCT No.: PCT/US2006/003983

§ 371 Date: May 19, 2008

Related U.S. Application Data
(60) Provisional application No. 60/649,494, filed on Feb. 3, 2005.
(60) Provisional application No. 60/649,495, filed on Feb. 3, 2005.

(51) Int. Cl. G02F 1/1337

(52) U.S. Cl. 349/124; 349/123; 428/1.2

(57) ABSTRACT

Generally, the presently disclosed subject matter relates to a liquid crystal display including one or more layers of a polymeric material. More particularly, the polymeric material is a low surface energy polymer material fabricated from a mold.

### CROSS REFERENCE TO RELATED APPLICATIONS

This application is based on and claims priority to U.S. Provisional Patent Application Ser. No. 60/649,494, filed Feb. 3, 2005, and U.S. Provisional Patent Application Ser. No. 60/649,495, filed Feb. 3, 2005, each of which is incorporated herein by reference in its entirety.

### INCORPORATION BY REFERENCE

All documents referenced herein are hereby incorporated by reference as if set forth in their entirety herein, including all references cited therein.

### GOVERNMENT INTEREST

The presently disclosed subject matter was made with U.S. Government support from Office of Naval Research No. N000140210185 and STC program of the National Science Foundation under Agreement No. CHE-9876674. The U.S. Government has certain rights in the presently disclosed subject matter.

### TECHNICAL FIELD

Generally, the presently disclosed subject matter relates to a liquid crystal display including one or more layers of a polymeric material. More particularly, the polymeric material is a low surface energy polymer material fabricated from a mold.

### ABBREVIATIONS

AC=alternating current
Ar=Argon
° C.=degrees Celsius
cm=centimeter
8-CNVE=perfluoro(8-cyano-5-methyl-3,6-dioxa-1-octene)
CSM=cure site monomer
CTFE=chlorotrifluoroethylene
g=grams
h=hours
1-HPFP=1,2,3,3,3-pentafluoropropene
2-HPFP=1,1,3,3,3-pentafluoropropene
HFP=hexafluoropropylene
HMDS=hexamethyldisilazane
IL=imprint lithography
IPDI=isophorone diisocyanate
MCP=microcontact printing
Me=methyl
MEA=membrane electrode assembly
MEMS=micro-electro-mechanical system
MeOH=methanol
MIMIC=micro-molding in capillaries
mL=milliliters
mm=millimeters
mmol=millimoles
Mₙ=number-average molar mass
m.p.=melting point
mW=milliwatts
NCM=nano-contact molding
NIL=nanoimprint lithography
nm=nanometers
Pd=palladium
PAVE=perfluoro(alkyl vinyl)ether
PDMS=poly(dimethylsiloxane)
PEM=proton exchange membrane
PFPE=perfluoropolyether
PMVE=perfluoro(methyl vinyl)ether
PPVE=perfluoro(propyl vinyl)ether
PSEPVE=perfluoro-2-(2-fluorosulfonylethoxy)propyl vinyl ether
PTFE=polytetrafluoroethylene
SAMIM=solvent-assisted micro-molding
SEM=scanning electron microscopy
Si=silicon
TFE=tetrafluoroethylene
pm=micrometers
UV=ultraviolet
W=watts
ZDOL=poly(tetrafluoroethylene oxide-co-difluoromethylene oxide)α,ω diol

### BACKGROUND

Typically, in a liquid crystal display (“LCD”), the liquid crystals are sandwiched between two glass plates coated with both a conducting layer and an alignment layer. Additional components of the display include various optical layers such as a polarizer, analyzer, and a color filter and backlight. Obtaining stable and uniform alignment of liquid crystals on a macroscopic scale is essential to the high-quality operation of LCDs. Liquid crystal alignment determines the electro-optical switching mode and speed of the display and good alignment prevents the formation of random multidomains caused by mismatches in liquid crystal director (symmetry axis) orientation that deteriorate the displayed image. The alignment layer imposes the proper orientation on the liquid crystals. Conventionally, this orienting effect is achieved by mechanically rubbing the alignment layer with either synthetic or natural fabric, a rather primitive technique that generates dust and often results in irreversible electrostatic damage to the electronic components of the display. Thus, there is a demand for non-contact alignment techniques.

The fundamental unit of the LCD is the liquid crystal (LC) pixel, which can be operated in either a bright or dark state. A typical pixel consists of a light source, two polarizers oriented 90° with respect to one another, two conductive and transparent substrates coated with an alignment layer, which are also oriented 90° with respect to one another, and the LC layer. In the bright state, the alignment layer determines the orientation of the LC molecules. Plane polarized light is generated as light passes through the first polarizer. This plane of light is rotated as a function of the LC director orientation and thus, is able to pass through the second polarizer (also called the analyzer) and emit from the other side of the pixel. In the dark state, an electric field is applied across the pixel, orienting the LC molecules perpendicular to the substrates. The plane polarized light passes through the LC layer parallel to the optic axis of the molecules and is not rotated and thus cannot pass through the analyzer and be emitted. The bright and dark states are also called the off and on states, respectively, in reference to the use of the electric field to reorient the LC director.

Many organic and inorganic materials have been used as alignment layers, utilizing such deposition methods as dip coating, sputtering, and spin coating. As previously discussed, some of these alignment layers require further treatment such as mechanical rubbing to induce unidirectional alignment. Others can spontaneously induce alignment.

When analyzing liquid crystalline materials by transmitted polarized light microscopy, the optical texture that is observed depends not only on the molecular organization of the sample, but also on the alignment of the sample with respect to the substrate. There are two modes of liquid crystal alignment. Planar alignment occurs when the LC director orients parallel to the substrate and is confirmed by the appearance of alternating dark and bright states at 45° intervals of sample rotation. Homeotropic alignment involves the orientation of the director perpendicular to the substrate. With homeotropic alignment, the molecules are oriented on average with their long axes and more importantly, their optic axes perpendicular to the substrate. Thus, as the polarized light propagates through the sample it travels along the optic axis, experiencing only one index of refraction and therefore, no change in its polarization state. With the analyzer rotated 90° with respect to the polarizer, no light is observed. Therefore, confirmation of homeotropic alignment requires insertion of the Bertrand lens into the light path, allowing a view of the objective back focal plane in which a diffraction pattern or conoscopic image is observed.

Polyimide alignment layers are the current standard for liquid crystal displays. This material has several advantages, including simple layer preparation (i.e. polyimide is a liquid at room temperature and thus easily deposited as a thin film by spin-coating), high chemical and thermal resistance, good adhesion to glass and oxide substrates, and potential for modification of the chemical structure and thus modification of the alignment characteristics.

Typically, alignment involves modification of a solid substrate such that its interface with the LC has some anchoring action that results in either planar (tangential) or homeotropic (perpendicular) orientation of the LC director with respect to the interface. Such modification is carried out on a substrate having an electrically conductive layer (usually indium tin oxide or ITO-coated glass) for electric-field-induced reorientation of the director which in turn results in a variation in the transmitted light intensity. Currently, the preferred modification technique is rather primitive: the conductive substrate is coated with a polyimide layer that after thermal curing is mechanically rubbed. The alignment mechanism associated with unidirectional rubbing has contributions from both the physical grooves caused by rubbing the polyimide substrate and the putative molecular interactions between exposed polyimide functionalities and the LC. However, the details of LC alignment are not well understood.

As the polyimide film is mechanically rubbed with a synthetic or natural fabric, microscopic and nanoscopic grooves are scratched into the surface. The elastic energy costs associated with aligning the director either parallel or perpendicular to the grooves determines the preferred alignment direction. The energy costs associated with the director aligning parallel to the grooves are much lower, thus explaining planar alignment of the LC parallel to the rubbing direction. Additional contributions to this preferred alignment direction can come from interactions between the exposed polyimide functionalities and the LC. It is possible that the orientation of the molecular chains of the polymer is altered (elongated and aligned in the rubbing direction) in the rubbing process due to local heating and simultaneous shearing force. The exposed functionalities of these oriented polyimide chains are then free to interact with the LC, thus reinforcing the preference for planar alignment parallel to the rubbing direction.

### SUMMARY

In one embodiment, the presently disclosed subject matter encompasses a liquid crystal display that includes a layer of a low surface energy polymeric material. In an illustrative embodiment, the low surface energy polymeric material includes at least one layer. In another illustrative embodiment, the low surface energy polymeric material includes two or more layers. In another illustrative embodiment, the layers are alignment layers.

According to some embodiments, the low surface energy polymeric material has a surface energy of less than about 30 mN/m, and in other embodiments the surface energy is between about 7 mN/m and about 20 mN/m. According to some embodiments, the low surface energy polymeric material is perfluoropolyether (PFPE), fluoroolefin-based fluoroelastomers, poly(dimethylsiloxane) (PDMS), poly(tetramethylene oxide), poly(ethylene oxide), poly(oxetanes), polyisoprene, polybutadiene, or mixtures thereof.

In some embodiments, the liquid crystal display further includes a second alignment layer and the second alignment layer can be coupled with the first alignment layer. The liquid crystal display can have liquid crystal dispersed between the first alignment layer and the second alignment layers in some embodiments.

According to some embodiments, the first alignment layer is spaced apart from the second alignment layer less than 100 μm. In other embodiments, the first alignment layer is spaced apart from the second alignment layer between about 20 μm and about 80 μm. In yet other embodiments, the first alignment layer is spaced apart from the second alignment layer about 40 μm. According to some embodiments, the first alignment layer and the second alignment layer are positioned at an angle with respect to one another, and in other embodiments, the first alignment layer and the second alignment layer are oriented at about a 90 degree angle with respect to one another.

In other embodiments, the low surface energy polymeric material includes a patterned surface. Sometimes the patterned surface includes grooves and the grooves can be between about 0.1 μm and about 2 μm in width, other times between about 0.3 μm and about 0.7 μm in width, and at other times less than about 2 meters in length. In some embodiments, the grooves are less than about 2 cm in length. In some embodiments, the grooves are less than the pixel width (sub-pixel patterning).

According to some embodiments, the patterned surface includes a regular grid pattern. In some embodiments, the low surface energy polymeric material defines a plurality of through holes and the through holes can have an average diameter of less than about 10 μm, average diameter of between about 20 nm and about 10 μm, or average diameter of between about 0.1 μm and about 7 μm.

In some embodiments, the liquid crystal display includes a second alignment layer, where the first and second alignment layers have a pattern on a surface thereof. In some embodiments, the pattern on the first alignment layer is different from the pattern on the second alignment layer. In some embodiments, the alignment layer is configured as a Langmuir-Blodgett film and includes multiple thin film layers of a fluorinated polymer.

According to some embodiments, the liquid crystal display includes a patterned surface that includes between about 1000 grooves per mm and about 4000 grooves per mm. In other embodiments, the patterned surface includes between about 1200 grooves per mm and about 3600 grooves per mm. In yet other embodiments, the patterned surface includes more than about 1200 grooves per mm. Still in other embodiments, the patterned surface includes less than about 3600 grooves per mm.

In some embodiments, the low surface energy polymeric material further includes a photo-curable agent. In other embodiments, the low surface energy polymeric material further includes a thermal-curable agent. In still other embodiments, the low surface energy polymeric material further includes photo-curable and thermal-curable agents.

According to some embodiments, the liquid crystal display includes a microphase separated structure, a copolymer, and a block copolymer.

In alternative embodiments, the liquid crystal display includes a layer of low surface energy polymeric material, where the layer is treated. In some embodiments the treatment of the layer of low surface energy polymeric materials is selected from an electrical conductor, metal nanoparticles, metal oxide, conducting polymer, toluene, and water.

According to some embodiments of the presently disclosed subject matter, a display screen includes a low surface energy polymeric alignment layer and the display screen is flexible. In other embodiments, a display screen includes a low surface energy polymeric alignment layer, where liquid crystals of the display screen undergo spontaneous alignment on the low surface energy polymeric alignment layer.

According to other embodiments, the liquid crystal display includes a low-molar-mass liquid crystal dispersed between the first alignment layer and the second alignment layer. In some embodiments, the low-molar-mass liquid crystal is between about 100 and 2000 molecular weight.

In some embodiments, the alignment layer is less than about 1,000 nm in thickness. In other embodiments, the alignment layer is between about 10 angstroms and about 1,000 angstroms thick. In still further embodiments, the alignment layer is between about 5 angstroms and about 200 angstroms thick.

In other embodiments, the alignment of the liquid crystals changes with an applied voltage.

According to some embodiments, a method of fabricating a display screen alignment layer includes providing a patterned template, depositing a low surface energy polymeric material in liquid form onto the patterned template, where the liquid polymer comprises a curing agent, activating the curing agent to cure the liquid low surface energy polymeric material, and removing the cured low surface energy polymeric material from the patterned template, where a replica of the patterned template is embossed on a surface of the cured low surface energy polymeric material. In some embodiments, the curing agent can be, for example, a photo-curing agent, a thermal-curing agent, both photo-curable and thermal-curable agents, combinations thereof, and the like. In other embodiments, the method further includes a low-molar-mass liquid crystal into communication with the embossed pattern of the cured low surface energy polymeric material.

According to some embodiments, a pixel includes a layer of low surface energy polymeric material, where a surface of the layer comprises a molded pattern configured thereon. In some embodiments, the curing agent can be, for example, a photo-curing agent, a thermal-curing agent, both photo-curable and thermal-curable agents, combinations thereof, and the like. In some embodiments, the low surface energy polymeric material includes perfluoropolyether (PFPE) and there can be a low-molar-mass liquid crystal in communication with the molded pattern of the low surface energy polymeric material.

In some embodiments, the pixel includes grooves molded on a surface of the alignment layer. According to some embodiments, the grooves can be between about 0.1 μm and about 2 μm in width. In other embodiments, the grooves can be between about 0.3 μm and about 0.7 μm in width. In some embodiments, the grooves can be less than about 2 meters in length. In other embodiments, the grooves can be less than about 2 cm in length. In yet other embodiments, the molded pattern includes a regular pattern and in some embodiments, the molded pattern defines a plurality of through-holes. In some embodiments, the through-holes have an average diameter of less than about 20 μm. In yet other embodiments, the molded pattern includes between about 1000 grooves per mm and about 4000 grooves per mm and in some embodiments, the molded pattern includes between about 1200 grooves per mm and about 3600 grooves per mm.

According to other embodiments, the layer is between about 10 angstroms and about 1,000 angstroms thick. In other embodiments, the layer is between about 5 angstroms and about 200 angstroms thick.

### BRIEF DESCRIPTION OF THE DRAWINGS

FIGS. 1A-1C show a schematic of a method of forming a patterned layer of a base material, according to an embodiment of the presently disclosed subject matter;

FIGS. 2A-2D show a schematic representation of a preparation of a multi-layered device according to an embodiment of the presently disclosed subject matter;

FIGS. 3A-3C show a method for adhering a layer of base material to a substrate, according to an embodiment of the presently disclosed subject matter;

FIGS. 4A-4C show a method for adhering a patterned layer of base material to another patterned layer of base material, according to an embodiment of the presently disclosed subject matter;

FIGS. 5A-5E show a method for making a multilayered device, according to an embodiment of the presently disclosed subject matter;

FIGS. 6A-6D show a method for forming a microstructure by using a sacrificial layer of a degradable or selectively soluble material, according to an embodiment of the presently disclosed subject matter;

FIGS. 7A-7C show a method for forming a microstructure by using a sacrificial layer of a degradable or selectively soluble material, according to an embodiment of the presently disclosed subject matter;

FIG. 8 is a schematic representation of a liquid crystal display pixel, showing two display operation modes (bright (left side) and dark (right side) states), according to an embodiment of the presently disclosed subject matter;

FIG. 9 is a schematic representation of a step-wise preparation of a thin film polymer alignment layer and liquid crystal optical cell, according to an embodiment of the presently disclosed subject matter;

FIGS. 10A-10D shows a method of making an alignment layer having a pattern mirroring a patterned template, according to an embodiment of the presently disclosed subject matter;

FIGS. 11A and 11B are optical images of photo-cured PFPE embossed with square micro-wells, approximately 5 micron per side, according to an embodiment of the presently disclosed subject matter;

FIG. 12 is a schematic representation of a fabrication of encapsulated liquid crystal “bubbles” showing a PFPE sheet 1200 embossed with micro-wells; a second smooth PFPE sheet 1202 (wet with PFPE precursor for subsequent photo-cured seal); a liquid crystal fluid 1206; and a source 1210 for curing and/or sealing of liquid crystal filled “bubbles,” according to an embodiment of the presently disclosed subject matter;

FIG. 13 is a comparison of surface energies of PFPE and other fluorinated alignment layers with several typical alignment layers, such as Teflon AF, perfluorosilane, DMOAP, CTAB, polyimide and clean ITO, the surface energy of PFPE is much lower than standard alignment layers currently used and the liquid crystal alignment mode achieved with each type of alignment layer for both positive and negative dielectric liquid crystals is noted in the FIG. (e.g., 5CB:homeotropic, MLC-6608:planar [symbol] ; 5CB and MLC-6608:homeotropic [symbol] ; and 5CB and MLC-6608:planar [symbol] );

FIG. 14 is a polarizing micrograph of a birefringent texture of a positive dielectric nematic liquid crystal on PFPE showing a spontaneous homeotropic alignment generated by PFPE (see inset), according to an embodiment of the presently disclosed subject matter;

FIG. 15, parts A and B show polarizing micrographs comparing birefringent textures of a positive (5CB) and negative dielectric (MLC-6608) liquid crystal on PFPE, part A (left panel, 0°; right panel, 45°) shows a spontaneous homeotropic alignment of a positive dielectric nematic liquid crystal on PFPE and part B (left panel, 00; right panel, 45°) shows a spontaneous planar alignment of a negative dielectric nematic liquid crystal on PFPE, the planar alignment is not uniform, but exhibits random domains, according to an embodiment of the presently disclosed subject matter, where the orientation of the crossed polarizers are given by the arrows;

FIG. 16, parts A and B are polarizing micrographs of liquid crystal alignment on PFPE alignment layers pretreated with toluene, part A (left panel, 0°; right panel, 45°) shows spontaneous homeotropic alignment of a positive dielectric nematic liquid crystal (5CB) (see inset), and part B (left panel, 0°; right panel, 45°) shows spontaneous homeotropic alignment of a negative dielectric nematic liquid crystal (MLC-6608) (see inset), according to an embodiment of the presently disclosed subject matter, where the orientation of the crossed polarizers is given by the arrows;

FIG. 17, parts A and B are polarizing micrographs of liquid crystal alignment on PFPE alignment layers pretreated with water, part A (left panel, 0°; right panel, 45° ) shows random domains of planar alignment of a positive dielectric nematic liquid crystal (5CB) and part B (left panel, 0°; right panel, 45°) shows random domains of planar alignment of a negative dielectric nematic liquid crystal (MLC-6608), according to an embodiment of the presently disclosed subject matter, where the orientation of the crossed polarizers is given by the arrows;

FIG. 18, parts A, B, and C are polarizing micrographs of liquid crystal alignment on PFPE films prepared by Langmuir-Blodgett (LB) method, part A (left panel, 0°; right panel, 45° ) shows planar of alignment of a nematic liquid crystal on a PFPE LB film of 1-layer thickness and parts B and C (for each: left panel, 0°; right panel, 45° ) show planar alignment of a nematic liquid crystal on a PFPE LB film of 5-layer thickness and 10-layer thickness, respectively, according to an embodiment of the presently disclosed subject matter, where the orientation of the crossed polarizers are given by the arrows;

FIG. 19 is a tabular summary of results of experiments in which PFPE alignment layers were pretreated by either toluene or water, according to an embodiment of the presently disclosed subject matter;

FIG. 20 is a schematic representation of preparation of a grooved PFPE alignment layer by embossing, according to an embodiment of the presently disclosed subject matter;

FIGS. 21A and 21B shows a patterned template and a molded mirror image of the patterned template fabricated in base material of the presently disclosed subject matter, according to an embodiment of the presently disclosed subject matter;

FIG. 22, parts A and B are atomic force microscopy images of a diffraction grating master and PFPE replica, the sinusoidal grooves of the diffraction grating are exactly replicated, according to an embodiment of the presently disclosed subject matter;

FIG. 23 is a set of polarizing micrographs (left panel, 0°; right panel, 45°) of planar liquid crystal alignment on an embossed PFPE film such as that shown in FIG. 22, where the orientation of the crossed polarizers are given by the arrows;

FIGS. 24A and 24B (left panel, 0°; right panel, 45°) are polarizing micrographs of planar liquid crystal alignment on a PFPE film embossed with a sharkskin pattern, such as the pattern represented in FIG. 21, according to an embodiment of the presently disclosed subject matter, where the orientation of the crossed polarizers are given by the arrows and FIG. 24A is at 10× magnification and FIG. 24B is at 40× magnification;

FIG. 25 is a schematic representation of a thin-film transistor (TFT) often used in color displays, according to an embodiment of the presently disclosed subject matter; and

FIG. 26 shows schematically a display screen and a microprocessor controller for the display screen, according to an embodiment of the presently disclosed subject matter.

### DETAILED DESCRIPTION

The presently disclosed subject matter will now be described more fully hereinafter with reference to the accompanying Drawings and Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist.

### I. DEFINITIONS

As used herein, the term “pattern” can mean a channel, openings, orefices, grooves, texturing, micro-channels, nano-channels, and the like, wherein in some embodiments the patterning structure can intersect and/or overlap at predetermined points. A pattern also can include one or more of a micro- or nano-scale fluid reservoir, a micro- or nano-scale reaction chamber, a micro- or nano-scale mixing chamber, a micro- or nano-scale separation region, a surface texture, a pattern on a surface that can include micro and/or nano recesses and/or projections. The surface pattern can be regular or irregular.

As used herein, the term “intersect” can mean to meet at a point, to meet at a point and cut through or across, or to meet at a point and overlap. More particularly, as used herein, the term “intersect” describes an embodiment wherein two patterning structures meet at a point, meet at a point and cut through or across one another, or meet at a point and overlap one another, and the like. Accordingly, in some embodiments, two patterns can intersect, i.e., meet at a point or meet at a point and cut through one another, and be in fluid communication with one another. In some embodiments, two or more patterns can intersect, i.e., meet at a point and overlap one another, and not be in fluid communication with one another, for example, as is the case when a flow channel and a control channel intersect.

As used herein, the term “communicate” (e.g., a first component “communicates with” or “is in communication with” a second component) and grammatical variations thereof are used to indicate a structural, functional, mechanical, electrical, optical, or fluidic relationship, or any combination thereof, between two or more components or elements. As such, the fact that one component is said to communicate with a second component is not intended to exclude the possibility that additional components can be present between, and/or operatively associated or engaged with, the first and second components.

As used herein, the term “monolithic” refers to a structure having or acting as a single, uniform structure.

As used herein, the term “non-biological organic materials” refers to organic materials, i.e., those compounds having covalent carbon-carbon bonds, other than biological materials. As used herein, the term “biological materials” includes nucleic acid polymers (e.g., DNA, RNA), amino acid polymers (e.g., enzymes, proteins, and the like) and small organic compounds (e.g., steroids, hormones) wherein the small organic compounds have biological activity, especially biological activity for humans or commercially significant animals, such as pets and livestock, and where the small organic compounds are used primarily for therapeutic or diagnostic purposes. While biological materials are of interest with respect to pharmaceutical and biotechnological applications, a large number of applications involve chemical processes that are enhanced by other than biological materials, i.e., non-biological organic materials.

As used herein, the term “partial cure” refers to a process wherein less than about 100% of the polymerizable groups are reacted. Thus, the term “partially-cured material” refers to a material which has undergone a partial cure process.

As used herein, the term “full cure” refers to a process wherein about 100% of the polymerizable groups are reacted. Thus, the term “fully-cured material” refers to a material which has undergone a full cure process.

As used herein, the term “photocured” refers to the reaction of polymerizable groups whereby the reaction can be triggered by actinic radiation, such as UV light. In this application UV-cured can be a synonym for photocured.

As used herein, the term “thermal cure” or “thermally cured” refers to the reaction of polymerizable groups, whereby the reaction can be triggered by heating the material beyond a threshold.

Following long-standing patent law convention, the terms “a”, “an”, and “the” refer to “one or more” when used in this application, including the claims. Thus, for example, reference to “an alignment layer” includes a plurality of such alignment layers, and so forth.

### II. MATERIALS

The presently disclosed subject matter broadly encompasses and employs solvent resistant, low surface energy polymeric materials, derived from casting low viscosity liquid materials onto a master template and then curing the low viscosity liquid materials to generate a patterned template for use in high-resolution soft or imprint lithographic applications, such as micro- and nanoscale replica molding. In some embodiments, the patterned template comprises a solvent resistant, elastomer-based material, such as but not limited to a fluorinated elastomer-based materials.

Further, the presently disclosed subject matter describes and employs nano-contact molding of organic materials to generate high fidelity features using an elastomeric mold. Accordingly, the subject matter encompasses and employs a method for producing free-standing, isolated micro- and nanostructures of any shape using, for example, soft or imprint lithography techniques.

The nanostructures described by the presently disclosed subject matter can be used in several applications, including, but not limited to, materials for displays, including LCDs; photovoltaics; a solar cell device; and optoelectronic devices. Further, liquid crystal display screens, such as those described herein, can be used in, for example, LCD TV, automobile monitors, PDA, plasma TV, viewfinders, projectors, games, industrial applications, mobile telephones, notebook PCs, mp3 players, desktop monitors, other portable devices, and the like.

In certain embodiments, the presently disclosed subject matter broadly describes and employs solvent resistant, low surface energy polymeric materials. According to some embodiments the low surface energy polymeric materials include, but are not limited to perfluoropolyether (PFPE), poly(dimethylsiloxane) (PDMS), poly(tetramethylene oxide), poly(ethylene oxide), poly(oxetanes), polyisoprene, polybutadiene, fluoroolefin-based fluoroelastomers, and the like.

For the sake of simplicity, such solvent resistant, low surface energy polymeric materials are collectively referred to, herein, as base materials or base polymers. It will be appreciated that the materials and techniques disclosed herein, can be applied to and utilize any of the materials, polymers, urethanes, silicons, and the like, disclosed herein. For simplification purposes, many of the description will focus on PFPE materials, however, it is not the intent of the disclosure to limit the disclosure to PFPE materials, and it will be appreciated that other such polymers can be equally applied to the methods, materials, and devices of the presently disclosed subject matter.

Representative solvent resistant elastomer-based materials include but are not limited to fluorinated elastomer-based materials. As used herein, the term “solvent resistant” refers to a material, such as an elastomeric material that neither swells nor dissolves in common hydrocarbon-based organic solvents or acidic or basic aqueous solutions. Examples of some common hydrocarbon-based organic solvents or acidic or basic aqueous solutions are, but not limited to, water, isopropyl alcohol, acetone, N-methyl pyrollidinone, and dimethyl formamide, and the like. Representative fluorinated elastomer-based materials include but are not limited to perfluoropolyether (PFPE)-based materials.

In certain embodiments, base materials, such as for example, functional liquid PFPE materials exhibit desirable properties for use in a Liquid Crystal display device. For example, base materials such as functional PFPE materials typically have low surface energy, are non-toxic, UV and visible light transparent, highly gas permeable; cure into a tough, durable, highly fluorinated elastomeric or glassy materials with excellent release properties, resistant to swelling, solvent resistant, biocompatible, combinations thereof, and the like. The properties of these materials can be tuned over a wide range through the judicious choice of additives, fillers, reactive co-monomers, and functionalization agents, examples of which are described further herein. Such properties that are desirable to modify, include, but are not limited to, modulus, tear strength, surface energy, permeability, functionality, mode of cure, solubility, toughness, hardness, elasticity, swelling characteristics, combinations thereof, and the like. Some examples of methods of adjusting mechanical and or chemical properties of the finished material includes, but are not limited to, shortening the molecular weight between cross-links to increase the modulus of the material, adding monomers that form polymers of high glass transition temperature (Tg) to increase the modulus of the material, adding charged monomer or species to the material to increase the surface energy or wettability of the material, combinations thereof, and the like. Further examples include adding photo-curable and/or thermal curable components to the base materials of the presently disclosed subject matter such that the base materials can be subjected to multiple curing techniques.

According to some embodiments, base materials of the presently disclosed subject matter are configured with surface energy below about 30 mN/m. According to other embodiments the surface energy is between about 7 mN/m and about 20 mN/m. According to more preferred embodiments, the surface energy is between about 10 mN/m and about 15 mN/m. The non-swelling nature and easy release properties of the presently disclosed base materials, such as PFPE materials, allow for the fabrication of alignment layer devices.

An example of casting a device with such base materials includes casting liquid PFPE precursor materials onto a patterned substrate and then curing the liquid PFPE precursor materials to generate a patterned layer of functional PFPE material, which can be used to form a device, such as an alignment layer for a liquid crystal display, a medical device, a microfluidic device, an anti-fouling layer or coating, or the like.

### II.A. Perfluoropolyether materials prepared from a liquid PFPE precursor material having a viscosity less than about 100 centistokes

As would be recognized by one of ordinary skill in the art, perfluoropolyethers (PFPEs) have been in use for over 25 years for many applications. Commercial PFPE materials are made by polymerization of perfluorinated monomers. The first member of this class was made by the cesium fluoride catalyzed polymerization of hexafluoropropene oxide (HFPO) yielding a series of branched polymers designated as KRYTOX® (DuPont, Wilmington, Del., United States of America). A similar polymer is produced by the UV catalyzed photo-oxidation of hexafluoropropene (FOMBLIN® Y) (Solvay Solexis, Brussels, Belgium). Further, a linear polymer (FOMBLIN® Z) (Solvay) is prepared by a similar process, but utilizing tetrafluoroethylene. Finally, a fourth polymer (DEMNUM®) (Daikin Industries, Ltd., Osaka, Japan) is produced by polymerization of tetrafluorooxetane followed by direct fluorination. Structures for these fluids are presented in Table I. Table II contains property data for some members of the PFPE class of lubricants. Likewise, the physical properties of functional PFPEs are provided in Table Ill. In addition to these commercially available PFPE fluids, a new series of structures are being prepared by direct fluorination technology. Representative structures of these new PFPE materials appear in Table IV. Of the abovementioned PFPE fluids, only KRYTOX® and FOMBLIN® Z have been extensively used in applications. See Jones, W. R., Jr., The Properties of Perfluoropolyethers Used for Space Applications, NASA Technical Memorandum 106275 (July 1993), which is incorporated herein by reference in its entirety. Accordingly, the use of such PFPE materials is provided in the presently disclosed subject matter.

TABLE I
NAMES AND CHEMICAL STRUCTURES
OF COMMERCIAL PFPE FLUIDS

| NAME | Structure |
|---|---|
| DEMNUM ® | C₃F₇O(CF₂CF₂CF₂O)ₓC₂F₅ |
| KRYTOX ® | C₃F₇O[CF(CF₃)CF₂O]ₓC₂F₅ |
| FOMBLIN ® Y | C₃F₇O[CF(CF₃)CF₂O]ₓ(CF₂O)_{y}C₂F₅ |
| FOMBLIN ® Z | CF₃O(CF₂CF₂O)ₓ(CF₂O)_{y}CF₃ |

TABLE II
PFPE PHYSICAL PROPERTIES

| | Average | Viscosity | | Pour | Vapor Pressure, | |
|---|---|---|---|---|---|---|
| | Molecular | at 20° C., | Viscosity | Point, | Torr | |
| Lubricant | Weight | (cSt) | Index | ° C. | 20° C. | 100° C. |
| FOMBLIN ® | 9500 | 255 | 355 | −66 | 2.9 × 10⁻¹² | 1 × 10⁻⁸ |
| Z-25 | | | | | | |
| KRYTOX ® | 3700 | 230 | 113 | −40 | 1.5 × 10⁻⁶ | 3 × 10⁻⁴ |
| 143AB | | | | | | |
| KRYTOX ® | 6250 | 800 | 134 | −35 | 2 × 10⁻⁸ | 8 × 10⁻⁶ |
| 143AC | | | | | | |
| DEMNUM ® | 8400 | 500 | 210 | −53 | 1 × 10⁻¹⁰ | 1 × 10⁻⁷ |
| S-200 | | | | | | |

TABLE III
PFPE PHYSICAL PROPERTIES OF FUNCTIONAL PFPES

| | Average | Viscosity | | |
|---|---|---|---|---|
| | Molecular | at 20° C., | Vapor Pressure, Torr | |
| Lubricant | Weight | (cSt) | 20° C. | 100° C. |
| FOMBLIN ® | 2000 | 85 | 2.0 × 10⁻⁵ | 2.0 × 10⁻⁵ |
| Z-DOL 2000 | | | | |
| FOMBLIN ® | 2500 | 76 | 1.0 × 10⁻⁷ | 1.0 × 10⁻⁴ |
| Z-DOL 2500 | | | | |
| FOMBLIN ® | 4000 | 100 | 1.0 × 10⁻⁸ | 1.0 × 10⁻⁴ |
| Z-DOL 4000 | | | | |
| FOMBLIN ® | 500 | 2000 | 5.0 × 10⁻⁷ | 2.0 × 10⁻⁴ |
| Z-TETROL | | | | |

TABLE IV
Names and Chemical Structures of Representative PFPE Fluids

| Name | Structure^{a} |
|---|---|
| Perfluoropoly(methylene oxide) (PMO) | CF₃O(CF₂O)ₓCF₃ |
| Perfluoropoly(ethylene oxide) (PEO) | CF₃O(CF₂CF₂O)ₓCF₃ |
| Perfluoropoly(dioxolane) (DIOX) | CF₃O(CF₂CF₂OCF₂O)ₓCF₃ |
| Perfluoropoly(trioxocane) (TRIOX) | CF₃O[(CF₂CF₂O)₂CF₂O]ₓCF₃ |

^{a}wherein x is any integer.

In some embodiments of the presently disclosed subject matter, the perfluoropolyether precursor includes poly(tetrafluoroethylene oxide-co-difluoromethylene oxide)α,ω diol, which in some embodiments can be photocured to form one of a perfluoropolyether dimethacrylate and a perfluoropolyether distyrenic compound. A representative scheme for the synthesis and photocuring of a functionalized perfluoropolyether is provided in Scheme 1.

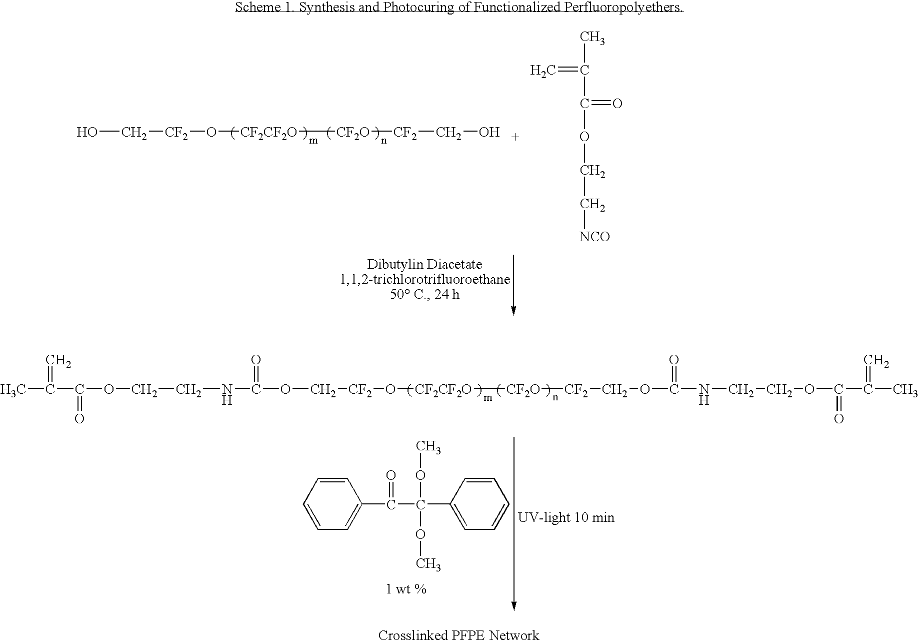

### II.B. Perfluoropolyether materials prepared from a liquid PFPE precursor material having a viscosity greater than about 100 centistokes

The methods provided herein below for promoting and/or increasing adhesion between a layer of a PFPE material and another material and/or a substrate and for adding a chemical functionality to a surface include, in some embodiments, a PFPE material having a characteristic of a viscosity greater than about 100 centistokes (cSt) and a viscosity less than about 100 cSt, provided that the liquid PFPE precursor material having a viscosity less than 100 cSt is not a free-radically photocurable PFPE material. As provided herein, the viscosity of a liquid PFPE precursor material refers to the viscosity of that material prior to functionalization, e.g., functionalization with a methacrylate or a styrenic group.

Thus, in some embodiments, PFPE material is prepared from a liquid PFPE precursor material having a viscosity greater than about 100 centistokes (cSt). In some embodiments, the liquid PFPE precursor is end-capped with a polymerizable group. In some embodiments, the polymerizable group is selected from the group consisting of an acrylate, a methacrylate, an epoxy, an amino, a carboxylic, an anhydride, a maleimide, an isocyanato, an olefinic, and a styrenic group.

In some embodiments, the perfluoropolyether material includes a backbone structure selected from the group consisting of:

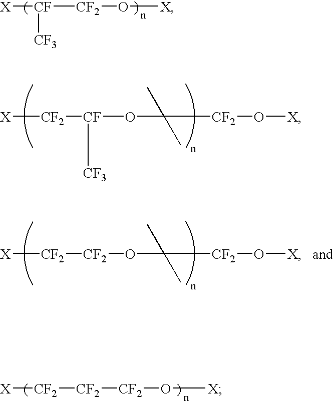

wherein X is present or absent, and when present includes an endcapping group, and n is an integer from 1 to 100.

In some embodiments, the PFPE liquid precursor is synthesized from hexafluoropropylene oxide as shown in Scheme 2.

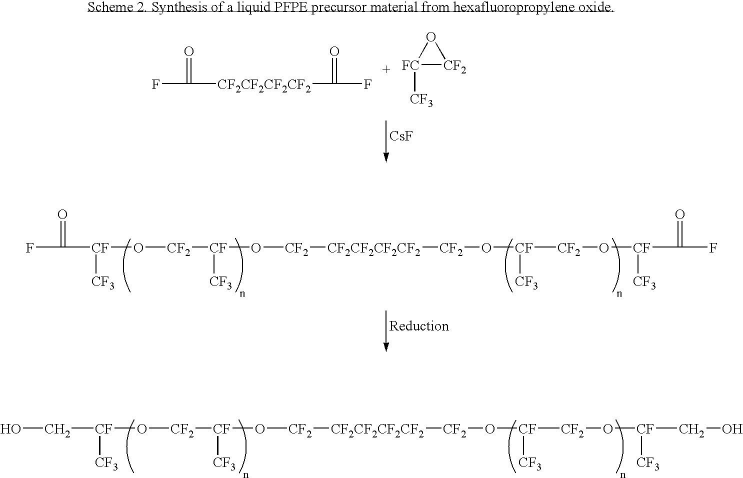

In some embodiments, the liquid PFPE precursor is synthesized from hexafluoropropylene oxide as shown in Scheme 3.

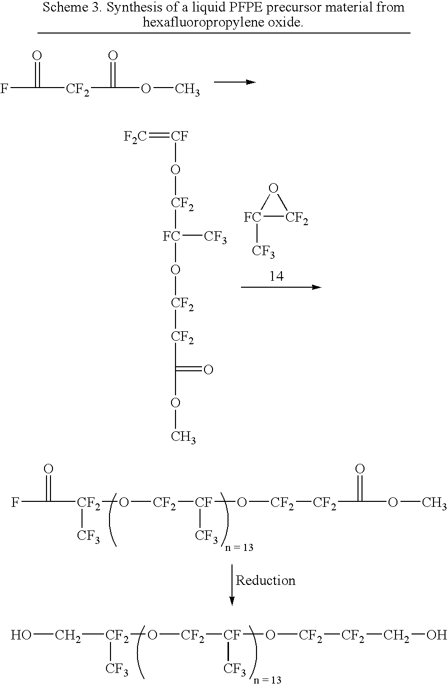

In some embodiments the liquid PFPE precursor includes a chain extended material such that two or more chains are linked together before adding polymerizablable groups. Accordingly, in some embodiments, a “linker group” joins two chains to one molecule. In some embodiments, as shown in Scheme 4, the linker group joins three or more chains.

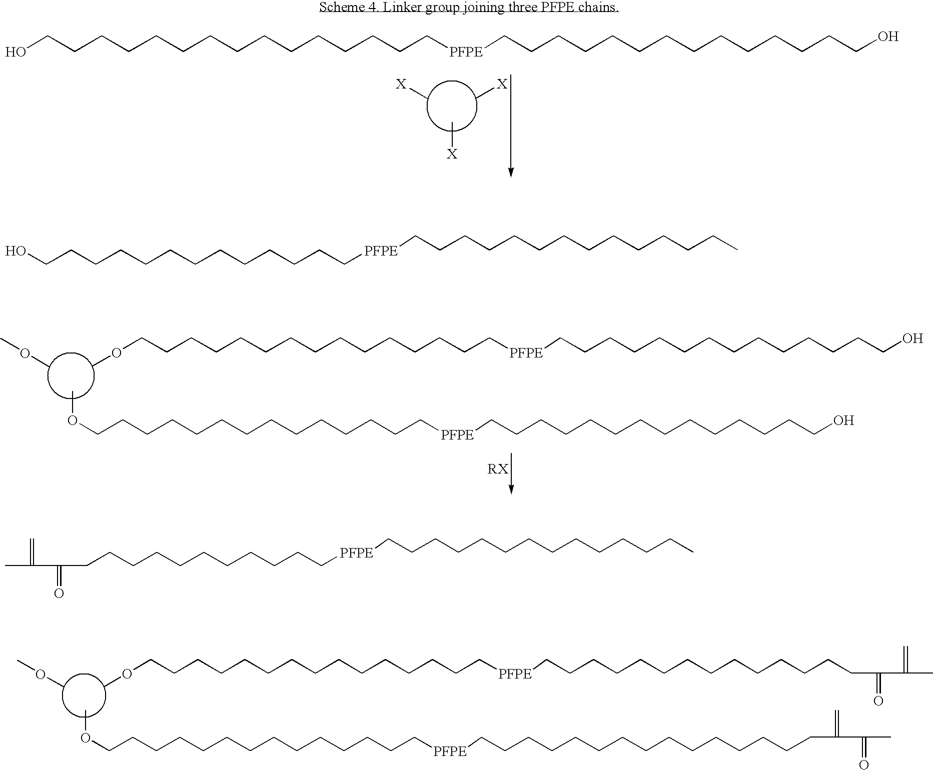

In some embodiments, X is an isocyanate, an acid chloride, an epoxy, and/or a halogen. In some embodiments, R is an acrylate, a methacrylate, a styrene, an epoxy, a carboxylic, an anhydride, a maleimide, an isocyanate, an olefinic, and/or an amine. In some embodiments, the circle represents any multifunctional molecule. In some embodiments, the multifunctional molecule includes a cyclic molecule. PFPE refers to any PFPE material provided herein.

In some embodiments, the liquid PFPE precursor includes a hyperbranched polymer as provided in Scheme 5, wherein PFPE refers to any PFPE material provided herein.

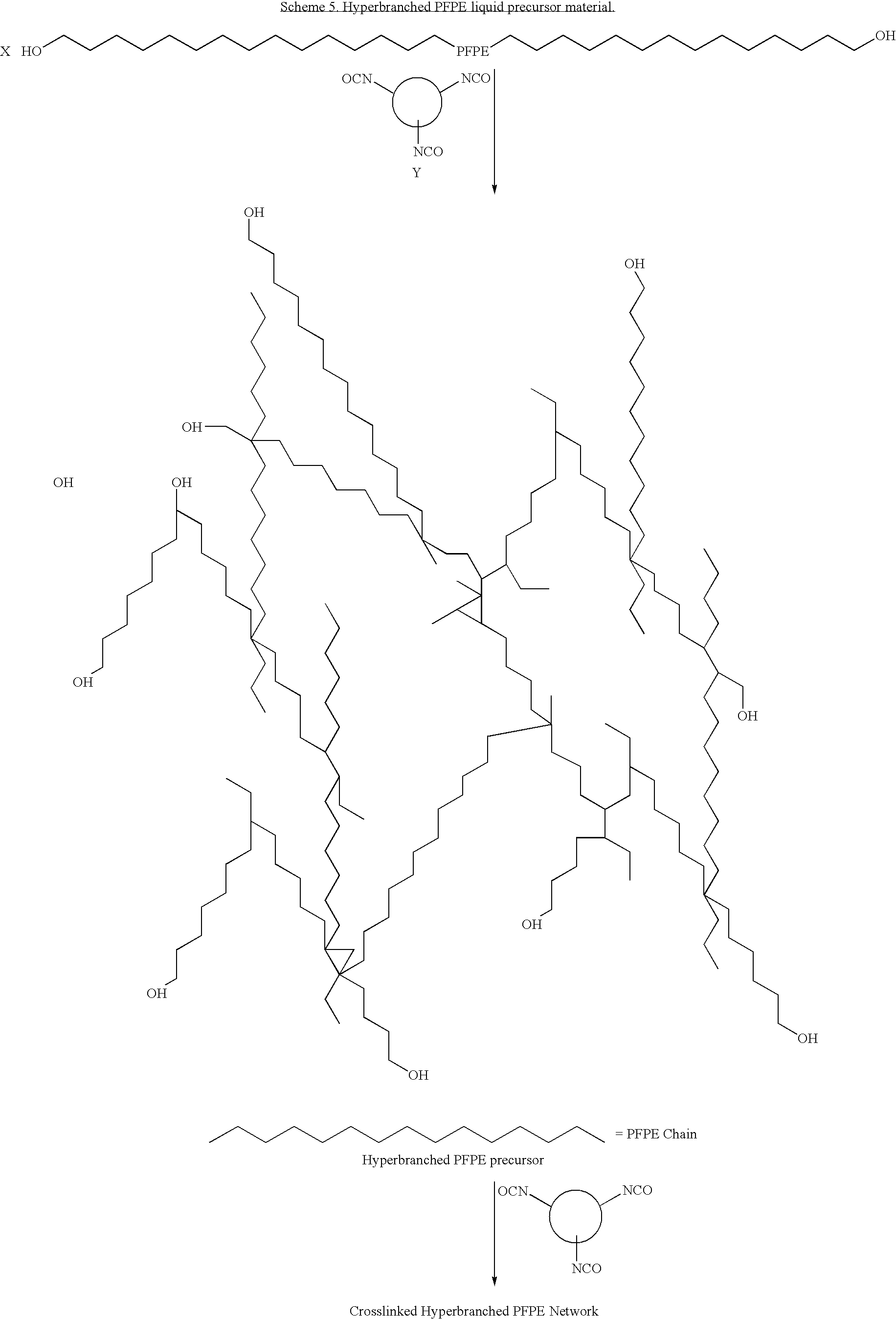

In some embodiments, the liquid PFPE material includes an end-functionalized material, such as for example:

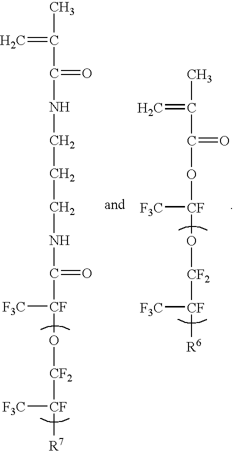

In some embodiments, low surface energy base material, such as for example, PFPE liquid precursor, is encapped with an epoxy moiety that can be photocured using a photoacid generator. Photoacid generators suitable for use in the presently disclosed subject matter include, but are not limited to: bis(4-tert-butylphenyl)iodonium p-toluenesulfonate, bis(4-tert-butylphenyl)iodonium triflate, (4-bromophenyl)diphenylsulfonium triflate, (tert-butoxycarbonylmethoxynaphthyl)-diphenylsulfonium triflate, (tert-butoxycarbonylmethoxyphenyl)diphenylsulfonium triflate, (4-tert-butylphenyl)diphenylsulfonium triflate, (4-chlorophenyl)diphenylsulfonium triflate, diphenyliodonium-9,10-dimethoxyanthracene-2-sulfonate, diphenyliodonium hexafluorophosphate, diphenyliodonium nitrate, diphenyliodonium perfluoro-1-butanesulfonate, diphenyliodonium p-toluenesulfonate, diphenyliodonium triflate, (4-fluorophenyl)diphenylsulfonium triflate, N-hydroxynaphthalimide triflate, N-hydroxy-5-norbornene-2,3-dicarboximide perfluoro-1-butanesulfonate, N-hydroxyphthalimide triflate, [4-[(2-hydroxytetradecyl)oxy]phenyl]phenyliodonium hexafluoroantimonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, 2-naphthyl diphenylsulfonium triflate, (4-phenoxyphenyl)diphenylsulfonium triflate, (4-phenylthiophenyl)diphenylsulfonium triflate, thiobis(triphenyl sulfonium hexafluorophosphate), triarylsulfonium hexafluoroantimonate salts, triarylsulfonium hexafluorophosphate salts, triphenylsulfonium perfluoro-1-butanesulfonate, triphenylsulfonium triflate, tris(4-tert-butylphenyl)sulfonium perfluoro-1-butanesulfonate, and tris(4-tert-butylphenyl)sulfonium triflate.

In some embodiments the low surface energy base material, such as for example, liquid PFPE precursor, cures into a highly UV and/or highly visible light transparent elastomer. In some embodiments the base material, such as liquid PFPE precursor, cures into an elastomer that is highly permeable to oxygen, carbon dioxide, nitrogen, and the like, yielding a property that can facilitate maintaining the viability of biological fluids/cells, tissues, organs, and the like disposed therein or thereon. In some embodiments, devices fabricated from the low surface energy base materials can include additives or can be formed into layers with varying additives yielding layers with different physical and chemical properties to enhance the overall function of a device. In some embodiments, the additives and/or varying layers enhance barrier properties of the device to molecules, such as oxygen, carbon dioxide, nitrogen, dyes, reagents, and the like.

### II.C. Other suitable base materials

In some embodiments, the material suitable for use with the presently disclosed subject matter includes a silicone material having a fluoroalkyl functionalized polydimethylsiloxane (PDMS) having the following structure:

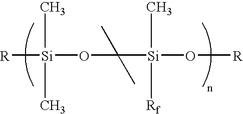

wherein:

R is selected from the group consisting of an acrylate, a methacrylate, and a vinyl group;

R_{f} includes a fluoroalkyl chain; and

n is an integer from 1 to 100,000.

According to alternate embodiments, novel silicone based materials include photocurable and thermal-curable components. In such alternate embodiments, silicone based materials can include one or more photo-curable and thermal-curable components such that the silicone based material has a dual curing capability as described herein. Silicone based materials compatible with the presently disclosed subject matter are described herein and throughout the reference materials incorporated by reference into this application.

In some embodiments, the material suitable for use with the presently disclosed subject matter includes a styrenic material having a fluorinated styrene monomer selected from the group consisting of:

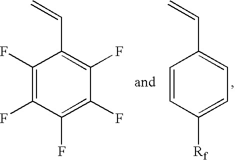

wherein R_{f} includes a fluoroalkyl chain.

In some embodiments, the material suitable for use with the presently disclosed subject matter includes an acrylate material having a fluorinated acrylate or a fluorinated methacrylate having the following structure:

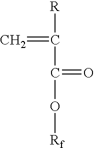

wherein:

R is selected from the group consisting of H, alkyl, substituted alkyl, aryl, and substituted aryl; and

R_{f} includes a fluoroalkyl chain with a —CH₂— or a —CH₂—CH₂-spacer between a perfluoroalkyl chain and the ester linkage. In some embodiments, the perfluoroalkyl group has hydrogen substituents.

In some embodiments, the material suitable for use with the presently disclosed subject matter includes a triazine fluoropolymer having a fluorinated monomer.

In some embodiments, the fluorinated monomer or fluorinated oligomer that can be polymerized or crosslinked by a metathesis polymerization reaction includes a functionalized olefin. In some embodiments, the functionalized olefin includes a functionalized cyclic olefin.

According to an alternative embodiment, the PFPE material includes a urethane block as described and shown in the following structures provided in Scheme 6:

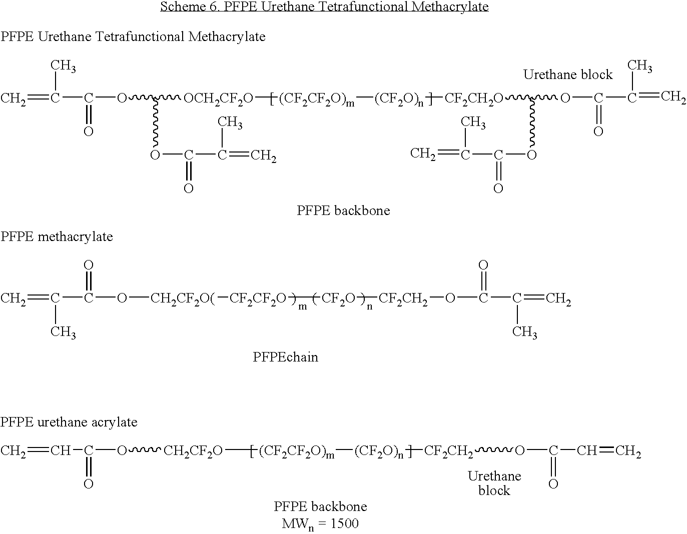

According to an embodiment of the presently disclosed subject matter, PFPE urethane tetrafunctional methacrylate materials such as the above described can be used as the materials and methods of the presently disclosed subject matter or can be used in combination with other materials and methods described herein, as will be appreciated.

According to some embodiments, base materials, such as urethane based material systems include materials with the following structures.

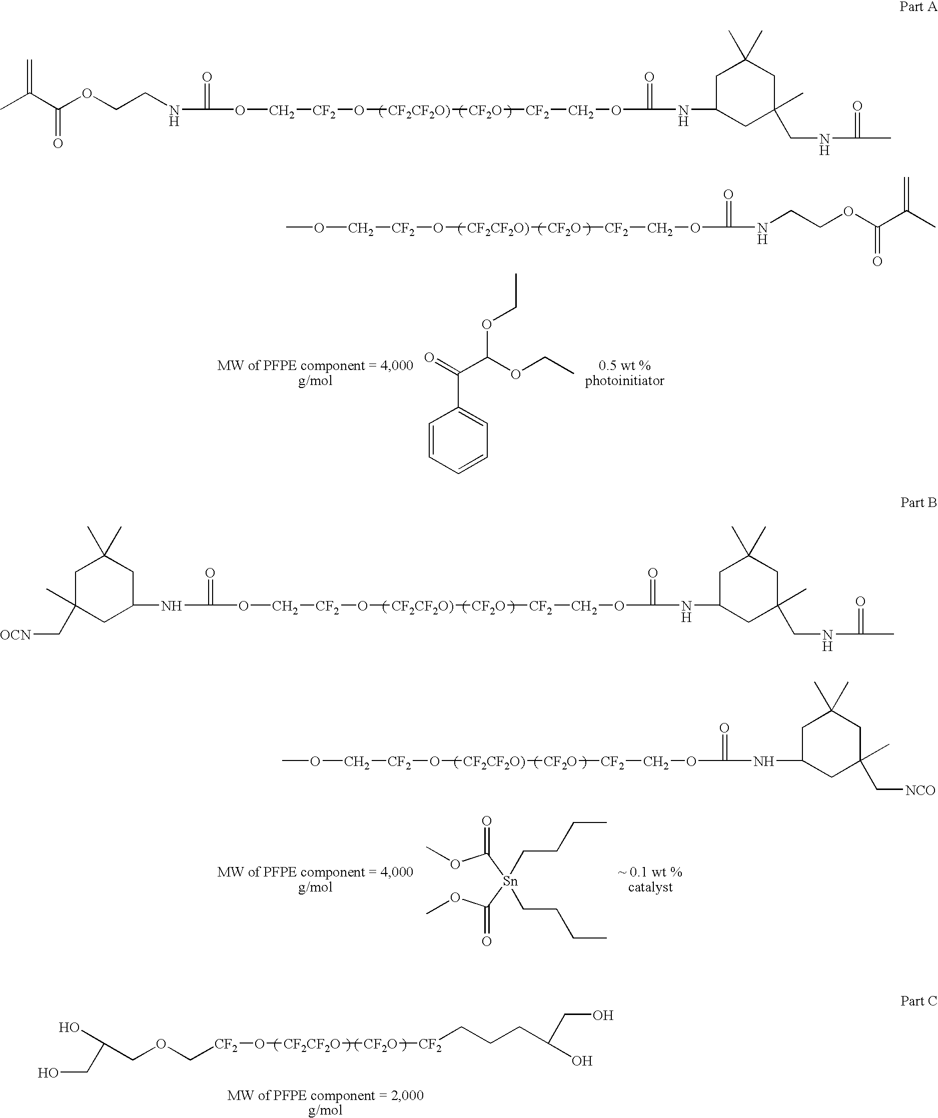

According to this scheme, parts A, B, C, and D can be added to a base material described herein. Part A is a UV curable precursor and parts B and C make up a thermally curable component of the urethane system. The fourth component, part D, is a end-capped precursor, (e.g., styrene end-capped liquid precursor). According to some embodiments, part D reacts with latent methacrylate, acrylate, or styrene groups contained in a base material, thereby adding chemical compatibility or a surface passivation to the base material and increasing the functionality of the base material. This system is described with respect to a urethane system, however, it will be appreciated that it can be applied to all the base materials described herein.

### II.D. Fluoroolefin-based materials

Further, in some embodiments, the base materials used herein are selected from highly fluorinated fluoroelastomers, e.g., fluoroelastomers having at least fifty-eight weight percent fluorine, as described in U.S. Pat. No. 6,512,063 to Tang, which is incorporated herein by reference in its entirety. Such fluoroelastomers can be partially fluorinated or perfluorinated and can contain between 25 to 70 weight percent, based on the weight of the fluoroelastomer, of copolymerized units of a first monomer, e.g., vinylidene fluoride (VF₂) or tetrafluoroethylene (TFE). The remaining units of the fluoroelastomers include one or more additional copolymerized monomers, which are different from the first monomer, and are selected from the group consisting of fluorine-containing olefins, fluorine containing vinyl ethers, hydrocarbon olefins, and combinations thereof.

These fluoroelastomers include VITON® (DuPont Dow Elastomers, Wilmington, Del., United States of America) and Kel-F type polymers, as described for microfluidic applications in U.S. Pat. No. 6,408,878 to Unger et al. These commercially available polymers, however, have Mooney viscosities ranging from about 40 to 65 (ML 1+10 at 121° C.) giving them a tacky, gum-like viscosity. When cured, they become a stiff, opaque solid. As currently available, VITON® and Kel-F have limited utility for micro-scale molding. Curable species of similar compositions, but having lower viscosity and greater optical clarity, is needed in the art for the applications described herein. A lower viscosity (e.g., 2 to 32 (ML 1+10 at 121° C.)) or more preferably as low as 80 to 2000 cSt at 20° C., composition yields a pourable liquid with a more efficient cure.

More particularly, the fluorine-containing olefins include, but are not limited to, vinylidine fluoride, hexafluoropropylene (HFP), tetrafluoroethylene (TFE), 1,2,3,3,3-pentafluoropropene (1-HPFP), chlorotrifluoroethylene (CTFE) and vinyl fluoride.

The fluorine-containing vinyl ethers include, but are not limited to perfluoro(alkyl vinyl)ethers (PAVEs). More particularly, perfluoro(alkyl vinyl) ethers for use as monomers include perfluoro(alkyl vinyl)ethers of the following formula:

CF₂═CFO(R_{f}O)ₙ(R_{f}O)ₘR_{f}

wherein each R_{f} is independently a linear or branched C₁-C₆ perfluoroalkylene group, and m and n are each independently an integer from 0 to 10.

In some embodiments, the perfluoro(alkyl vinyl)ether includes a monomer of the following formula:

CF₂═CFO(CF₂CFXO)ₙR_{f}

wherein X is F or CF₃, n is an integer from 0 to 5, and R_{f} is a linear or branched C₁-C₆ perfluoroalkylene group. In some embodiments, n is 0 or 1 and R_{f} includes 1 to 3 carbon atoms. Representative examples of such perfluoro(alkyl vinyl)ethers include perfluoro(methyl vinyl)ether (PMVE) and perfluoro(propyl vinyl)ether (PPVE).

In some embodiments, the perfluoro(alkyl vinyl)ether includes a monomer of the following formula:

CF₂═CFO[(CF₂)ₘCF₂CFZO)ₙR_{f}

wherein R_{f} is a perfluoroalkyl group having 1-6 carbon atoms, m is an integer from 0 or 1, n is an integer from 0 to 5, and Z is F or CF₃. In some embodiments, R_{f} is C₃F₇, m is 0, and n is 1.

In some embodiments, the perfluoro(alkyl vinyl)ether monomers include compounds of the formula:

CF₂═CFO[(CF₂CF{C F₃}O)ₙ(CF₂CF₂CF₂O)ₘ(CF₂)ₚ]CₓF₂ₓ₊₁

wherein m and n each integers independently from 0 to 10, p is an integer from 0 to 3, and x is an integer from 1 to 5. In some embodiments, n is 0 or 1, m is 0 or 1, and x is 1.

Other examples of useful perfluoro(alkyl vinyl ethers) include:

CF₂═CFOCF₂CF(CF₃)O(CF₂O)ₘCₙF₂ₙ₊₁

wherein n is an integer from 1 to 5, m is an integer from 1 to 3. In some embodiments, n is 1.

In embodiments wherein copolymerized units of a perfluoro(alkyl vinyl)ether (PAVE) are present in the presently described fluoroelastomers, the PAVE content generally ranges from 25 to 75 weight percent, based on the total weight of the fluoroelastomer. If the PAVE is perfluoro(methyl vinyl) ether (PMVE), then the fluoroelastomer contains between 30 and 55 wt. % copolymerized PMVE units.

Hydrocarbon olefins useful in the presently described fluoroelastomers include, but are not limited to ethylene (E) and propylene (P). In embodiments wherein copolymerized units of a hydrocarbon olefin are present in the presently described fluoroelastomers, the hydrocarbon olefin content is generally 4 to 30 weight percent.

Further, the presently described fluoroelastomers can, in some embodiments, include units of one or more cure site monomers. Examples of suitable cure site monomers include: i) bromine-containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl)ether; and ix) non-conjugated dienes.

The brominated cure site monomers can contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers include 2-bromo-perfluoroethyl perfluorovinyl ether and fluorinated compounds of the class CF₂Br—R_{f}—O—CF═CF₂ (wherein R_{f} is a perfluoroalkylene group), such as CF₂BrCF₂O—CF═CF₂, and fluorovinyl ethers of the class ROCF═CFBr or ROCBr═CF₂ (wherein R is a lower alkyl group or fluoroalkyl group), such as CH₃OCF═CFBr or CF₃CH₂OCF═CFBr.

Suitable iodinated cure site monomers include iodinated olefins of the formula: CHR═CH-Z-CH₂CHR—I, wherein R is —H or —CH₃; Z is a C₁ to C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n is an integer from 1 to 3, such as disclosed in U.S. Pat. No. 5,717,036. In addition, suitable iodinated cure site monomers including iodoethylene, 4-iodo-3,3,4,4-tetrafluorobutene-1 (ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether also are useful cure site monomers.

Useful nitrile-containing cure site monomers include those of the formulas shown below:

CF₂═CF—O(CF₂)ₙ—CN

wherein n is an integer from 2 to 12. In some embodiments, n is an integer from 2 to 6.

CF₂═CF—O[CF₂—CF(CF)—O]ₙ—CF₂—CF(CF₃)—CN

wherein n is an integer from 0 to 4. In some embodiments, n is an integer from 0 to 2.

CF₂═CF—[OCF₂CF(CF₃)]ₓ—O—(CF₂)ₙ—CN

wherein x is 1 or 2, and n is an integer from 1 to 4; and

CF₂═CF—O—(CF₂)ₙ—O—CF(CF₃)—CN

wherein n is an integer from 2 to 4. In some embodiments, the cure site monomers are perfluorinated polyethers having a nitrile group and a trifluorovinyl ether group.

In some embodiments, the cure site monomer is:

CF₂═CFOCF₂CF(CF₃)OCF₂CF₂CN

i.e., perfluoro(8-cyano-5-methyl-3,6-dioxa-1-octene) or 8-CNVE.

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in Canadian Patent No. 2,067,891 and European Patent No. 0784064A1. A suitable triene is 8-methyl-4-ethylidene-1,7-octadiene.

In embodiments wherein the fluoroelastomer will be cured with peroxide, the cure site monomer is preferably selected from the group consisting of 4-bromo-3,3,4,4-tetrafluorobutene-1 (BTFB); 4-iodo-3,3,4,4-tetrafluorobutene-1 (ITFB); allyl iodide; bromotrifluoroethylene and 8-CNVE. In embodiments wherein the fluoroelastomer will be cured with a polyol, 2-HPFP or perfluoro(2-phenoxypropyl vinyl)ether is the preferred cure site monomer. In embodiments wherein the fluoroelastomer will be cured with a tetraamine, bis(aminophenol) or bis(thioaminophenol), 8-CNVE is the preferred cure site monomer.

Units of cure site monomer, when present in the presently disclosed fluoroelastomers, are typically present at a level of 0.05-10 wt. % (based on the total weight of fluoroelastomer), preferably 0.05-5 wt. % and most preferably between 0.05 and 3 wt. %.

Fluoroelastomers which can be used in the presently disclosed subject matter include, but are not limited to, those having at least 58 wt. % fluorine and having copolymerized units of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; yl) vinylidene fluoride, perfluoro(methyl vinyl)ether, tetrafluoroethylene and 4-iodo-3,3,4,4-tetrafluorobutene-1; vii) vinylidene fluoride, perfluoro(methyl vinyl)ether, tetrafluoroethylene and 1,1,3,3,3-pentafluoropropene; viii) tetrafluoroethylene, perfluoro(methyl vinyl)ether and ethylene; ix) tetrafluoroethylene, perfluoro(methyl vinyl)ether, ethylene and 4-bromo-3,3,4,4-tetrafluorobutene-1; x) tetrafluoroethylene, perfluoro(methyl vinyl) ether, ethylene and 4-iodo-3,3,4,4-tetrafluorobutene-1; xi) tetrafluoroethylene, propylene and vinylidene fluoride; xii) tetrafluoroethylene and perfluoro(methyl vinyl)ether; xiii) tetrafluoroethylene, perfluoro(methyl vinyl)ether and perfluoro(8-cyano-5-methyl-3,6-dioxa-1-octene); xiv) tetrafluoroethylene, perfluoro(methyl vinyl)ether and 4-bromo-3,3,4,4-tetrafluorobutene-1; xv) tetrafluoroethylene, perfluoro(methyl vinyl)ether and 4-iodo-3,3,4,4-tetrafluorobutene-1; and xvi) tetrafluoroethylene, perfluoro(methyl vinyl)ether and perfluoro(2-phenoxypropyl vinyl)ether.

Additionally, iodine-containing endgroups, bromine-containing endgroups or combinations thereof can optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4-tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)perfluorocyclobutane; monoiodoperfluoroethane; monoiodoperfluorobutane; 2-iodo-1-hydroperfluoroethane, and the like. Also included are the cyano-iodine chain transfer agents disclosed European Patent No. 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Other chain transfer agents suitable for use include those disclosed in U.S. Pat. No. 3,707,529. Examples of such agents include isopropanol, diethylmalonate, ethyl acetate, carbon tetrachloride, acetone and dodecyl mercaptan.

### II.E. Dual photocurable and thermalcurable materials

According to another embodiment, a material according to the presently disclosed subject matter includes one or more of a photo-curable constituent and a thermal-curable constituent. In one embodiment, the photo-curable constituent is independent from the thermal-curable constituent such that the material can undergo multiple cures. A material having the ability to undergo multiple cures is useful, for example, in forming layered devices or in connecting or attaching devices to other devices or portions or components of devices to other portions or components of devices. For example, a liquid material having photocurable and thermal-curable constituents can undergo a first cure to form a first device through, for example, a photocuring process or a thermal curing process. Then the photocured or thermal cured first device can be adhered to a second device of the same material or any material similar thereto that will thermally cure or photocure and bind to the material of the first device. By positioning the first device and second device adjacent one another and subjecting the first and second devices to a thermal curing or photocuring, whichever component that was not activated on the first curing. Thereafter, either the thermal cure constituents of the first device that were left un-activated by the photocuring process or the photocure constituents of the first device that were left un-activated by the first thermal curing, will be activated and bind the second device. Thereby, the first and second devices become adhered together. It will be appreciated by one of ordinary skill in the art that the order of curing processes is independent and a thermal-curing could occur first followed by a photocuring or a photocuring could occur first followed by a thermal curing.

According to yet another embodiment, multiple thermo-curable constituents can be included in the material such that the material can be subjected to multiple independent thermal-cures. For example, the multiple thermal-curable constituents can have different activation temperature ranges such that the material can undergo a first thermal-cure at a first temperature range and a second thermal-cure at a second temperature range. Accordingly, the material can be adhered to multiple other materials through different thermal-cures, thereby, forming a multiple laminate layer device.

Examples of chemical groups which would be suitable end-capping agents for a UV curable component include: methacrylates, acrylates, styrenics, epoxides, cyclobutanes and other 2+2 cycloadditions, combinations thereof, and the like. Examples of chemical group pairs which are suitable to endcap a thermally curable component include: epoxy/amine, epoxy/hydroxyl, carboxylic acid/amine, carboxylic acid/hydroxyl, ester/amine, ester/hydroxyl, amine/anhydride, acid halide/hydroxyl, acid halide/amine, amine/halide, hydroxyl/halide, hydroxyl/chlorosilane, azide/acetylene and other so-called “click chemistry” reactions, and metathesis reactions involving the use of Grubb's-type catalysts, combinations thereof, and the like.

The presently disclosed methods for the adhesion of multiple layers of a device to one another or to a separate surface can be applied to PFPE-based materials, as well as a variety of other materials, including PDMS and other liquid-like polymers. Examples of liquid-like polymeric materials that are suitable for use in the presently disclosed adhesion methods include, but are not limited to, PDMS, poly(tetramethylene oxide), poly(ethylene oxide), poly(oxetanes), polyisoprene, polybutadiene, and fluoroolefin-based fluoroelastomers, such as those available under the registered trademarks VITON® AND KALREZ®.

Accordingly, the presently disclosed methods can be used to adhere layers of different polymeric materials together to form devices, such as alignment layers for liquid crystal displays, microfluidic devices, medical device, surgical devices, tools, components of medical devices, implant materials, laminates, and the like. For example, multiple PFPE and PDMS layers can be adhered together in a given liquid crystal display device, microfluidic, medical device, and the like.

### III. Method for forming a device through a thermal free radical curing process

In some embodiments, the presently disclosed subject matter provides a method for forming an alignment layer for a liquid crystal display device, by which a functional base material, such as for example, liquid perfluoropolyether (PFPE) precursor material is contacted with a patterned substrate, i.e., a master, and is thermally cured using a free radical initiator. As provided in more detail herein, in some embodiments, the liquid PFPE precursor material is fully cured to form a fully cured PFPE network, which can then be removed from the patterned substrate and contacted with a second substrate to form a reversible, hermetic seal.

In some embodiments, the liquid PFPE precursor material is partially cured to form a partially cured PFPE network. In some embodiments, the partially cured network is contacted with a second partially cured layer of PFPE material and the curing reaction is taken to completion, thereby forming a permanent bond between the PFPE layers.

Further, the partially cured PFPE network can be contacted with a layer or substrate including another polymeric material, such as poly(dimethylsiloxane) or another polymer, and then thermally cured so that the PFPE network adheres to the other polymeric material. Additionally, the partially cured PFPE network can be contacted with a solid substrate, such as glass, quartz, or silicon, and then bonded to the substrate through the use of a silane coupling agent.

### III.A. Method of forming a patterned layer of an elastomeric material

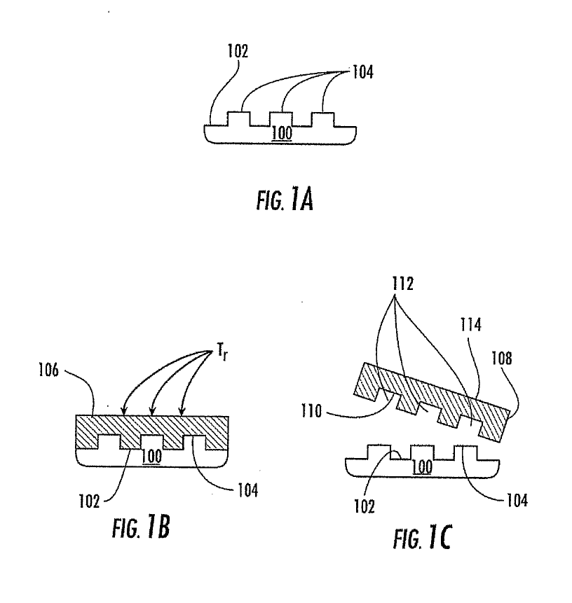

In some embodiments, the presently disclosed subject matter provides a method of forming a patterned layer of an elastomeric base material. The presently disclosed method is suitable for use with the perfluoropolyether material described herein, as well as the fluoroolefin-based materials described herein. An advantage of using a higher viscosity PFPE material allows, among other things, for a higher molecular weight between cross links. A higher molecular weight between cross links can improve the elastomeric properties of the material, which can prevent among other things, cracks from forming. Referring now to FIGS. 1A-1C, a schematic representation of an embodiment of the presently disclosed subject matter is shown. A substrate 100 having a patterned surface 102 with a raised protrusion 104 is depicted. Accordingly, the patterned surface 102 of the substrate 100 includes at least one raised protrusion 104, which forms the shape of a pattern. In some embodiments, patterned surface 102 of substrate 100 includes a plurality of raised protrusions 104 which form a complex pattern.

As best seen in FIG. 1B, a liquid precursor material 106 is disposed on patterned surface 102 of substrate 100. As shown in FIG. 1B, the liquid precursor material 102 is treated with a treating process Tᵣ. Upon the treating of liquid precursor material 106, a patterned layer 108 of an elastomeric material (as shown in FIG. 1C) is formed.

As shown in FIG. 1C, the patterned layer 108 of the elastomeric material includes a recess 110 that is formed in the bottom surface of the patterned layer 108. The dimensions of recess 110 correspond to the dimensions of the raised protrusion 104 of patterned surface 102 of substrate 100. In some embodiments, recess 110 includes at least one channel 112, which in some embodiments of the presently disclosed subject matter includes a microscale channel. Patterned layer 108 is removed from patterned surface 102 of substrate 100 to yield patterned grooved device 114. In some embodiments, removal of patterned grooved device 114 is performed using a “lift-off” solvent which slowly wets underneath the device and releases it from the patterned substrate. Examples of such solvents include, but are not limited to, any solvent that will not adversely interact with the device or functional components of the patterned grooved device. Examples of such solvents include, but are not limited to: water, isopropyl alcohol, acetone, N-methylpyrollidinone, and dimethyl formamide, and the like. In some embodiments, the patterned grooved device 114 can be used for alignment layers of a liquid crystal display device.

In some embodiments, the patterned substrate includes an etched silicon wafer. In some embodiments, the patterned substrate includes a photoresist patterned substrate. In some embodiments, the patterned substrate is treated with a coating that can aid in the release of the device from the patterned substrate or prevent reaction with latent groups on a photoresist which constitutes the patterned substrate. An example of the coating can include, but is not limited to, a silane or thin film of metal deposited from a plasma, such as, a Gold/Palladium coating. For the purposes of the presently disclosed subject matter, the patterned substrate can be fabricated by any of the processing methods known in the art, including, but not limited to, photolithography, electron beam lithography, and ion milling.

In some embodiments, the patterned layer of perfluoropolyether is between about 0.1 micrometers and about 100 micrometers thick. In some embodiments, the patterned layer of perfluoropolyether is between about 0.1 millimeters and about 10 millimeters thick. In some embodiments, the patterned layer of perfluoropolyether is between about one micrometer and about 50 micrometers thick. In some embodiments, the patterned layer of perfluoropolyether is about 20 micrometers thick. In some embodiments, the patterned layer of perfluoropolyether is about 5 millimeters thick.

In some embodiments, the patterned layer of perfluoropolyether includes a plurality of microscale channels. In some embodiments, the channels have a width ranging from about 0.01 μm to about 1000 μm; a width ranging from about 0.05 μm to about 1000 μm; and/or a width ranging from about 1 μm to about 1000 μm. In some embodiments, the channels have a width ranging from about 1 μm to about 500 μm; a width ranging from about 1 μm to about 250 μm; and/or a width ranging from about 10 μm to about 200 μm. Exemplary channel widths include, but are not limited to, 0.1 μm, 1 μm, 2 μm, 5 μm, 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, and 250 μm.

In some embodiments, the channels have a depth ranging from about 1 μm to about 1000 μm; and/or a depth ranging from about 1 μm to 100 μm. In some embodiments, the channels have a depth ranging from about 0.01 μm to about 1000 μm; a depth ranging from about 0.05 μm to about 500 μm; a depth ranging from about 0.2 μm to about 250 μm; a depth ranging from about 1 μm to about 100 μm; a depth ranging from about 2 μm to about 20 μm; and/or a depth ranging from about 5 μm to about 10 μm. Exemplary channel depths include, but are not limited to 0.01 μm, 0.02 μm, 0.05 μm, 0.1 μm, 0.2 μm, 0.5 μm, 1 μm, 2 μm, 3 μm, 4 μm, 5 μm, 7.5 μm, 10 μm, 12.5 μm, 15 μm, 17.5 μm, 20 μm, 22.5 μm, 25 μm, 30 μm, 40 μm, 50 μm, 75 μm, 100 μm, 150 μm, 200 μm, and 250 μm.

According to some embodiments the channels or grooves have a length of up to about 2 meters. In some embodiments the length of the channels or grooves is up to about 1 meter. In some embodiments the length of the channels or grooves is up to about 0.5 meter. In some embodiments the length of the channels or grooves is up to about 1 cm. In some embodiments the length of the channels or grooves is up to about 5 mm. In some embodiments the length of the channels or grooves is up to about 1 mm. In some embodiments the length of the channels or grooves is between about 5 nm and about 1000 nm.

In some embodiments, the channels have a width-to-depth ratio ranging from about 0.1:1 to about 100:1. In some embodiments, the channels have a width-to-depth ratio ranging from about 1:1 to about 50:1. In some embodiments, the channels have a width-to-depth ratio ranging from about 2:1 to about 20:1. In some embodiments, the channels have a width-to-depth ratio ranging from about 3:1 to about 15:1. In some embodiments, the channels have a width-to-depth ratio of about 10:1.

One of ordinary skill in the art would recognize that the dimensions of the channels of the presently disclosed subject matter are not limited to the exemplary ranges described hereinabove and can vary in width and depth to affect a substance applied to the grooves, the magnitude of force required to flow a material within a groove, to actuate a valve corresponding to the groove, and the like. Further, as will be described herein, grooves of greater width and length are contemplated for use as alignment layers for liquid crystal displays, a fluid reservoir, a reaction chamber, a mixing channel, a separation region, and the like.

### III.B. Method for forming a multilayer patterned material

In some embodiments, the presently disclosed subject matter describes a method for forming a multilayer patterned material, e.g., a multilayer patterned PFPE material. In some embodiments, the multilayer patterned perfluoropolyether material is used to fabricate monolithic PFPE-based devices. In some embodiments the device is an alignment layer of a liquid crystal display, in other embodiments the device is a microfluidic device.

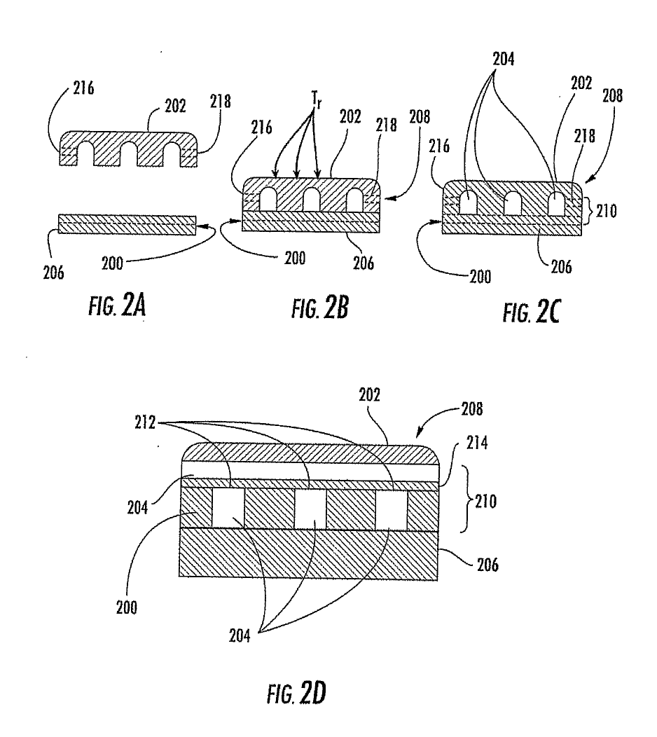

Referring now to FIGS. 2A-2D, a schematic representation of the preparation of an embodiment of the presently disclosed subject matter is shown. Patterned layers 200 and 202 are provided, each of which, in some embodiments, include a perfluoropolyether material prepared from a liquid PFPE precursor material having a viscosity greater than about 100 cSt. In this example, each of the patterned layers 200 and 202 include a plurality of channels 204. In this embodiment of the presently disclosed subject matter, the plurality of channels or grooves 204 include microscale channels. In patterned layer 200, the channels are represented by a dashed line, i.e., in shadow, in FIGS. 2A-2C. Patterned layer 202 is overlaid on patterned layer 200 in a predetermined alignment. In this example, the predetermined alignment is such that channels 204 in patterned layer 200 and 202 are substantially perpendicular to each other. In some embodiments, as depicted in FIGS. 2A-2D, patterned layer 200 is overlaid on nonpatterned layer 206. Nonpatterned layer 206 can include a perfluoropolyether.

Continuing with reference to FIGS. 2A-2D, patterned layers 200 and 202, and in some embodiments nonpatterned layer 206, are treated by a treating process Tᵣ. As described in more detail herein below, layers 200, 202, and, in some embodiments nonpatterned layer 206, are treated by treating Tᵣ, to promote the adhesion of patterned layers 200 and 202 to each other, and in some embodiments, patterned layer 200 to nonpatterned layer 206, as shown in FIGS. 2C and 2D. The resulting device 208 includes an integrated network 210 of microscale channels or grooves 204 which intersect predetermined intersecting points 212, as best seen in the cross-section provided in FIG. 2D. Also shown in FIG. 2D is membrane 214 comprising the top surface of channels 204 of patterned layer 200 which separates channel 204 of patterned layer 202 from channels 204 of patterned layer 200.

Continuing with reference to FIGS. 2A-2C, in some embodiments, patterned layer 202 includes a plurality of apertures, and the apertures are designated input aperture 216 and output aperture 218. In some embodiments, the holes, e.g., input aperture 216 and output aperture 218 are in fluid communication with channels 204. In some embodiments, the apertures include a side-actuated valve structure constructed of, for example, a thin membrane of PFPE material which can be actuated to restrict the flow in an abutting channel. It will be appreciated, however, that the side-actuated valve structure can be constructed from other materials disclosed herein.

In some embodiments, the first patterned layer of photocured PFPE material is cast at such a thickness to impart a degree of mechanical stability to the PFPE structure. Accordingly, in some embodiments, the first patterned layer of the photocured PFPE material is about 50 μm to several centimeters thick. In some embodiments, the first patterned layer of the photocured PFPE material is between 50 μm and about 10 millimeters thick. In some embodiments, the first patterned layer of the photocured PFPE material is 5 mm thick. In some embodiments, the first patterned layer of PFPE material is about 4 mm thick. Further, in some embodiments, the thickness of the first patterned layer of PFPE material ranges from about 0.1 μm to about 10 cm; from about 1 μm to about 5 cm; from about 10 μm to about 2 cm; and from about 100 μm to about 10 mm.

In some embodiments, the second patterned layer of the photocured PFPE material is between about 1 micrometer and about 100 micrometers thick. In some embodiments, the second patterned layer of the photocured PFPE material is between about 1 micrometer and about 50 micrometers thick. In some embodiments, the second patterned layer of the photocured material is about 20 micrometers thick.

Although FIGS. 2A-2C disclose the formation of a device wherein two patterned layers of PFPE material are combined, in some embodiments of the presently disclosed subject matter it is possible to form a device having one patterned layer and one non-patterned layer of PFPE material. Thus, the first patterned layer can include a microscale channel or an integrated network of microscale channels and then the first patterned layer can be overlaid on top of the non-patterned layer and adhered to the non-patterned layer using a photocuring step, such as application of ultraviolet light as disclosed herein, to form a monolithic structure including enclosed channels therein.

Accordingly, in some embodiments, a first and a second patterned layer of photocured perfluoropolyether material, or alternatively a first patterned layer of photocured perfluoropolyether material and a nonpatterned layer of photocured perfluoropolyether material, adhere to one another, thereby forming a monolithic PFPE-based device.

### III.C. Method of forming a patterned layer through a thermal free radical curing process

In some embodiments, a thermal free radical initiator, including, but not limited to, a peroxide and/or an azo compound, is blended with a liquid perfluoropolyether (PFPE) precursor, which is functionalized with a polymerizable group, including, but not limited to, an acrylate, a methacrylate, and a styrenic unit to form a blend. As shown in FIGS. 1A-1C, the blend is then contacted with a patterned substrate, i.e., a “master,” and heated to cure the PFPE precursor into a network.

In some embodiments, the PFPE precursor is fully cured to form a fully cured PFPE precursor polymer. In some embodiments, the free radical curing reaction is allowed to proceed only partially to form a partially-cured network.

### III.D. Method of adhering a layer to a substrate through a thermal free radical curing process

In some embodiments the fully cured PFPE precursor is removed, e.g., peeled, from the patterned substrate, i.e., the master, and contacted with a second substrate to form a reversible, hermetic seal.

In some embodiments, the partially cured network is contacted with a second partially cured layer of PFPE material and the curing reaction is taken to completion, thereby forming a permanent bond between the PFPE layers.

In some embodiments, the partial free-radical curing method is used to bond at least one layer of a partially-cured PFPE material to a substrate. In some embodiments, the partial free-radical curing method is used to bond a plurality of layers of a partially-cured PFPE material to a substrate. In some embodiments, the substrate is selected from the group consisting of a glass material, a quartz material, a silicon material, a fused silica material, and a plastic material. In some embodiments, the substrate is treated with a silane coupling agent.

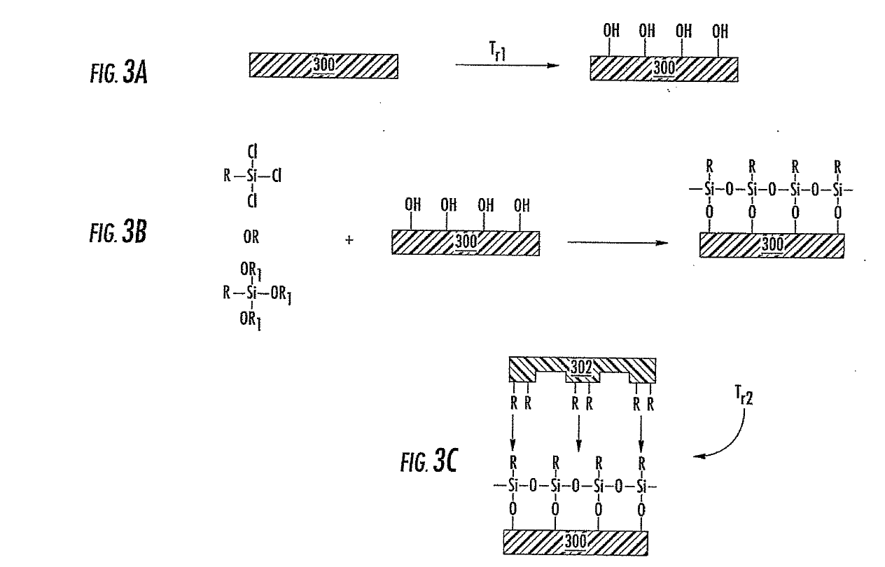

An embodiment of the presently disclosed method for adhering a layer of PFPE material to a substrate is illustrated in FIGS. 3A-3C. Referring now to FIG. 3A, a substrate 300 is provided, wherein, in some embodiments, substrate 300 is selected from the group consisting of a glass material, a quartz material, a silicon material, a fused silica material, and a plastic material. Substrate 300 is treated by treating process Tᵣ₁. In some embodiments, treating process Tᵣ₁ includes treating the substrate with a base/alcohol mixture, e.g., KOH/isopropanol, to impart a hydroxyl functionality to substrate 300.

Referring now to FIG. 3B, functionalized substrate 300 is reacted with a silane coupling agent, e.g., R—SiCl₃ or R—Si(OR₁)₃, wherein R and R₁ represent a functional group as described herein to form a silanized substrate 300. In some embodiments, the silane coupling agent is selected from the group consisting of a monohalosilane, a dihalosilane, a trihalosilane, a monoalkoxysilane, a dialkoxysilane, and a trialkoxysilane; and wherein the monohalosilane, dihalosilane, trihalosilane, monoalkoxysilane, dialkoxysilane, and trialkoxysilane are functionalized with a moieties selected from the group consisting of an amine, a methacrylate, an acrylate, a styrenic, an epoxy, an isocyanate, a halogen, an alcohol, a benzophenone derivative, a maleimide, a carboxylic acid, an ester, an acid chloride, and an olefin.

Referring now to FIG. 3C, silanized substrate 300 is contacted with a patterned layer of partially cured PFPE material 302 and treated by treating process Tr₂ to form a permanent bond between patterned layer of PFPE material 302 and substrate 300.

In some embodiments, a partial free radical cure is used to adhere a PFPE layer to a second polymeric material, such as a poly(dimethyl siloxane) (PDMS) material, a polyurethane material, a silicone-containing polyurethane material, and a PFPE-PDMS block copolymer material. In some embodiments, the second polymeric material includes a functionalized polymeric material. In some embodiments, the second polymeric material is encapped with a polymerizable group. In some embodiments, the polymerizable group is selected from the group consisting of an acrylate, a styrene, and a methacrylate. Further, in some embodiments, the second polymeric material is treated with a plasma and a silane coupling agent to introduce the desired functionality to the second polymeric material.

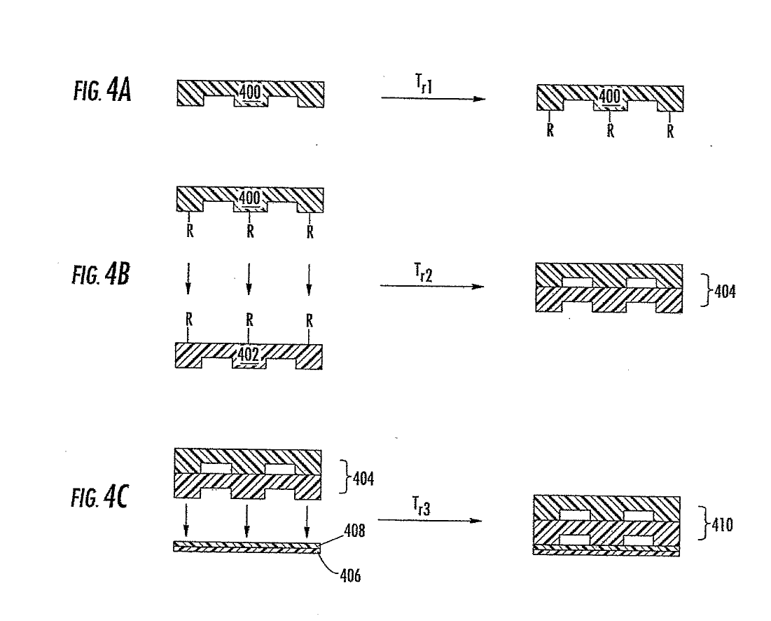

An embodiment of the presently disclosed method for adhering a patterned layer of PFPE material to another patterned layer of polymeric material is illustrated in FIGS. 4A-4C. Referring now to FIG. 4A, a patterned layer of a first polymeric material 400 is provided. In some embodiments, first polymeric material includes a PFPE material. In some embodiments, first polymeric material includes a polymeric material selected from the group consisting of a poly(dimethylsiloxane) material, a polyurethane material, a silicone-containing polyurethane material, and a PFPE-PDMS block copolymer material. Patterned layer of first polymeric material 400 is treated by treating process Tᵣ₁. In some embodiments, treating process Tᵣ₁ includes exposing the patterned layer of first polymeric material 400 to UV light in the presence of O₃ and an R functional group, to add an R functional group to the patterned layer of polymeric material 400.

Referring now to FIG. 4B, the functionalized patterned layer of first polymeric material 400 is contacted with the top surface of a functionalized patterned layer of PFPE material 402 and then treated by treating process Tᵣ₂ to form a two layer hybrid assembly 404. Thus, functionalized patterned layer of first polymeric material 400 is thereby bonded to functionalized patterned layer of PFPE material 402.

Referring now to FIG. 4C, two-layer hybrid assembly 404, in some embodiments, is contacted with substrate 406 to form a multilayer hybrid structure 410. In some embodiments, substrate 406 is coated with a layer of liquid PFPE precursor material 408. Multilayer hybrid structure 410 is treated by treating process Tᵣ₃ to bond two-layer assembly 404 to substrate 406.

### IV. METHODS FOR FORMING A DEVICE THROUGH A TWO-COMPONENT Curing Process

The presently disclosed subject matter provides a method for forming a device by which a polymer, such as, functional perfluoropolyether (PFPE) precursors, are contacted with a patterned surface and then cured through the reaction of two components, such as epoxy/amine, epoxy/hydroxyl, carboxylic acid/amine, carboxylic acid/hydroxyl, ester/amine, ester/hydroxyl, amine/anhydride, acid halide/hydroxyl, acid halide/amine, amine/halide, hydroxyl/halide, hydroxyl/chlorosilane, azide/acetylene and other so-called “click chemistry” reactions, and metathesis reactions involving the use of Grubb's-type catalysts to form a fully-cured or a partially-cured PFPE network.

As used herein the term “click chemistry” refers to a term used in the art to describe the synthesis of compounds using any of a number of carbon-heteroatom bond forming reactions. “Click chemistry” reactions typically are relatively insensitive to oxygen and water, have high stereoselectivity and yield, and thermodynamic driving forces of about 20 kcal/mol or greater. Useful “click chemistry” reactions include cycloaddition reactions of unsaturated compounds, including 1,3-dipolar additions and Diels-Alder reactions; nucleophilic substitution reactions, especially those involving ring opening of small, strained rings like epoxides and aziridines; addition reactions to carbon-carbon multiple bonds; and reactions involving non-aldol carbonyl chemistry, such as the formation of ureas and amides.

Further, the term “metathesis reactions” refers to reactions in which two compounds react to form two new compounds with no change in oxidation numbers in the final products. For example, olefin metathesis involves the 2+2 cycloaddition of an olefin and a transition metal alkylidene complex to form a new olefin and a new alkylidene. In ring-opening metathesis polymerization (ROMP), the olefin is a strained cyclic olefin, and 2+2 cycloaddition to the transition metal catalyst involves opening of the strained ring. The growing polymer remains part of the transition metal complex until capped, for example, by 2+2 cycloaddition to an aldehyde. Grubbs catalysts for metathesis reactions were first described in 1996 (see Schwab, P., et al., J. Am. Chem. Soc., 118, 100-110 (1996)). Grubbs catalysts are transition metal alkylidenes containing ruthenium supported by phosphine ligands and are unique in that that they are tolerant of different functionalities in the alkene ligand.

Accordingly, in one embodiment, the photocurable component can include functional groups that can undergo photochemical 2+2 cycloadditions. Such groups include alkenes, aldehydes, ketones, and alkynes. Photochemical 2+2 cycloadditions can be used, for example, to form cyclobutanes and oxetanes.

Thus, in some embodiments, the partially-cured PFPE network is contacted with another substrate, and the curing is then taken to completion to adhere the PFPE network to the substrate. This method can be used to adhere multiple layers of a PFPE material to a substrate.

Further, in some embodiments, the substrate includes a second polymeric material, such as PDMS, or another polymer. In some embodiments, the second polymeric material includes an elastomer other than PDMS, such as Kratons™ (Shell Chemical Company), buna rubber, natural rubber, a fluoroelastomer, chloroprene, butyl rubber, nitrile rubber, polyurethane, or a thermoplastic elastomer. In some embodiments, the second polymeric material includes a rigid thermoplastic material, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

In some embodiments, the PFPE layer is adhered to a solid substrate, such as a glass material, a quartz material, a silicon material, and a fused silica material, through use of a silane coupling agent.

### IV.A. Method of forming a patterned layer through a two-component curing process

In some embodiments, a PFPE network is formed through the reaction of a two-component functional liquid precursor system. Using the general method for forming a patterned layer of polymeric material as shown in FIGS. 1A-1C, a liquid precursor material that includes a two-component system is contacted with a patterned substrate and a patterned layer of PFPE material is formed. In some embodiments, the two-component liquid precursor system is selected from the group consisting of an epoxy/amine, epoxy/hydroxyl, carboxylic acid/amine, carboxylic acid/hydroxyl, ester/amine, ester/hydroxyl, amine/anhydride, acid halide/hydroxyl, acid halide/amine, amine/halide, hydroxyl/halide, hydroxyl/chlorosilane, azide/acetylene and other so-called “click chemistry” reactions, and metathesis reactions involving the use of Grubb's-type catalysts. The functional liquid precursors are blended in the appropriate ratios and then contacted with a patterned surface or master. The curing reaction is allowed to take place by using heat, catalysts, and the like, until the network is formed.

In some embodiments, a fully cured PFPE precursor is formed. In some embodiments, the two-component reaction is allowed to proceed only partially, thereby forming a partially cured PFPE network.

### IV.B. Method of adhering a PFPE layer to a substrate through a two-component curing process

IV.B.1. Full Cure with a Two-Component Curing Process

In some embodiments, the fully cured PFPE two-component precursor is removed, e.g., peeled, from the master and contacted with a substrate to form a reversible, hermetic seal. In some embodiments, the partially cured network is contacted with another partially cured layer of PFPE and the reaction is taken to completion, thereby forming a permanent bond between the layers.

IV.B.2. Partial Cure with a Two-Component System

As shown in FIGS. 3A-3C, in some embodiments, the partial two-component curing method is used to bond at least one layer of a partially-cured PFPE material to a substrate. In some embodiments, the partial two-component curing method is used to bond a plurality of layers of a partially-cured PFPE material to a substrate. In some embodiments, the substrate is selected from the group consisting of a glass material, a quartz material, a silicon material, a fused silica material, and a plastic material. In some embodiments, the substrate is treated with a silane coupling agent.

As shown in FIGS. 4A-4C, in some embodiments, a partial two-component cure is used to adhere the PFPE layer to a second polymeric material, such as a poly(dimethylsiloxane) (PDMS) material. In some embodiments, the PDMS material includes a functionalized PDMS material. In some embodiments, the PDMS is treated with a plasma and a silane coupling agent to introduce the desired functionality to the PDMS material. In some embodiments, the PDMS material is encapped with a polymerizable group. In some embodiments, the polymerizable group includes an epoxide. In some embodiments, the polymerizable group includes an amine.

In some embodiments, the second polymeric material includes an elastomer other than PDMS, such as Kratons™, buna rubber, natural rubber, α-fluoroelastomer, chloroprene, butyl rubber, nitrile rubber, polyurethane, or a thermoplastic elastomer. In some embodiments, the second polymeric material includes a rigid thermoplastic, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

IV.B.3. Excess Cure with a Two-Component System

The presently disclosed subject matter provides a method for forming a device by which a functional perfluoropolyether (PFPE) precursor is contacted with a patterned substrate and cured through the reaction of two components, such as epoxy/amine, epoxy/hydroxyl, carboxylic acid/amine, carboxylic acid/hydroxyl, ester/amine, ester/hydroxyl, amine/anhydride, acid halide/hydroxyl, acid halide/amine, amine/halide, hydroxyl/halide, hydroxyl/chlorosilane, azide/acetylene and other so-called “click chemistry” reactions, and metathesis reactions involving the use of Grubb's-type catalysts, to form a layer of cured PFPE material. In this particular method, the layer of cured PFPE material can be adhered to a second substrate by fully curing the layer with an excess of one component and contacting the layer of cured PFPE material with a second substrate having an excess of a second component in such a way that the excess groups react to adhere the layers.

Thus, in some embodiments, a two-component system, such as an epoxy/amine, epoxy/hydroxyl, carboxylic acid/amine, carboxylic acid/hydroxyl, ester/amine, ester/hydroxyl, amine/an hydride, acid halide/hydroxyl, acid halide/amine, amine/halide, hydroxyl/halide, hydroxyl/chlorosilane, azide/acetylene and other so-called “click chemistry” reactions, and metathesis reactions involving the use of Grubb's-type catalysts, is blended. In some embodiments, at least one component of the two-component system is in excess of the other component. The reaction is then taken to completion by heating, using a catalyst, and the like, with the remaining cured network having a plurality of functional groups generated by the presence of the excess component.

In some embodiments, two layers of fully cured PFPE materials including complimentary excess groups are contacted with one another, wherein the excess groups are allowed to react, thereby forming a permanent bond between the layers.

As shown in FIGS. 3A-3C, in some embodiments, a fully cured PFPE network including excess functional groups is contacted with a substrate. In some embodiments, the substrate is selected from the group consisting of a glass material, a quartz material, a silicon material, a fused silica material, and a plastic material. In some embodiments, the substrate is treated with a silane coupling agent such that the functionality on the coupling agent is complimentary to the excess functionality on the fully cured network. Thus, a permanent bond is formed to the substrate.

As shown in FIGS. 4A-4C, in some embodiments, the two-component excess cure is used to bond a PFPE network to a second polymeric material, such as a poly(dimethylsiloxane) PDMS material. In some embodiments, the PDMS material includes a functionalized PDMS material. In some embodiments, the PDMS material is treated with a plasma and a silane coupling agent to introduce the desired functionality. In some embodiments, the PDMS material is encapped with a polymerizable group. In some embodiments, the polymerizable material includes an epoxide. In some embodiments, the polymerizable material includes an amine.

In some embodiments, the second polymeric material includes an elastomer other than PDMS, such as Kratons™, buna rubber, natural rubber, a—fluoroelastomer, chloroprene, butyl rubber, nitrile rubber, polyurethane, or a thermoplastic elastomer. In some embodiments, the second polymeric material includes a rigid thermoplastic, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

IV.B.4 Blending a Thermalcurable Component with a Photocurable Material

According to yet another embodiment, devices are formed from adhering multiple layers of materials together. In one embodiment, a two-component thermally curable material is blended with a photocurable material, thereby creating a multiple stage curing material. In certain embodiments, the two-component system can include functional groups, such as epoxy/amine, epoxy/hydroxyl, carboxylic acid/amine, carboxylic acid/hydroxyl, ester/amine, ester/hydroxyl, amine/anhyd ride, acid halide/hydroxyl, acid halide/amine, amine/halide, hydroxyl/halide, hydroxyl/chlorosilane, azide/acetylene and other so-called “click chemistry” reactions, and metathesis reactions involving the use of Grubb's-type catalysts. In one embodiment, the photocurable component can include such functional groups as: acrylates, styrenics, epoxides, cyclobutanes and other 2+2 cycloadditions.

In some embodiments, a two-component thermally curable material is blended in varying ratios with a photocurable material. In one embodiment, the material can then be deposited on a patterned substrate as described above. Such a system can be exposed to actinic radiation, e.g., UV light, and solidified into a network, while the thermally curable components are mechanically entangled in the network but remain unreacted. Layers of the material can then be prepared, for example, cut, trimmed, punched with inlet/outlet holes, filled with a liquid, and aligned in predetermined positions on a second, photocured layer. Once the photocured layers are aligned and sealed, the device can be heated to activate the thermally curable component within the layers. When the thermally curable components are activated by the heat, the layers are adhered together by reaction at the interface.

In some embodiments, the thermal reaction is taken to completion. In other embodiments, the thermal reaction is only done partially and multiple layers are adhered this way by repeating this process. In other embodiments, a multilayered device is formed and adhered to a final flat, non-patterned layer through the thermal cure.

In some embodiments, the thermal cure reaction is done first. The layer is then prepared, for example, cut, trimmed, punched with inlet/outlet holes, filled with a liquid, aligned, and the like. Next, the photocurable component is activated by exposure to actinic radiation, e.g., UV light, and the layers are adhered by functional groups reacting at the interface between the layers.

In some embodiments, blended two-component thermally curable and photocurable materials are used to bond a PFPE network to a second polymeric material, such as a poly(dimethylsiloxane) PDMS material. In some embodiments, the PDMS material includes a functionalized PDMS material. As will be appreciated by one of ordinary skill in the art, the functionalized PDMS material is PDMS material that contains a reactive chemical group, as described elsewhere herein. In some embodiments, the PDMS material is treated with a plasma and a silane coupling agent to introduce the desired functionality. In some embodiments, the PDMS material is encapped with a polymerizable group. In some embodiments, the polymerizable material includes an epoxide. In some embodiments, the polymerizable material includes an amine.

In some embodiments, the second polymeric material includes an elastomer other than PDMS, such as Kratons™, buna rubber, natural rubber, a fluoroelastomer, chloroprene, butyl rubber, nitrile rubber, polyurethane, or a thermoplastic elastomer. In some embodiments, the second polymeric material includes a rigid thermoplastic, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

In some embodiments, a blend of a photocurable PFPE liquid precursor and a two-component thermally curable PFPE liquid precursor is made in such a way that one component of the two component thermally curable blend is in excess of the other. In this way, multiple layers can be adhered through residual complimentary functional groups present in multiple layers.

According to a preferred embodiment, the amount of thermal cure and photocure substance added to the material is selected to produce adhesion between layers of the completed device that can withstand a pressure up to about 60 psi without delaminating. According to a further embodiment, the amount of thermal cure and photocure substance added to the material is selected to produce adhesion between layers of the device that can withstand pressures between about 5 psi and about 45 psi without delaminating. According to yet a further embodiment, the amount of thermal cure and photocure substance added to the material is selected to produce adhesion between layers of the device that can withstand pressures between about 10 psi and about 30 psi without delaminating.

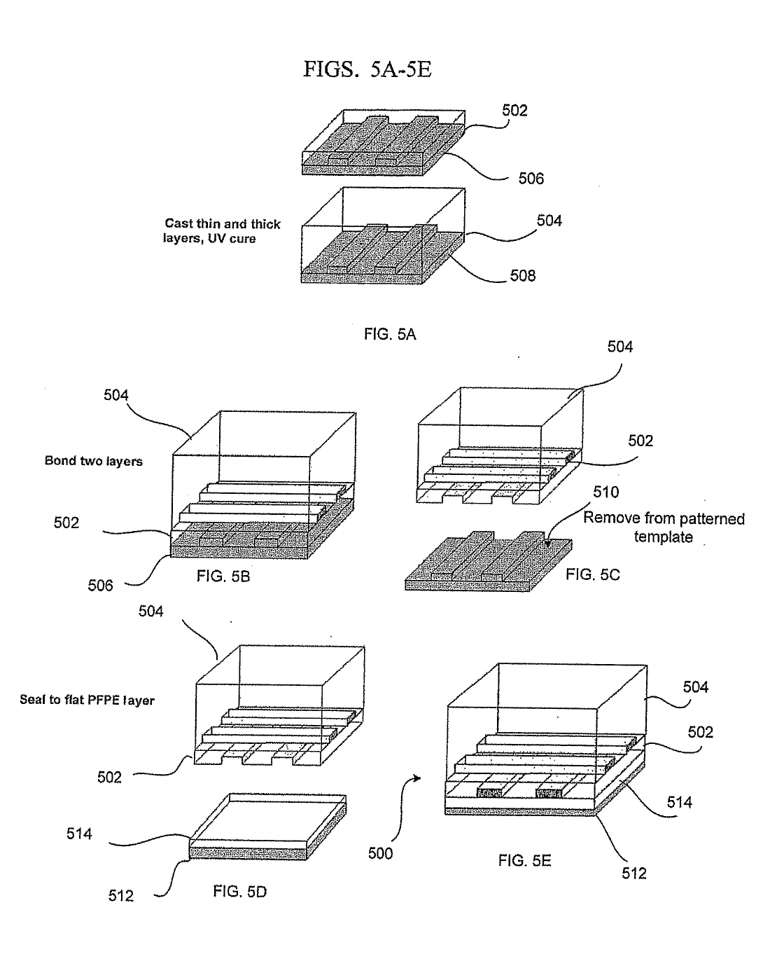

An illustrative example of a method for making a multilayered device will now be described with respect to FIGS. 5A-5E. A two-component thermally curable material blended with a photocurable material is disposed on patterned templates 506, 508 (sometimes referred to as a master template or template), as shown in FIG. 5A. According to alternative embodiments of the presently disclosed subject matter, the blended material can be spin coated onto the patterned template or cast onto the patterned template by pooling the material inside a gasket. Typically, spin coating is used to form thin layers such as first layer 502 and a cast technique is used to form thick layers such as second layer 504, as will be appreciated by one of ordinary skill in the art. Next, the blended material positioned on templates 506 and 508 is treated with an initial cure, such as a photocure, to form first layer 502 and second layer 504, respectively. The photocure partially cures the material but does not initiate the thermal cure components of the material. Patterned template 508 is then removed from second layer 504. Removal of patterned templates from the layers is described in more detail herein. Next, second layer 504 is positioned with respect to first layer 502 and the combination is treated with a second cure, as shown in FIG. 5B, which results in the bonding, or adhesion, between first layer 502 and second layer 504, collectively referred to hereinafter as the “two adhered layers 502 and 504.” Typically, the second cure is an initial heat curing that initiates the two-component thermal cure of the material. Next, the two adhered layers 502 and 504 are removed from patterned template 506, as shown in FIG. 5C. In FIG. 5D, the two adhered layers 502 and 504 are positioned on flat layer 514, flat layer 514 previously being coated onto flat template 512 and treated with an initial cure. The combination of layers 502, 504, and 514 is then treated to a final cure to fully adhere all three layers together, as shown in FIG. 5E.

According to alternative embodiments, patterned template 506 can be coated with release layer 510 to facilitate removal of the cured or partially cured layers (see FIG. 5C). Further, coating of the templates, e.g., patterned template 506 and/or patterned template 508, can reduce reaction of the thermal components with latent groups present on the template. For example, release layer 510 can be a Gold/Palladium coating.

According to alternative embodiments, removal of the partially cured and cured layers can be realized by peeling, suction, pneumatic pressure, through the application of solvents to the partially cured or cured layers, or through a combination of these teachings.

### V. METHOD OF LINKING MULTIPLE CHAINS OF A PFPE MATERIAL WITH A FUNCTIONAL LINKER GROUP

In some embodiments, the presently disclosed method adds functionality to a device or layer by adding a chemical “linker” moiety to the elastomer itself. In some embodiments, a functional group is added along the backbone of the precursor material. An example of this method is illustrated in Scheme 8.

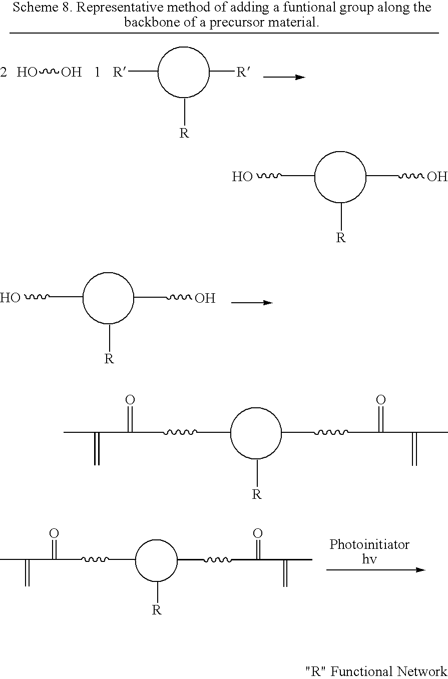

In some embodiments, the precursor material includes a macromolecule containing hydroxyl functional groups. In some embodiments, as depicted in Scheme 8, the hydroxyl functional groups include diol functional groups. In some embodiments, two or more of the diol functional groups are connected through a trifunctional “linker” molecule. In some embodiments, the trifunctional linker molecule has two functional groups, R and R′. In some embodiments, the R′ group reacts with the hydroxyl groups of the macromolecule. In Scheme 8, the circle can represent a linking molecule; and the wavy line can represent a PFPE chain.

In some embodiments, the R group provides the desired functionality to a surface of the device. In some embodiments, the R′ group is selected from the group including, but not limited to, an acid chloride, an isocyanate, a halogen, and an ester moiety. In some embodiments, the R group is selected from one of, but not limited to, a protected amine and a protected alcohol. In some embodiments, the macromolecule diol is functionalized with polymerizable methacrylate groups. In some embodiments, the functionalized macromolecule diol is cured and/or molded by a photochemical process as described by Rolland, J. et al. JACS 2004, 126, 2322-2323, the disclosure of which is incorporated herein by reference in its entirety.

Thus, the presently disclosed subject matter provides a method of incorporating latent functional groups into a photocurable PFPE material through a functional linker group. Thus, in some embodiments, multiple chains of a PFPE material are linked together before encapping the chain with a polymerizable group. In some embodiments, the polymerizable group is selected from the group consisting of a methacrylate, an acrylate, and a styrenic. In some embodiments, latent functionalities are attached chemically to such “linker” molecules in such a way that they will be present in the fully cured network.

In some embodiments, latent functionalities introduced in this manner are used to bond multiple layers of PFPE, bond a fully cured PFPE layer to a substrate, such as a glass material or a silicon material that has been treated with a silane coupling agent, or bond a fully cured PFPE layer to a second polymeric material, such as a PDMS material. In some embodiments, the PDMS material is treated with a plasma and a silane coupling agent to introduce the desired functionality. In some embodiments, the PDMS material is encapped with a polymerizable group. In some embodiments, the polymerizable group is selected from the group consisting of an acrylate, a styrene, and a methacrylate.

In some embodiments, the second polymeric material includes an elastomer other than PDMS, such as Kratons™, buna rubber, natural rubber, a fluoroelastomer, chloroprene, butyl rubber, nitrile rubber, polyurethane, or a thermoplastic elastomer. In some embodiments, the second polymeric material includes a rigid thermoplastic, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

In some embodiments, PFPE networks including functionality attached to “linker” molecules are used to functionalize a surface of a device fabricated from the base material. In some embodiments, device is functionalized by attaching a functional moiety selected from the group consisting of a protein, an oligonucleotide, a drug, a catalyst, a dye, a sensor, an analyte, and a charged species capable of changing the wettability of a surface of the device.

### VI. METHODS FOR IMPROVING CHEMICAL COMPATIBILITY OF A SURFACE

According to some embodiments of the presently disclosed subject matter, the surface of devices fabricated from materials and methods described herein can be passivated to impart chemical compatibility to the devices. According to such materials and methods, surface passivation is achieved by treating the surface of a device fabricated from materials described herein with an end-capped UV and/or thermal curable liquid precursor (e.g., styrene end-capped precursor). Upon activation of the photo or thermally cure component of the styrene end-capped precursor, the precursor reacts with latent methacrylate, styrene, and/or acrylate groups of the material and binds thereto, thereby providing a surface passivation to the surface of the device.

According to another embodiment, a device fabricated from PFPE that contains latent methacrylate, acrylate, and/or styrene groups, as described throughout this application, is treated with a styrene end-capped UV curable PFPE liquid precursor. According to such embodiments, a solution of the styrene end-capped UV curable precursor, dissolved in a solvent including but not limited to pentafluorobutane, can be applied to a surface of a device fabricated from PFPE. The solvent is allowed to evaporate, thereby leaving a film of the styrene end-capped UV curable precursor coating the PFPE surface. In one embodiment the film is then cured, by exposure to UV light, and thereby adhered to latent methacrylate, acrylate, and/or styrene groups of the PFPE material. The surface coated with the styrene end-capped precursor does not contain acid-labile groups such as urethane and/or ester linkages, thus creating a surface passivation and improving the chemical compatibility of the base PFPE material.

According to another embodiment, the surface of a device fabricated from base materials described herein is passivated by a gas phase passivation. According to such embodiments, a device is exposed to a mixture of 0.5% fluorine gas in nitrogen. The fluorine reacts free radically with hydrogen atoms in the base material, thus passivating the surface of device that is treated with the gas.

### VII. METHOD OF ADDING FUNCTIONAL MONOMERS TO THE PRECURSOR MATERIAL

In some embodiments, the method includes adding a functional monomer to an uncured precursor material. In some embodiments, the functional monomer is selected from the group consisting of functional styrenes, methacrylates, and acrylates. In some embodiments, the precursor material includes a fluoropolymer. In some embodiments, the functional monomer includes a highly fluorinated monomer. In some embodiments, the highly fluorinated monomer includes perfluoro ethyl vinyl ether (EVE). In some embodiments, the precursor material includes a poly(dimethyl siloxane) (PDMS) elastomer. In some embodiments, the precursor material includes a polyurethane elastomer. In some embodiments, the method further includes incorporating the functional monomer into the network by a curing step.

In some embodiments, functional monomers are added directly to the liquid PFPE precursor to be incorporated into the network upon crosslinking. For example, monomers can be introduced into the network that are capable of reacting post-crosslinking to adhere multiple layers of PFPE, bond a fully cured PFPE layer to a substrate, such as a glass material or a silicon material that has been treated with a silane coupling agent, or bond a fully cured PFPE layer to a second polymeric material, such as a PDMS material. In some embodiments, the PDMS material is treated with a plasma and a silane coupling agent to introduce the desired functionality. In some embodiment, the PDMS material is encapped with a polymerizable group. In some embodiments, the polymerizable material is selected from the group consisting of an acrylate, a styrene, and a methacrylate.

In some embodiments, the second polymeric material includes an elastomer other than PDMS, such as Kratons™, buna rubber, natural rubber, a fluoroelastomer, chloroprene, butyl rubber, nitrile rubber, polyurethane, or a thermoplastic elastomer. In some embodiments, the second polymeric material includes a rigid thermoplastic, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

In some embodiments, functional monomers are added directly to the liquid PFPE precursor and are used to attach a functional moiety selected from the group consisting of a protein, an oligonucleotide, a drug, a catalyst, a dye, a sensor, an analyte, and a charged species capable of changing the wettability of the channel.

Such monomers include, but are not limited to, tert-butyl methacrylate, tert butyl acrylate, dimethylaminopropyl methacrylate, glycidyl methacrylate, hydroxy ethyl methacrylate, aminopropyl methacrylate, allyl acrylate, cyano acrylates, cyano methacrylates, trimethoxysilane acrylates, trimethoxysilane methacrylates, isocyanato methacrylate, lactone-containing acrylates and methacrylates, sugar-containing acrylates and methacrylates, poly-ethylene glycol methacrylate, nornornane-containing methacrylates and acrylates, polyhedral oligomeric silsesquioxane methacrylate, 2-trimethylsiloxyethyl methacrylate, 1H, 1H,2H,2H-fluoroctylmethacrylate, pentafluorostyrene, vinyl pyridine, bromostyrene, chlorostyrene, styrene sulfonic acid, fluorostyrene, styrene acetate, acrylamide, and acrylonitrile.

In some embodiments, monomers which already have the above agents attached are blended directly with the liquid PFPE precursor to be incorporated into the network upon crosslinking. In some embodiments, the monomer includes a group selected from the group consisting of a polymerizable group, the desired agent, and a fluorinated segment to allow for miscibility with the PFPE liquid precursor. In some embodiments, the monomer does not include a polymerizable group, the desired agent, and a fluorinated segment to allow for miscibility with the PFPE liquid precursor.

In some embodiments, monomers are added to adjust the mechanical properties of the fully cured elastomer. Such monomers include, but are not limited to: perfluoro(2,2-dimethyl-1,3-dioxole), hydrogen-bonding monomers which contain hydroxyl, urethane, urea, or other such moieties, monomers containing bulky side group, such as tert-butyl methacrylate.

In some embodiments, functional species such as the above mentioned monomers are introduced and are mechanically entangled, i.e., not covalently bonded, into the network upon curing. For example, in some embodiments, functionalities are introduced to a PFPE chain that does not contain a polymerizable monomer and such a monomer is blended with the curable PFPE species. In some embodiments, such entangled species can be used to adhere multiple layers of cured PFPE together if two species are reactive, such as: epoxy/amine, hydroxy/acid chloride, hydroxy/isocyanate, amine/isocyanate, amine/halide, hydroxy/halide, amine/ester, and amine/carboxylic acid. Upon heating, the functional groups will react and adhere the two layers together.

Additionally, such entangled species can be used to adhere a PFPE layer to a layer of another material, such as glass, silicon, quartz, PDMS, Kratons™, buna rubber, natural rubber, a fluoroelastomer, chloroprene, butyl rubber, nitrile rubber, polyurethane, or a thermoplastic elastomer. In some embodiments, the second polymeric material includes a rigid thermoplastic, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

### VIII. OTHER METHODS OF INTRODUCING FUNCTIONALITY TO A SURFACE

In some embodiments, an Argon plasma is used to introduce functionality along a fully cured PFPE surface using the method for functionalizing a poly(tetrafluoroethylene) surface as described by Chen, Y. and Momose. Y. Surf. Interface. Anal. 1999, 27, 1073-1083, which is incorporated herein by reference in it entirety. More particularly, without being bound to any one particular theory, exposure of a fully cured PFPE material to Argon plasma for a period of time adds functionality along the fluorinated backbone.

Such functionality can be used to adhere multiple layers of PFPE, bond a fully cured PFPE layer to a substrate, such as a glass material or a silicon material that has been treated with a silane coupling agent, or bond a fully cured PFPE layer to a second polymeric material, such as a PDMS material. In some embodiments, the PDMS material includes a functionalized material. In some embodiments, the PDMS material is treated with a plasma and a silane coupling agent to introduce the desired functionality. Such functionalities also can be used to attach proteins, oligonucleotides, drugs, catalysts, dyes, sensors, analytes, and charged species capable of changing the wettability of the channel.

In some embodiments, the second polymeric material includes an elastomer other than PDMS, such as Kratons™, buna rubber, natural rubber, a fluoroelastomer, chloroprene, butyl rubber, nitrile rubber, polyurethane, or a thermoplastic elastomer. In some embodiments, the second polymeric material includes a rigid thermoplastic, including but not limited to: polystyrene, poly(methyl methacrylate), a polyester, such as poly(ethylene terephthalate), a polycarbonate, a polyimide, a polyamide, a polyvinylchloride, a polyolefin, a poly(ketone), a poly(ether ether ketone), and a poly(ether sulfone).

In some embodiments, a fully cured PFPE layer is brought into conformal contact with a solid substrate. In some embodiments, the solid substrate is selected from the group consisting of a glass material, a quartz material, a silicon material, a fused silica material, and a plastic material. In some embodiments, the PFPE material is irradiated with UV light, e.g., a 185-nm UV light, which can strip a fluorine atom off of the back bone and form a chemical bond to the substrate as described by Vurens, G., et al. Langmuir 1992, 8, 1165-1169. Thus, in some embodiments, the PFPE layer is covalently bonded to the solid substrate by radical coupling following abstraction of a fluorine atom.

### IX. METHOD FOR FORMING A MICROSTRUCTURE USING SACRIFICIAL LAYERS

The presently disclosed subject matter provides a method for forming microchannels, grooves, openings, channels, a microstructure, or the like for use as a device, such as for example alignment layers in a liquid crystal display by using sacrificial layers including a degradable or selectively soluble material. In some embodiments, the method includes contacting a liquid precursor material with a two-dimensional or a three-dimensional sacrificial structure, treating, e.g., curing, the precursor material, and removing the sacrificial structure to form a patterned surface, groove, channel, or micro or nano opening.

Accordingly, in some embodiments, a PFPE liquid precursor is disposed on a multidimensional scaffold, wherein the multidimensional scaffold is fabricated from a material that can be degraded or washed away after curing of the PFPE network. These materials protect the grooves, channels, or openings from being filled in when another layer of elastomer is cast thereon. Examples of such degradable or selective soluble materials include, but are not limited to waxes, photoresists, polysulfones, polylactones, cellulose fibers, salts, or any solid organic or inorganic compounds. In some embodiments, the sacrificial layer is removed thermally, photochemically, or by washing with solvents. Importantly, the compatibility of the materials and devices disclosed herein with organic solvents provides the capability to use sacrificial polymer structures in end use devices.

The PFPE materials of use in forming a microstructure by using sacrificial layers include those PFPE and fluoroolefin-based materials as described herein.

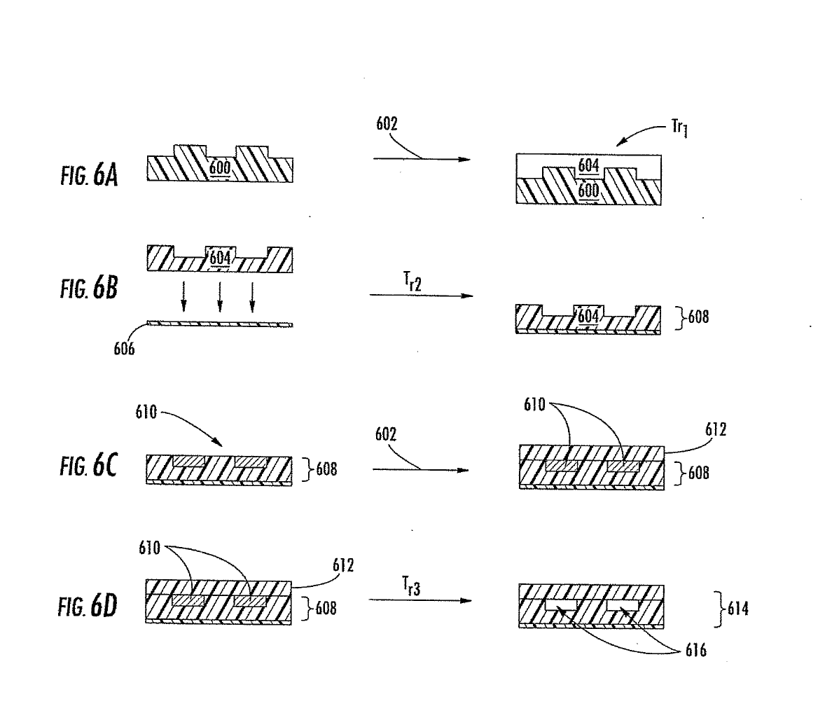

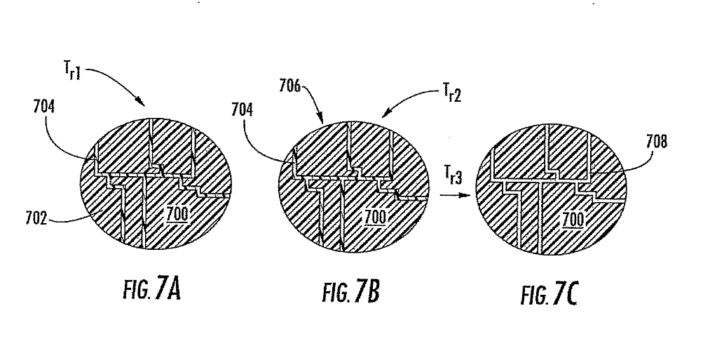

FIGS. 6A-6D and FIGS. 7A-7C show embodiments of the presently disclosed methods for forming a microstructure by using a sacrificial layer of a degradable or selectively soluble material.

Referring now to FIG. 6A, a patterned substrate 600 is provided. Liquid PFPE precursor material 602 is disposed on patterned substrate 600. In some embodiments, liquid PFPE precursor material 602 is disposed on patterned substrate 600 via a spin-coating process. Liquid PFPE precursor material 602 is treated by treating process Tᵣ₁ to form a layer of treated liquid PFPE precursor material 604.

Referring now to FIG. 6B, the layer of treated liquid PFPE precursor material 604 is removed from patterned substrate 600. In some embodiments, the layer of treated liquid PFPE precursor material 604 is contacted with substrate 606. In some embodiments, substrate 606 includes a planar substrate or a substantially planar substrate. In some embodiments, the layer of treated liquid PFPE precursor material is treated by treating process Tᵣ₂, to form two-layer assembly 608.

Referring now to FIG. 6C, a predetermined volume of degradable or selectively soluble material 610 is disposed on two-layer assembly 608. In some embodiments, the predetermined volume of degradable or selectively soluble material 610 is disposed on two-layer assembly 608 via a spin-coating process. Referring once again to FIG. 6C, liquid precursor material 602 is disposed on two-layer assembly 608 and treated to form a layer of PFPE material 612, which covers the predetermined volume of degradable or selectively soluble material 610.

Referring now to FIG. 6D, the predetermined volume of degradable or selectively soluble material 610 is treated by treating process Tᵣ₃ to remove the predetermined volume of degradable or selectively soluble material 610, thereby forming microstructure 616. In some embodiments, microstructure 616 includes a micro groove, channel, through-holes, or the like. In some embodiments, treating process Tᵣ₃ is selected from a thermal process, an irradiation process, a dissolution process, combinations thereof, and the like.

In some embodiments, patterned substrate 600 includes an etched silicon wafer. In some embodiments, the patterned substrate includes a photoresist patterned substrate. For the purposes of the presently disclosed subject matter, the patterned substrate can be fabricated by any of the processing methods known in the art, including, but not limited to, photolithography, electron beam lithography, and ion milling.

In some embodiments, degradable or selectively soluble material 610 is selected from the group consisting of a polyolefin sulfone, a cellulose fiber, a polylactone, and a polyelectrolyte. In some embodiments, the degradable or selectively soluble material 610 is selected from a material that can be degraded or dissolved away. In some embodiments, degradable or selectively soluble material 610 is selected from the group consisting of a salt, a water-soluble polymer, and a solvent-soluble polymer.

In addition to simple channels, the presently disclosed subject matter also provides for the fabrication of multiple complex structures that can be “injection molded” or fabricated ahead of time and embedded into the material and removed as described above.

FIGS. 7A-C illustrate an embodiment of the presently disclosed method for forming a microchannel or a microstructure through the use of a sacrificial layer. Referring now to FIG. 7A, a substrate 700 is provided. In some embodiments, substrate 700 is coated with a liquid PFPE precursor material 702. Sacrificial structure 704 is placed on substrate 700. In some embodiments, liquid PFPE precursor material 702 is treated by treating process Tᵣ₁.

Referring now to FIG. 7B, a second liquid PFPE precursor material 706 is disposed over sacrificial structure 704, in such a way to encase sacrificial structure 704 in second liquid precursor material 706. Second liquid precursor material 706 is then treated by treating process Tᵣ₂. Referring now to FIG. 7C, sacrificial structure 704 is treated by treating process Tᵣ₃, to degrade and/or remove sacrificial structure, thereby forming microstructure 708. In some embodiments, microstructure 708 includes a patterned structure, channels, grooves, openings, and the like.

In some embodiments, substrate 700 includes a silicon wafer. In some embodiments, sacrificial structure 704 includes a degradable or selectively soluble material. In some embodiments, sacrificial structure 704 is selected from the group consisting of a polyolefin sulfone, a cellulose fiber, a polylactone, and a polyelectrolyte. In some embodiments, the sacrificial structure 704 is selected from a material that can be degraded or dissolved away. In some embodiments, sacrificial structure 704 is selected from the group consisting of a salt, a water-soluble polymer, and a solvent-soluble polymer.

### X. METHOD OF INCREASING THE MODULUS OF A DEVICE USING POWDER

In some embodiments, the modulus of a device fabricated from the base materials, such as PFPE materials or any of the fluoropolymer materials described herein can be increased by blending a powder, such as polytetrafluoroethylene (PTFE) powder, also referred to herein as a “PTFE filler,” into the liquid precursor prior to curing. Because PTFE itself has a very high modulus, addition of PTFE in its powder form, when evenly dispersed throughout the low modulus materials of the presently disclosed subject matter, will raise the overall modulus of the material. The PTFE filler also can contribute additional chemical stability and solvent resistance to the PFPE materials.

### XI. APPLICATIONS OF SOLVENT RESISTANT LOW SURFACE ENERGY MATERIALS

According to alternative embodiments, the presently disclosed materials and methods can be combined with and/or substituted for, one or more of the following materials and applications.

According to one embodiment, the materials and methods of the presently disclosed subject matter can be substituted for the silicone component in adhesive materials. In another embodiment, the materials and methods of the presently disclosed subject matter can be combined with adhesive materials to provide stronger binding and alternative adhesion formats. An example of a material to which the presently disclosed subject matter can be applied includes adhesives, such as a two part flowable adhesive that rapidly cures when heated to form a flexible and high tear elastomer. Adhesives such as this are suitable for bonding silicone coated fabrics to each other and to various substrates. An example of such an adhesive is, DOW CORNING® Q5-8401 ADHESIVE KIT (Dow Corning Corp., Midland, Mich., United States of America).

According to another embodiment, the materials and methods of the presently disclosed subject matter can be substituted for the silicone component in color masterbatches. In another embodiment, the materials and methods of the presently disclosed subject matter can be combined with the components of color masterbatches to provide stronger binding and alternative binding formats. Examples of a color masterbatch suitable for use with the presently disclosed subject matter include, but are not limited to, a range of pigment masterbatches designed for use with liquid silicone rubbers (LSR's), for example, SILASTIC® LPX RED IRON OXIDE 5 (Dow Corning Corp., Midland, Mich., United States of America).

According to yet another embodiment, the materials and methods of the presently disclosed subject matter can be substituted for liquid silicone rubber materials. In another embodiment, the materials and methods of the presently disclosed subject matter can be combined with liquid silicone rubber materials to provide stronger binding and alternative binding techniques of the presently disclosed subject matter to the liquid silicone rubber material. Examples of liquid silicone rubber suitable for use or substitution with the presently disclosed subject matter include, but are not limited to, liquid silicone rubber coatings, such as a two part solventless liquid silicone rubber that is both hard and heat stable. Similar liquid silicone rubber coatings show particularly good adhesion to polyamide as well as glass and have a flexible low friction and non-blocking surface, such products are represented by, for example, DOW CORNING® 3625 A&B KIT. Other such liquid silicone rubber includes, for example, DOW CORNING® 3629 PART A; DOW CORNING® 3631 PART A&B (a two part, solvent free, heat-cured liquid silicone rubber); DOW CORNING® 3715 BASE (a two part solventless silicone top coat that cures to a very hard and very low friction surface that is anti-soiling and dirt repellent); DOW CORNING® 3730 A&B KIT (a two part solventless and colorless liquid silicone rubber with particularly good adhesion to polyamide as well as glass fabric); SILASTIC® 590 LSR PART A&B (a two part solventless liquid silicone rubber that has good thermal stability); SILASTIC® 9252/250P KIT PARTS A & B (a two part, solvent-free, heat cured liquid silicone rubber; general purpose coating material for glass and polyamide fabrics; three grades are commonly available including halogen free, low smoke toxicity, and food grade); SILASTIC® 9252/500P KIT PARTS A&B; SILASTIC® 9252/900P KIT PARTS A&B; SILASTIC® 9280/30 KIT PARTS A & B; SILASTIC® 9280/60E KIT PARTS A & B; SILASTIC® 9280/70E KIT PARTS A & B; SILASTIC® 9280/75E KIT PARTS A & B; SILASTIC® LSR 9151-200P PART A; SILASTIC® LSR 9451-100P; RTV Elastomers (Dow Corning Corp., Midland, Mich., United States of America); DOW CORNING® 734 FLOWABLE SEALANT, CLEAR (a one part solventless silicone elastomer for general sealing and bonding applications, this silicone elastomer is a flowable liquid that is easy to use and cures on exposure to moisture in the air); DOW CORNING® Q3-3445 RED FLOWABLE ELASTOMER; (a red, flowable one part solventless silicone elastomer for high temperature release coatings, typically this product is used to coat fabric, release foodstuffs, and is stable up to 260° C.); and DOW CORNING® Q3-3559 SEMIFLOWABLE TEXTILE ELASTOMER (a semi-flowable one part solventless silicone elastomer).

According to yet another embodiment, the materials and methods of the presently disclosed subject matter can be substituted for water based precured silicone elastomers. In another embodiment, the materials and methods of the presently disclosed subject matter can be combined with water based silicone elastomers to provide the improved physical and chemical properties described herein to the materials. Examples of water based silicone elastomers suitable for use or substitution with the presently disclosed subject matter include, but are not limited to, water based auxiliaries to which the presently disclosed subject matter typically applies include DOW CORNING® 84 ADDITIVE (a water based precured silicone elastomer); DOW CORNING® 85 ADDITIVE (a water based precured silicone elastomer); DOW CORNING® ET-4327 EMULSION (methyl/phenyl functional silicone emulsion providing fiber lubrication, abrasion resistance, water repellency and flexibility to glass fabric, typically used as a glassfiber pre-treatment for PTFE coatings); and Dow Corning 7-9120 Dimethicone NF Fluid (a new grade of polydimethylsiloxane fluid introduced by Dow Corning for use in over-the-counter (OTC) topical and skin care products).

According to yet another embodiment, the materials and methods of the presently disclosed subject matter can be substituted for other silicone based materials. In another embodiment, the materials and methods of the presently disclosed subject matter can be combined with such other silicone based materials to impart improved physical and chemical properties to these other silicone based materials. Examples of other silicone based materials suitable for use or substitution with the presently disclosed subject matter include, but are not limited to, for example, United Chemical Technologies RTV silicone (United Chemical Technologies, Inc., Bristol, Pa., United States of America) (flexible transparent elastomer suited for electrical/electronic potting and encapsulation); Sodium Methyl siliconate (this product renders siliceous surfaces water repellent and increases green strength and green storage life); Silicone Emulsion (useful as a non-toxic sprayable releasing agent and dries to clear silicone film); PDMS/α-Methylstyrene (useful where temporary silicone coating must be dissolved off substrate); GLASSCLAD® 6C (United Chemical Technologies, Inc., Bristol, Pa., United States of America) (a hydrophobic coating with glassware for fiberoptics, clinical analysis, electronics); GLASSCLAD® 18 (a hydrophobic coating for labware, porcelain ware, optical fibers, clinical analysis, and light bulbs); GLASSCLAD® HT (a protective hard thin film coating with >350° C. stability); GLASSCLAD® PSA (a high purity pressure sensitive adhesive which forms strong temporary bonds to glass, insulation components, metals and polymers); GLASSCLAD® SO (a protective hard coating for deposition of silicon dioxide on silicon); GLASSCLAD® EG (a flexible thermally stable resin, gives oxidative and mechanical barrier for resistors and circuit boards); GLASSCLAD® RC (methylsilicone with >250° C. stability, commonly used as coatings for electrical and circuit board components); GLASSCLAD® CR (silicone paint formulation curing to a flexible film, serviceable to 290° C.); GLASSCLAD® TF (a source of thick film (0.2-0.4 micron) coatings of silicon dioxide, converts to 36% silicon dioxide and is typically used for dielectric layers, abrasion resistant coatings, and translucent films); GLASSCLAD® FF (a moisture activated soft elastomer for biomedical equipment and optical devices); and UV SILICONE (UV curable silicone with refractive index (R.I.) matched to silica, cures in thin sections with conventional UV sources).

According to still further embodiments of the presently disclosed subject matter, the materials and methods of the presently disclosed subject matter can be substituted for and/or combined with further silicone containing materials. Some examples of further silicone containing materials include, but are not limited to, TUFSIL® (Specialty Silicone Products, Inc., Ballston Spa, N.Y., United States of America) (developed by Specialty Silicones primarily for the manufacture of components of respiratory masks, tubing, and other parts that come in contact with skin, or are used in health care and food processing industries); Baysilone Paint Additive TP 3738 (LANXESS Corp., Pittsburgh, Pa., United States of America) (a slip additive that is resistant to hydrolysis); Baysilone Paint Additive TP 3739 (compositions that reduce surface tension and improve substrate wetting, three acrylic thickeners for anionic, cationic, nonionic and amphoteric solutions, such as APK, APN and APA which are powdered polymethacrylates, and a liquid acrylic thickener); Tego Protect 5000 (Tego Chemie Service GmbH, Essen, Germany) (a modified polydimethylsiloxane resin typically for matte finishes, clear finishes and pigmented paint systems); Tego Protect 5001 (a silicone polyacrylate resin that contains a water repellent, typically used with clear varnish systems); Tego Protect 5002 (a silicone polyacrylate resin that can be repainted after mild surface preparation); Microsponge 5700 Dimethicone (a system based on the Microsponge dimethicone entrapment technology which is useful in the production of emulsion, powder, and stick products for facial treatments, foundations, lipsticks, moisturizers, and sun care products, dimethicone typically is packed into the empty spaces in a complex crosslinked matrix of polymethacrylate copolymer); 350 cST polydimethylsiloxane makes up 78% of the entrapped dimethicone component and 1000 cST polydimethylsiloxane constitutes the other 22%, the system typically facilitates the delivery of dimethicone's protective action to the skin); MB50 high molecular weight polydimethylsiloxane additive series (enables better processing with reduced surface friction and faster operating speeds, commonly available in formulations for PE, PS, PP, thermoplastic polyester elastomer, nylon 6 and 66, acetal and ABS, the silicone component is odorless and colorless and can be used for applications involving food contact, the product can be used as a substitute for silicone fluid and PTFE); Slytherm XLT (a new polydimethylsiloxane low temperature heat transfer fluid from Dow Corning, unlike traditional organic transfer fluids, it is non-toxic, odorless and does not react with other materials in the system, at high temperatures it has the additional advantage of being non-fouling and non-sludge forming); and 561® silicone transformer fluid (this material has a flash point of 300° C. and a fire point of 343° C., the single-component fluid is 100% PDMS, contains no additives, is naturally degradable in soils and sediments, and does not cause oxygen depletion in water).

### XII. MATERIALS HAVING NANOSCOPIC VOIDS AND METHODS FOR FORMING THE SAME

According to other embodiments of the presently disclosed subject matter, materials of the present disclosure are formed with nano-scale voids. The nano-scale voids can provide a porous material, a material with increased surface area, increase the permeability of the material, and the like. According to such embodiments, a fluorinated solvent is introduced to the precursors, described herein, in low concentrations. The materials are then cured as described herein, including but not limited to UV curing, thermal curing, evaporation, combinations thereof, and the like. Next, the solvent is evaporated from the cured material. Following evaporation of the solvent from the cured material, nano-scopic voids are left behind. These nano-scale voids can act give porosity to the material, increase permeability of the material, increase surface area, can be interconnected or independent, combinations thereof, and the like. According to one embodiment, the concentration of the fluorinated solvent is less than about 15%. According to another embodiment, the concentration of the fluorinated solvent is less than about 10%. In yet another embodiment, the concentration of the fluorinated solvent is less than about 5%. According to such embodiments, the solvent acts as a porogen, leaving nano-scopic voids in the cured elastomer, thereby increase the gas permeability of the material, generating nano-scale porosity in the material, increasing liquid permeability, increasing surface area, combinations thereof, and the like.

### XIII. EMBOSSED FLUOROPOLYMER ALIGNMENT LAYER FOR LIQUID CRYSTAL FOR DISPLAYS

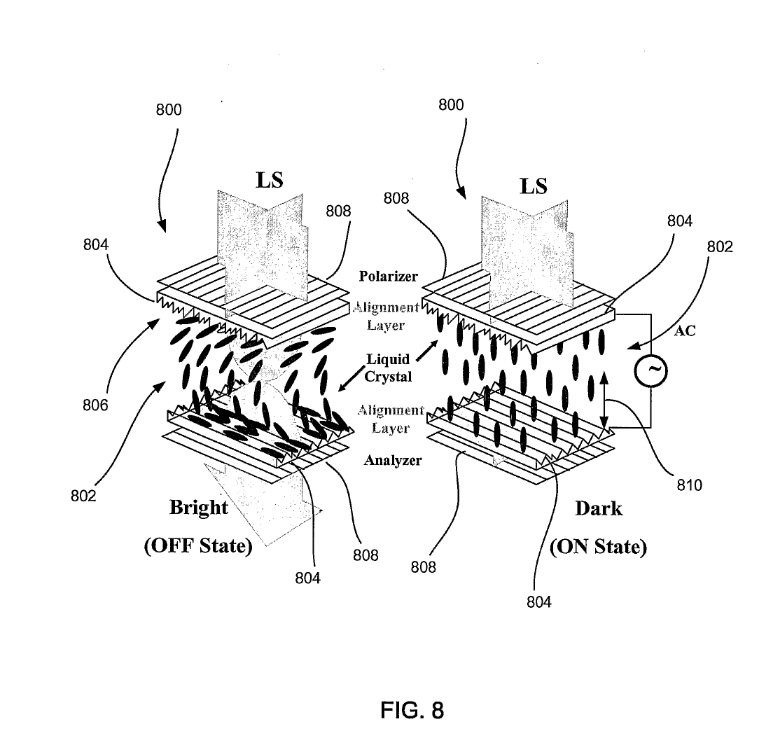

In some embodiments, the base materials described and disclosed herein are configured as alignment layers in liquid crystal displays, as shown in FIG. 8. FIG. 8 shows a positive dielectric in relation to a light source. According to FIG. 8, a liquid crystal display pixel 800 is shown with a low surface energy base material alignment layer 804 and liquid crystal(s) 802. According to some embodiments, an embossed photocurable perfluoropolyether (PFPE) material is disposed as “alignment layer” 804 in liquid crystal displays (LCDs) 800. Accordingly, photocurable perfluoropolyethers (PFPEs) provide an alignment layer 804 that can be embossed with a pattern 806 to give sub-pixel features for a variety of LCD cell designs. In some embodiments the pattern is a regular pattern or repeating shapes that are sub-pixel in scale. According to such embodiments, the pixels of an LCD can have similar or unique patterns. In some embodiments the embossed pattern can be grooves, throughholes, recesses, grid pattern grooves, circular patterns, and the like. According to some embodiments the pattern can be between about 10 nm and about 10 μm. According to other embodiments, the pattern can be between about 100 nm and about 5 μm. In other embodiments, the pattern can be between about 0.5 μm and about 1 μm. The low surface energy base materials disclosed herein, such as for example, the PFPE materials cause a spontaneous vertical (homeotropic) director orientation at PFPE vertical alignment (VA) orientation interface 810. VA orientation interface 810 can be used for Thin-Film-Transistor (TFT) LCDs, in one embodiment. Further, the photocurable perfluoropolyethers (PFPEs) can provide desirable alignment without endangering the TFT electronics, as current rubbing techniques known in the art do. Thus, the presently disclosed subject matter can be used for the manufacture of flexible liquid crystal displays.

According to FIG. 8, each LCD pixel 800 has two modes of operation in relation to light source LS, a “bright” state (OFF state), which is depicted on the left hand side of FIG. 8, and a “dark” state (ON state), which is depicted on the right hand side of FIG. 8. Each state is determined by the orientation of the liquid crystalline (LC) molecules 802 that are placed between two transparent, conducting substrates, or alignment layers 804. Polarizers, analyzers, and/or color filters 808 cause a (in some embodiments, color) contrast when the LC director is reoriented by an applied electric filed, e.g., an AC voltage AC.

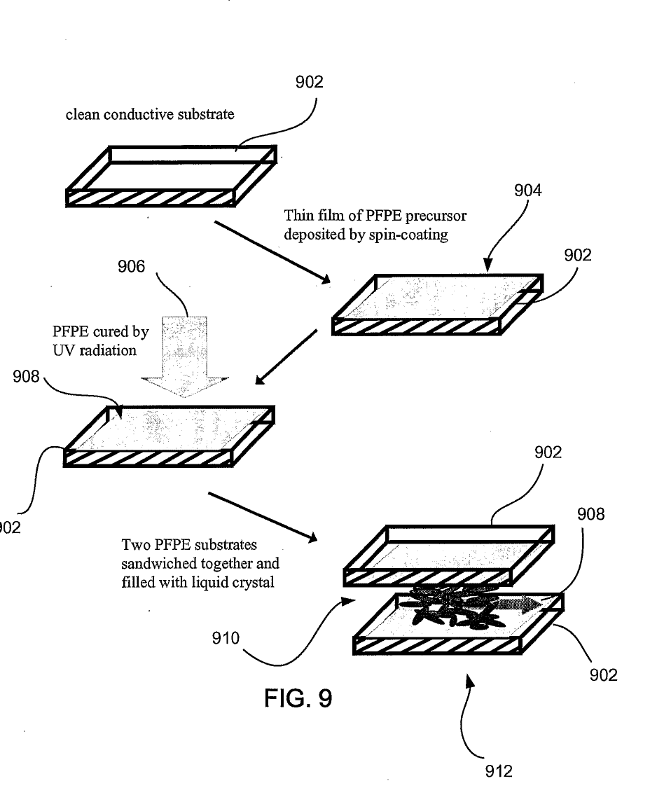

Referring to FIG. 9, a method of forming an alignment layer 908 on a substrate 902 is shown. Substrate 902 is prepared according to a preferred embodiment. The substrate 902 can, in some embodiments, include a pattern or be a flat surface. In some embodiments, substrate 902 includes a clean, conductive substrate. A base material 904, such as low surface energy base materials disclosed herein, is disposed on the substrate 902. According to some embodiments the base material 904 is deposited on the substrate 902 by, for example, dropping liquid precursor base material on the substrate, spin-coating, or the like. In some embodiments the base material 904 disposed on the substrate is a PFPE liquid precursor. Base material 904 is then treated with a curing treatment 906, such as for example, a UV curing process, as described herein, such that the base material is cured into an alignment layer 908. Multiple substrates 902, each with a base material alignment layer 908 can then be positioned with respect to each other and liquid crystals 910 can be positioned therebetween, thereby creating a pixel 912.

A typical LCD example is the so-called “twisted nematic cell,” wherein a surface treatment applied to an interior conducting substrate surface, i.e., “an alignment layer,” establishes the initial (bright) state. In such LCDs, the uniform “planar” alignment of the director tangent to the cell walls is configured to be orthogonal on opposite sides of the cell generating a twisting optical axis through the LC medium. This twisted medium rotates plane-polarized light, thus enabling its transmission through a second polarizer. The dark state arises on applying an electric field normal to the cell walls forming a uniaxial medium that does not rotate the polarization.

Typical methods for aligning these films involve modification of the conducting substrate such that the resulting interface—the alignment layer—has some orienting or anchoring action. Traditional modification techniques involve coating of a substrate with a polyimide alignment layer that upon curing is mechanically rubbed. The coating has traditionally been “spincoated” onto the substrate to generate a thin layer. Meanwhile, the typical materials provide chemical and thermal stability and adhesion, and the techniques are amenable to chemical diversity. Some disadvantages of such traditional modification techniques, however, are that the mechanical rubbing necessary for alignment, of prior art alignment layers, can lead to destruction of electronic components due to static charge, thus providing only a 40% yield of useful product. Also, the mechanism of alignment of traditionally used materials is poorly understood. The presently disclosed subject matter, on the other hand, addresses these and other disadvantages of traditional modification techniques by using base materials disclosed and described herein, such as for example, photocurable perfluoropolyethers as an alignment layer. Photocurable perfluoropolyethers (PFPEs) are a unique class of fluoropolymers that are liquids at room temperature, exhibit low surface energy, low toxicity, excellent chemical resistance (similar to TEFLON® materials), that can be conformally applied and moulded or embossed to give a predetermined, patterned surface topology.

In addition to exhibiting the advantages associated with polyimide anchoring layers in LCDs as provided hereinabove, PFPEs offer several unique properties that are beneficial for LCD production. For example, the low surface energy of the PFPE film causes a spontaneous, uniform homeotropic (normal) alignment over very large, e.g., greater than a centimeter, areas. The polarizing micrograph, as shown in FIG. 8, shows a spontaneous homeotropic alignment—vertical alignment (VA) orientation interface 810—on a millimeter scale in a cell 800 coated with PFPE.

In alternative embodiments, for example, a liquid crystal with a negative dielectric can be used in a display device with a photocurable perfluoropolyether alignment layer (pretreated such that spontaneous homeotropic alignment is achieved). According to such embodiments, the “off state” is the dark state that is spontaneously generated (NA). Application of an electric field across the cell (alignment layer) rotates the director by 90 degrees, creating a bright, birefringent “on state” (transverse orientation of the molecules within the cell).

Photocurable perfluoropolyethers (PFPEs) have the advantage of being an excellent polymer for soft lithography. Thus, embossing the PFPE surface with a pattern, such as for example, grooves, a corrugated sinusoidal pattern of grooves, or the like (i.e., pattern 806, FIG. 8, which in some embodiments includes grooves), would create directional preferences on the alignment layer surface, which in turn would dictate the orientation of the LC. The dimensions of the embossed pattern could be sub-pixel in scale.

The ability to emboss the surface with grooves in a variety of orientations can establish unique pixilated alignment patterns without using contemporary micro-rubbing strategies, further enabling the fabrication of smaller active surfaces comprising Thin Film Transistors (TFT) in high-yield for color displays. Thus, the presently disclosed subject matter provides for the manufacture of thin-film transistors while avoiding mechanical rubbing, which eliminates potential electrostatic damage to electrical components, resulting in a much higher yield of high-quality devices.

Further, base materials, such as for example, PFPEs can provide low anchoring energy, thereby enabling faster switching times. Also, the use of PFPEs can provide more efficient production of large-area LCD devices with absolute control of alignment at the sub-pixel scale. Embossed PFPE alignment layers also should facilitate all of the currently employed LCD geometry configurations: TN (Twisted Nematic), VA (Vertical Alignment), and IPS (In-plane Switching). Additionally, the presently disclosed subject matter should enable fabrication of printed, flexible, liquid crystal displays.

In some embodiments, the polymer alignment layer fabricated from materials disclosed herein can be adhered to, for example, another alignment layer (e.g., as shown in FIGS. 5A-5E) by the dual cure methods described herein. For example, a base material for alignment layers can include dual cure components, such as, photo-cure and thermal cure components. According to this example, a first alignment layer can be patterned from a master template and subjected to a first photo-cure such that first alignment layer is semi-cured to maintain a shape and pattern distribution. The thermal cure component of the first alignment layer remains un-activated for later treatment. Next, in some embodiments the photo-cured first alignment layer is positioned on a second layer. In some embodiments the second layer can be, for example, a second alignment layer, a glass layer, a silicon layer, and the like. In some embodiments, the second layer can be a patterned layer or a non-patterned layer formed by subjecting a liquid base material described herein to a first photo-cure such that the second layer is semi-cured. After positioning the first cured first alignment layer with the first cured second alignment layer, the combination can be subjected to a thermal cure process. In the thermal cure process the thermal cure component of the first alignment layer is activated and bonds the thermal component of the first alignment layer with the second alignment layer.

### XIV. FLEXIBLE FLUOROPOLYMER HOLOGRAPHIC DISPERSED LIQUID CRYSTAL DISPLAY

Polymer-Dispersed (PD) Liquid Crystal Displays (LCDs) are well known for their role in large-area flat-panel displays, which often include a dispersion of liquid crystal (LC) droplets in a polymer matrix. Polymer-Dispersed (PD) Liquid Crystal Displays (LCDs) typically are prepared by mixing a LC with a monomer and polymerizing the monomer. During polymerization there is a spontaneous phase separation wherein “pure” LC droplets are isolated from one another by the intervening polymer. The LCD works by applying an electric field across the dispersion thereby changing the (relative) refractive indices enhancing (or attenuating) the scattered light.

For example, Woo. J. Y., et al., J. Macromolecular Science-Physics 2004, B43 (4): 833-843, describe a polymer dispersed liquid crystal (PDLC) device consisting of a microdispersion of a low molar mass nematic fluid (LC) in a conventional transparent polymer host matrix sandwiched between thin coats of transparent, conducting tin oxide. Field-induced director reorientation with attendant optical changes is often used in large area LCDs: Polymer Dispersed LCs (PDLCs). PDLCs are a microemulsion of low-molar-mass LC dispersed in a conventional transparent polymer film. In the “off” state there is a miss-match between the refractive index of the mLC and the host polymer film. Hence, the dispersion of mLC droplets scatters light very effectively giving an optically opaque film. On application of an external E-field (across a capacitor-like transparent tin oxide coating on both sides of the polymer film), the director assumes the same orientation in all of the micro droplets. If the refractive index along the director matches that of the polymer film host, in the “on” state the film suddenly switches from opaque to transparent giving a very economical large-area “light valve.”

Further, flat panel technology is applied to many new and emerging portable products. A new technology in the flat display field is holographic polymer-dispersed liquid crystals (HPDLC). HPDLC, which are formed by applying the holography method to polymer-dispersed liquid crystals (PDLC) has been expected to be a candidate for high brightness, full color, and reflective display because polarizer and a color filter are not necessarily used in HPDLC. Dispersion of the liquid crystal (LC) molecules in the polymer matrix is often generated by polymerization-induced phase separation where the prepolymer and LC are mixed together and then polymerization is induced photochemically. The dynamics of the phase separation process are very complex phenomena, which are initiated by the change in the chemical potential of the constituents as a result of the polymerization process. The LC droplets are formed and grow at a rate that depends on the rate of polymerization and gelation, and also on the change in miscibility of the various components. Recently, the effects of polymer structure have received considerable attention with regard to HPDLC properties. It has been found, for example, that the driving voltage was significantly decreased by modeling the acrylic monomer with different alkyl side chain length. The improvement was interpreted in terms of interface modification, Le., cohesive energy of monomer and surface-free energy of cured polymer. Also, the effects of varying monomer functionality on HPDLC gratings have been reported. Recently, a major issue with HPDLC has been to minimize the grating shrinkage during the photopolymerization process. During cross-linking, the polymer volume shrinkage is on the order of above about 10%, which is fatal to the fabrication of accurate holographic gratings. The degree of shrinkage according to urethane acrylate monomer functionality has also been investigated, as well as the effects of prepolymer molecular structure on the reflection efficiency and volume shrinkage of HPDLC. In some reports, polyurethane acrylates (PUAs) have been used as photo-curable materials. PUAs can provide structure control, ie., their molecular structures can be controlled by varying the molecular parameters of the raw materials. The lengths of soft segment and hard segment structures of PUA have been varied and their electro-optic properties have been studied.

In contrast, the presently disclosed subject matter describes the use of base materials described herein, such as for example, photocurable perfluoropolyethers (PFPEs), as the host polymer matrix for the construction of a holographic polymer dispersed liquid crystal displays (PD LCDs). Photocurable perfluoropolyethers (PFPEs) should be incompatible with most nematic LCs, thus leading to delineated phase separation on photo-curing of the PFPE. More particularly, the low surface energy of the PFPE should cause a spontaneous perpendicular (homeotropic) director orientation within the spherulites of LC inclusion and, in turn, this should give rise to a strongly scattering “off” state, such as described when a negative dielectric LC is used. Further, there can be unique and advantageous gradients of phase-separated LC droplets (size distributions) that are a consequence of the intrinsic incompatibility of the photocurable perfluoropolyethers (PFPEs) and the LC.

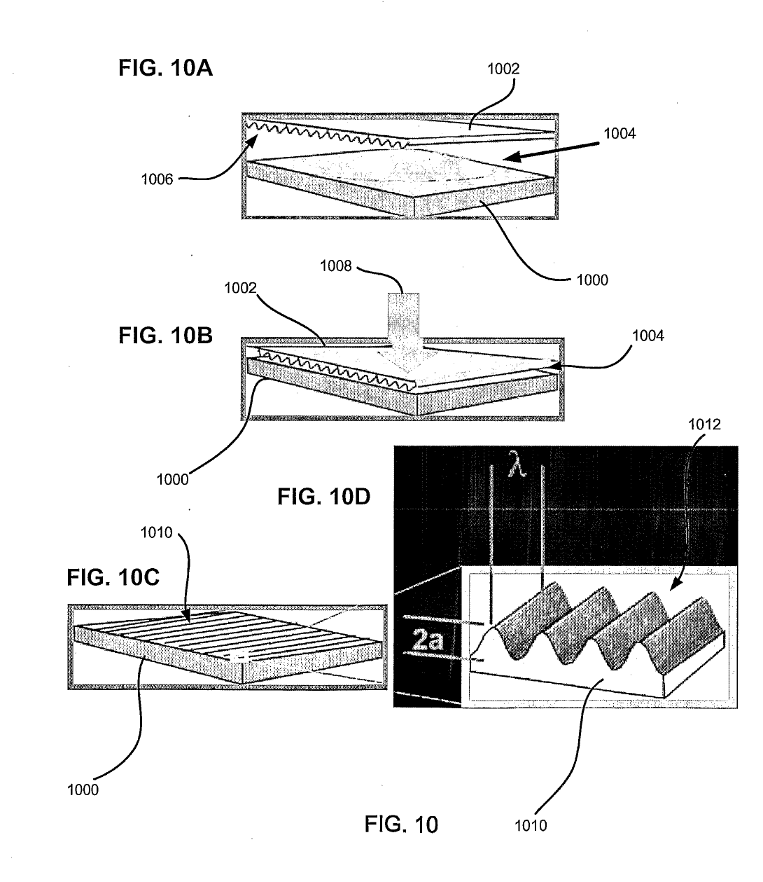

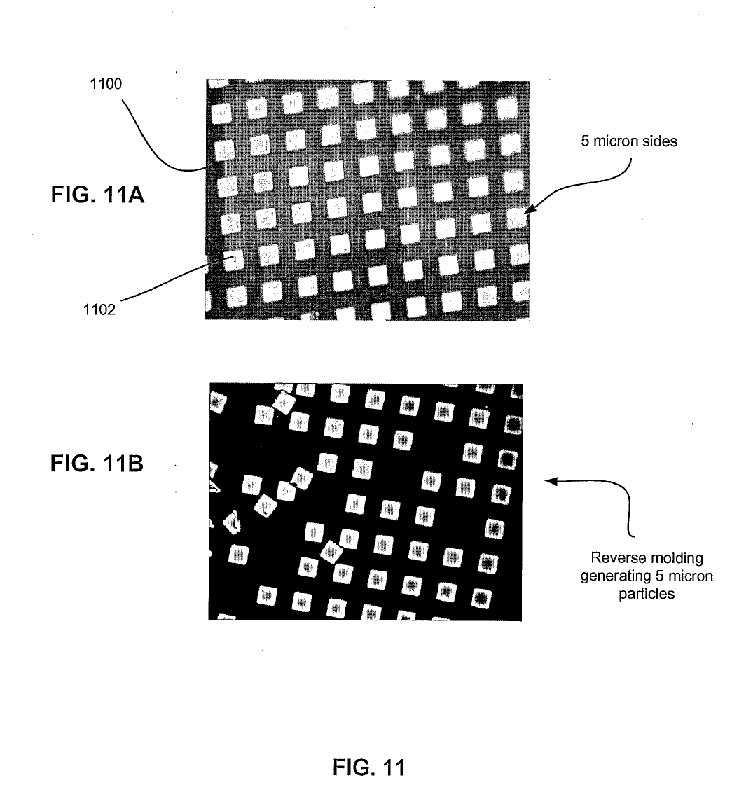

Referring now to FIGS. 10 and 11, in some embodiments the presently disclosed subject matter describes the use of a photocurable perfluoropolyether (PFPE) molded alignment layer 1010, 1100 prepared from a patterned substrate 1002 (FIG. 10), such as a silicon master, to make micron-size (in some embodiments, square, grooves, and the like) and sub-micron size (e.g. about 100-nanometer scale, which in some embodiments can be circular and can act as lenses, square, triangle, uniform, non-uniform, amorphous, grooved, and the like) addressable “containers.” “bubbles” or “wells” 1012, 1102 (FIGS. 10 and 11, showing alternative embodiments, respectively) for liquid crystals (LCs). In some embodiments, for example, “bubbles” or “wells” 1102 in FIG. 11A have 5-micron sides. The sealable PFPE bubbles can be individually activated with an electric field via a subsequent metallization step. Further, as depicted in FIG. 11B, reverse molding can generate 5-micron particles.

Photocurable perfluoropolyether (PFPE) an embossed pattern, such as grooves 1012 shown in FIG. 10, and/or wells 1102 FIG. 11, can be readily made with patterned substrate, such as a silicon master, and subsequent photocuring, Referring to FIG. 10, patterned template 1002 can be brought into communication with substrate 1000, thereby sandwiching liquid polymeric material 1004 therebetween. Liquid polymeric material 1004 become dispersed into grooves 1006 of patterned template 1002. After patterned template 1002 is brought into communication with substrate 1000, treatment 1008, such as for example, UV curing treatment or thermal curing treatment, is applied to the combination. Treatment 1008 activates curing agents contained in polymer material 1004 to cure polymer material into a patterned layer 1010. The patterned layer 1010 contains a mirror image embossed pattern of grooves 1012 of patterned template 1002.

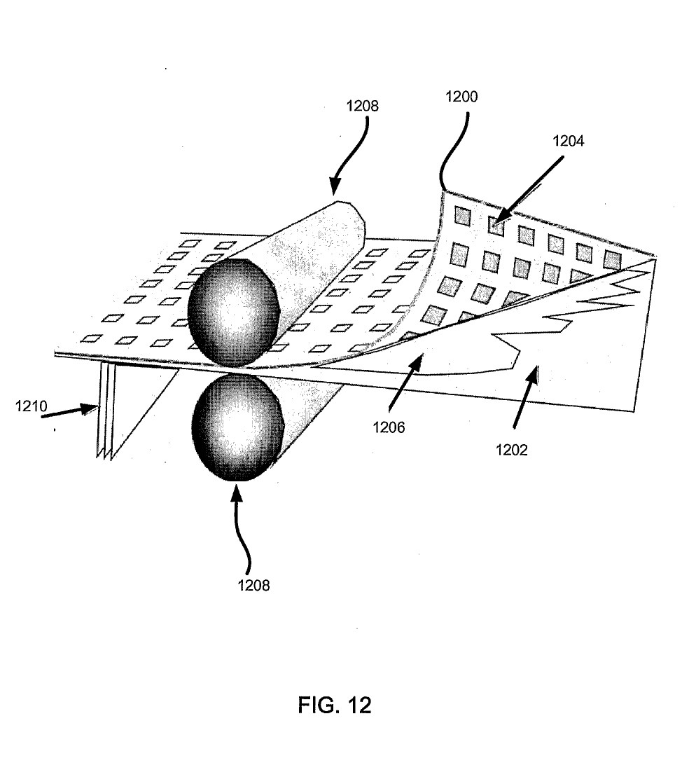

Referring to FIG. 12, in some embodiments, a “top” array of micro-containers 1200 can be sealed to a “bottom” PFPE layer 1202. In some embodiments, top array 1200 is sealed to bottom layer 1202 through a dual cure process described herein. In some embodiments, a liquid crystal 1206 is deposited on a smooth PFPE bottom surface 1202 that, in some embodiments, can be wetted with a PFPE monomer for photo-sealing. Contact between “top” 1200 and “bottom” 1202 PFPE surfaces segregates liquid crystal 1206 into micro-wells or micro-bubbles 1204. The low surface energy of the PFPE material provides a spontaneous perpendicular (homeotropic) director orientation with the micro-bubble. This orientation can be perturbed with an attendant optical response by application of an electric field across the micro-bubble. The intrinsic incompatibility of the photocurable perfluoropolyether (PFPE) material and the LC can provide discreet and separate containment of the LC in micro-wells or bubbles 1204. These micro-wells or “bubbles” can be filled with a nematic liquid crystal (having negative dielectric anisotropy) via a roll-lamination procedure, using rollers 1208, to give distinct liquid crystal “pixels” that can result in an economical, large-area, flexible light valve. During fabrication the alignment layers 1200, 1202 can be treated with curing 1210, such as for example, UV treatment, thermal treatment, or the like to activate components within the alignment layers 1200, 1202 and bind the layers.

The entire flexible panel can be metalized on both sides to give a conducting surface for reorienting the liquid crystal in an applied electric field. Uses can range from “Hue Capturing Based Transient Liquid Crystal Method for High-Resolution Mapping of Convective Heat Transfer on Curved Surfaces” and surface thermometry using cholesteric LCs, to light attenuation wall-sized panels, and the like.

Generally, this approach of well-defined “bubbles” or “pores” lends itself to a number of applications, including, but not limited to: (1) using PFPE as an alternative to conventional matrix-materials for polymer dispersed liquid crystal (PDLC) wide-area light valves; (2) in addition to serving as the low-surface-energy matrix itself for applications, PFPE molds with designed pore-shapes and spacing can be fabricated to mold conventional polymeric matrix materials forming pores in the latter matrix that could subsequently be filled with liquid crystal, which could enable fabrications of field-modulated devices, e.g., micro- and nano-lens arrays, photonic band-gap materials, and phase masks; and (3) more generally, PFPE materials will enable the fabrication of micro- and nano-lens arrays, photonic band-gap materials, and phase masks via high-fidelity molding of conventional materials.

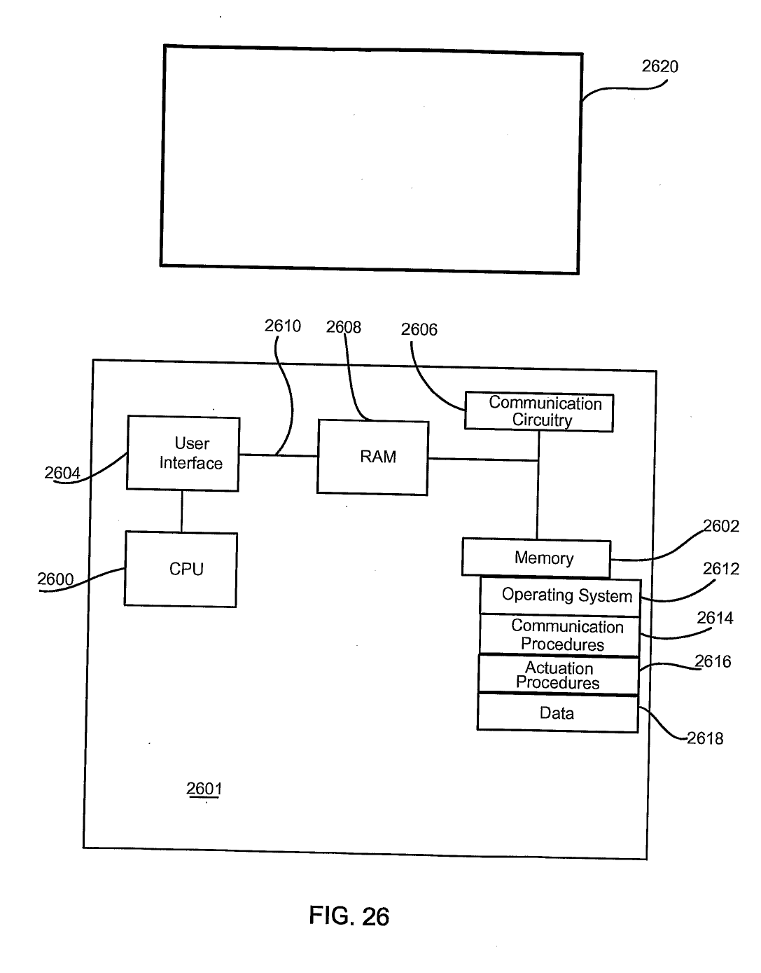

According to some embodiments, a liquid crystal display screen 2620 is controlled by a microprocessor 2601. As shown in FIG. 26, microprocessor 2601 generally includes a central processing unit (CPU) 2600, a memory 2602, user interface 2604, communications interface circuit 2606, a random access memory (RAM) 2608, and a bus 2610 that interconnects these elements. Microprocessor 2601 is programmable and stores data relating to the control, activation, deactivation, and the like of liquid crystal display screen 2620, in memory 2602. The CPU 2600 interprets and executes instructions stored in memory 2602 and instructions input by a user through user interface 2604. Memory 2602 also includes actuation procedures 2616 for controlling procedures of display screen 2620 and thus controlling objects and/or images generated and displayed on display screen 2620, and operation system 2612 and communications procedures 2614.

References that discuss displays in general include, but are not limited to: US 20040135961; JP 2004163780; and JP 2004045784; each of which is incorporated herein by reference in their entirety, including all references cited therein.

References that discuss flexible displays in general include, but are not limited to: JP 2005326825, which is incorporated herein by reference in the entirety, including all references cited therein.

References that discuss polymer alignment layers in general include, but are not limited to: JP 2003057658; JP 2001048904; EP 351718; US 6491988; and JP 2002229030; each of which is incorporated herein by reference in their entirety, including all references cited therein.

References that discuss grooved or patterned alignment layers in general include, but are not limited to: US 2005221009; US 20020126245; Polymer Preprint, ACS (2004), 45(1), 905-906; Adv. Mater. 2005, 17, 1398; Appl. Phys. Lett. 1998, 72(17), 2078; and Appl. Phys. Lett. 2003, 82(23), 4050; each of which is incorporated herein by reference in their entirety, including all references cited therein.

References that discuss fluorine and polymer alignment layers in general include, but are not limited to: JP 2005326439; U.S. Pat. No. 6,682,786; JP 2003238491; CN 1211743; and Applied Physics Letters, Part 2 (2001), 40(4A), L364; each of which is incorporated herein by reference in their entirety, including all references cited therein.

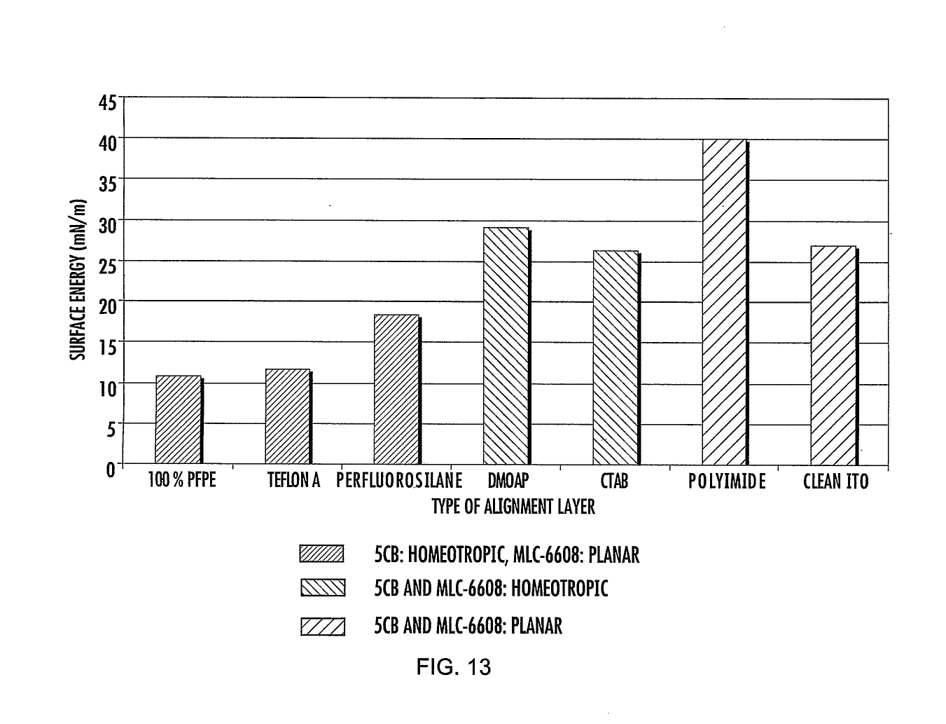

Referring to FIG. 13, a comparison of surface energies of PFPE, including 100% PFPE, and other fluorinated alignment layers with several typical alignment layers, such as Teflon AF, perfluorosilane, N,N-dimethyl-N-octadecyl-3-aminopropyltrimethylsilyl chloride (DMOAP), cetyl trimethylammonium bromide (CTAB), polyimide, and clean ITO, is shown. The surface energy of PFPE is much lower than standard alignment layers currently used and the liquid crystal alignment mode achieved with each type of alignment layer for both positive and negative dielectric liquid crystals, including 5CB:homeotropic, MLC-6608:planar; 5CB and MLC-6608:homeotropic; and 5CB and MLC-6608:planar, is noted in FIG. 13.

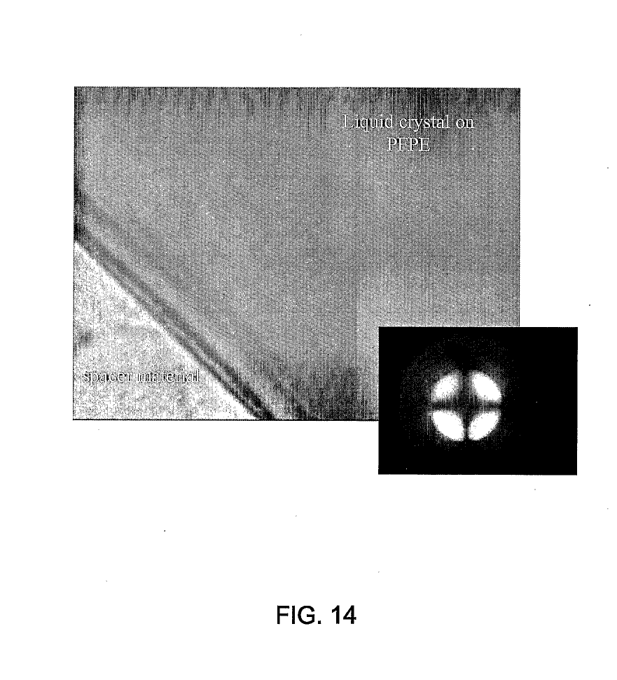

Referring to FIG. 14, a polarizing micrograph of a birefringent texture of a positive dielectric nematic liquid crystal on PFPE shows a spontaneous homeotropic alignment generated by PFPE (see inset).

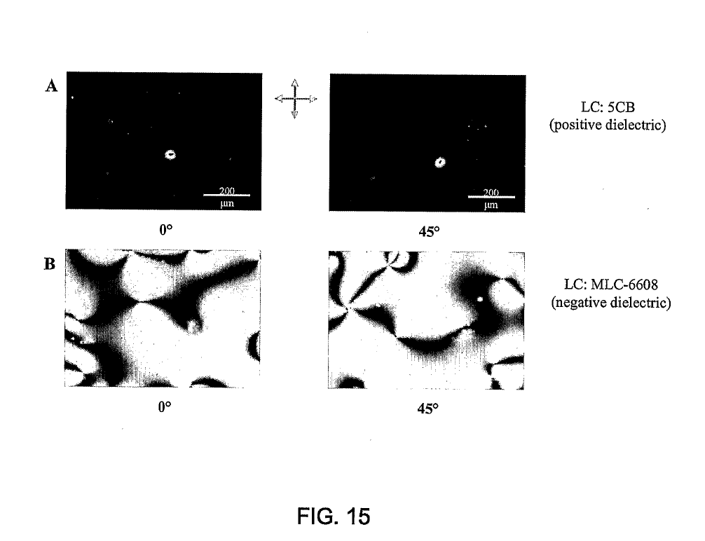

In FIG. 15, polarizing micrographs are shown comparing birefringent textures of a positive and a negative dielectric liquid crystal on PFPE. Part A (left panel, 0°; right panel, 45°) of FIG. 15 shows a spontaneous homeotropic alignment of a positive dielectric nematic liquid crystal, e.g., 5CB, on PFPE and part B (left panel, 0°; right panel, 45°) shows a spontaneous planar alignment of a negative dielectric nematic liquid crystal, e.g., MLC-6608, on PFPE, the planar alignment is not uniform, but exhibits random domains, according to an embodiment of the presently disclosed subject matter, where the orientation of the crossed polarizers are given by the arrows.

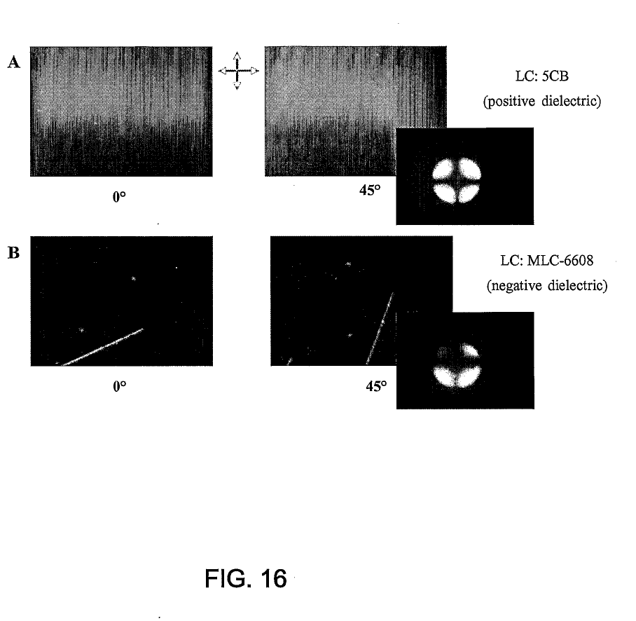

Referring to FIG. 16, Parts A and B (for each: left panel, 0°; right panel, 45°) are polarizing micrographs of liquid crystal alignment on PFPE alignment layers pretreated with toluene. Part A shows spontaneous homeotropic alignment of a positive dielectric nematic liquid crystal, e.g., 5CB (see inset). Part B of FIG. 16 shows spontaneous homeotropic alignment of a negative dielectric nematic liquid crystal, e.g., MLC-6608, according to an embodiment of the presently disclosed subject matter (see inset). Orientation of the crossed polarizers is given by the arrows.

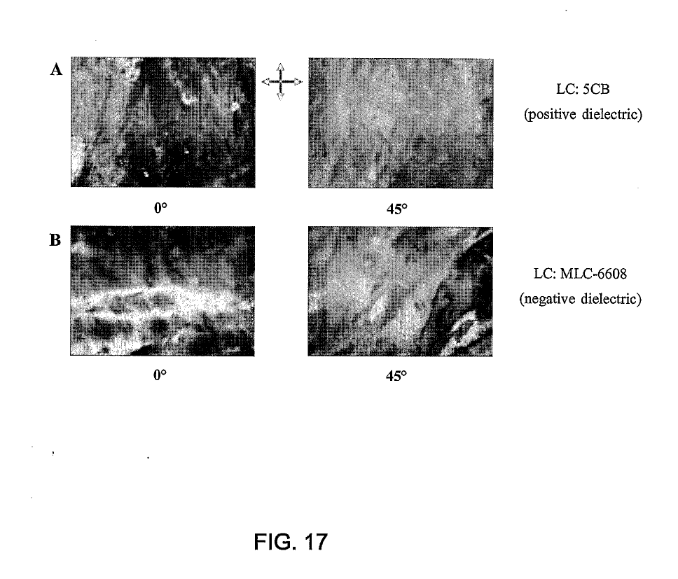

In FIG. 17, Parts A and B (for each: left panel, 0°; right panel, 45°) are polarizing micrographs of liquid crystal alignment on PFPE alignment layers pretreated with water. Part A shows random domains of planar alignment of a positive dielectric nematic liquid crystal, e.g., 5CB, and part B shows random domains of planar alignment of a negative dielectric nematic liquid crystal, e.g., MLC-6608, according to an embodiment of the presently disclosed subject matter. Orientation of the crossed polarizers is given by the arrows.

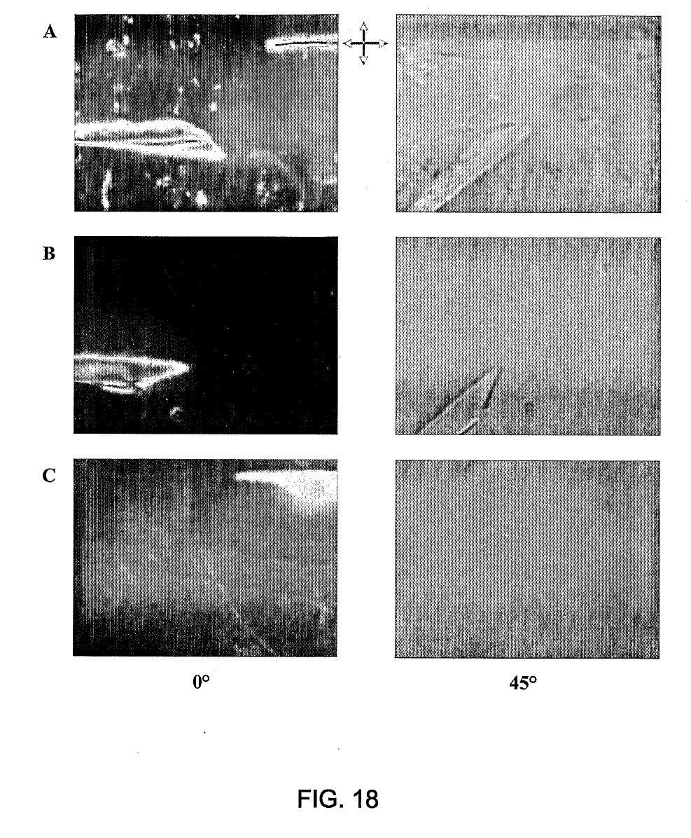

In FIG. 18, parts A, B, and C (for each: left panel, 0°; right panel, 45°) are polarizing micrographs of liquid crystal alignment on PFPE films prepared by a Langmuir-Blodgett (LB) method. Part A shows planar of alignment of a nematic liquid crystal on a PFPE LB film of 1-layer thickness and parts B and C show planar alignment of a nematic liquid crystal on a PFPE LB film of 5-layer thickness and 10-layer thickness, respectively, according to an embodiment of the presently disclosed subject matter.

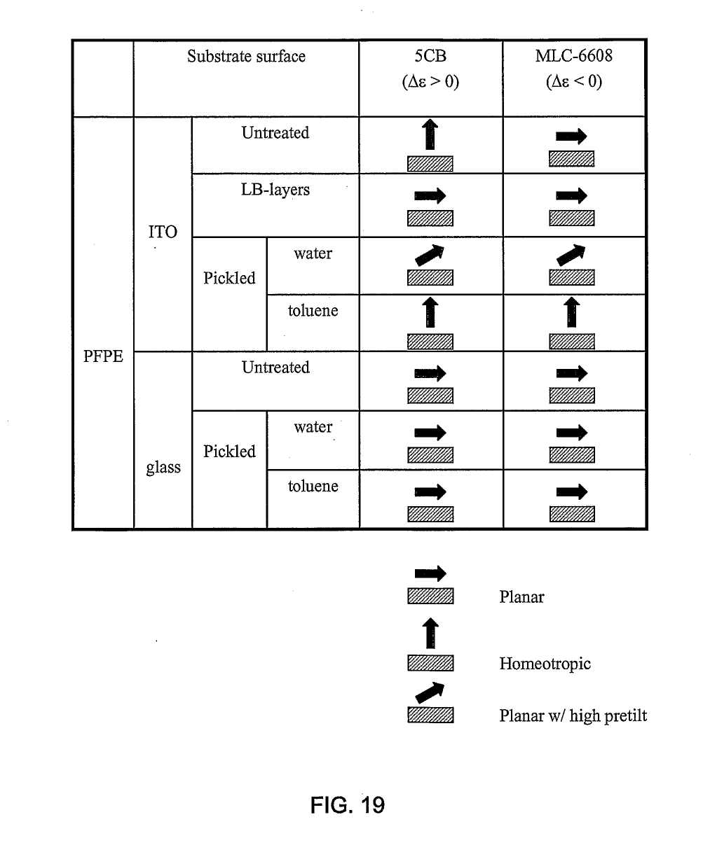

Referring now to FIG. 19, a tabular summary of results of experiments in which PFPE alignment layers were pretreated by either toluene or water is shown.

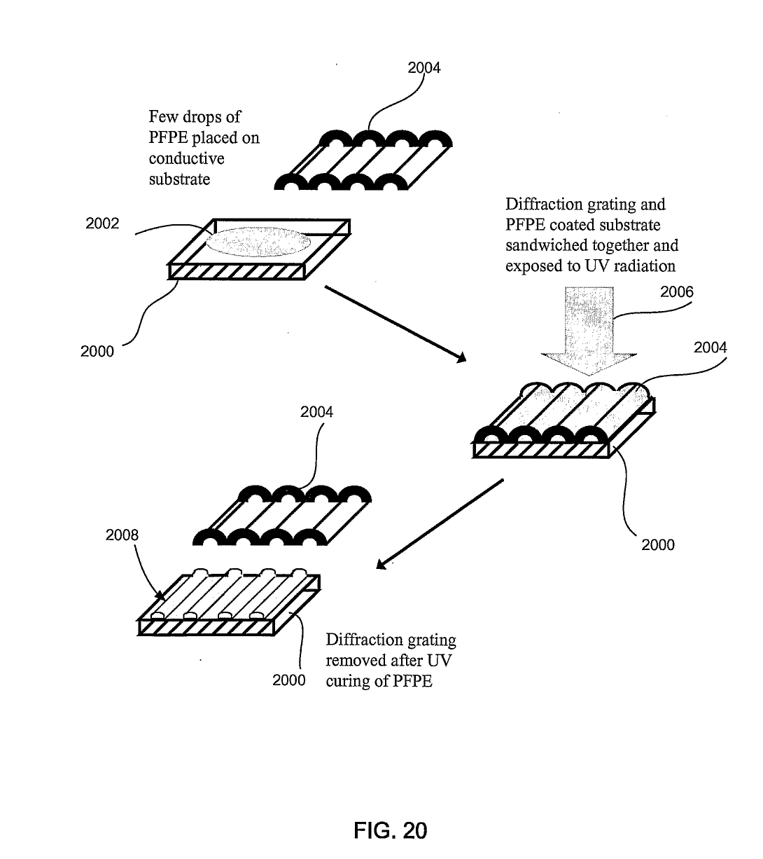

FIG. 20 is a schematic representation of preparation of a grooved PFPE alignment layer by embossing, according to an embodiment of the presently disclosed subject matter. According to FIG. 20, substrate 2000, which in some embodiments includes a conductive substrate, is positioned and receives base material 2002. In some embodiments base material 2002 includes a PFPE material. A patterned diffraction grating template 2004 is positioned with respect to substrate 2000 and brought into contact with base material 2002 on substrate 2000. After positioning patterned diffraction grating template 2004 with respect to substrate 2000, the combination is treated with cure 2006 to activate a curing agent, such as for example, UV cure agent, thermal cure agent, or the like, in base material 2002. After curing 2006, patterned diffraction grating template 2004 is removed leaving alignment layer 2008 with a mirror image of a pattern on patterned diffraction grating template 2004 on alignment layer 2008.

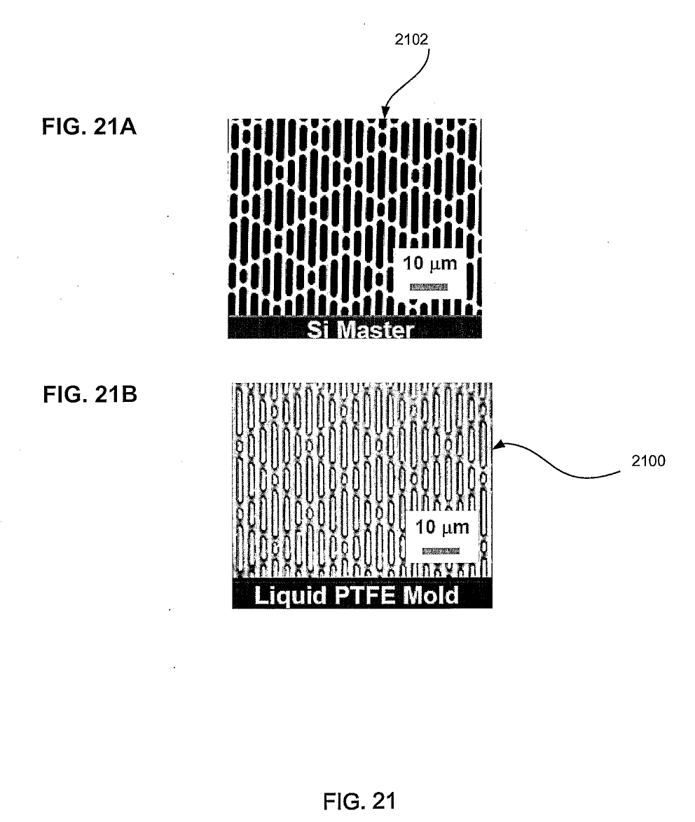

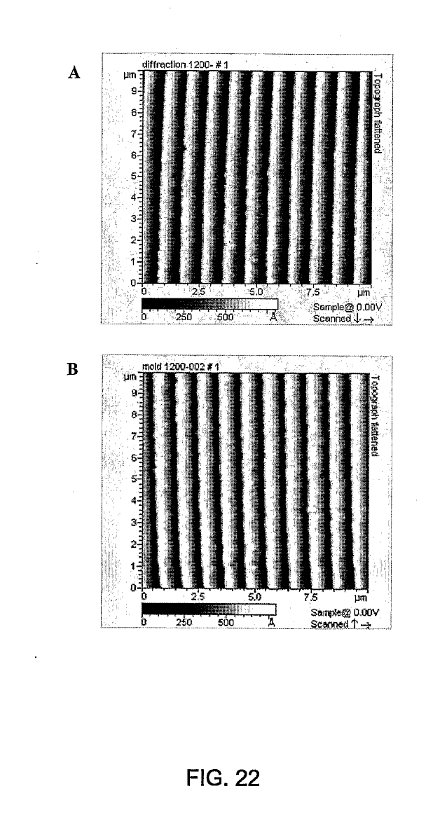

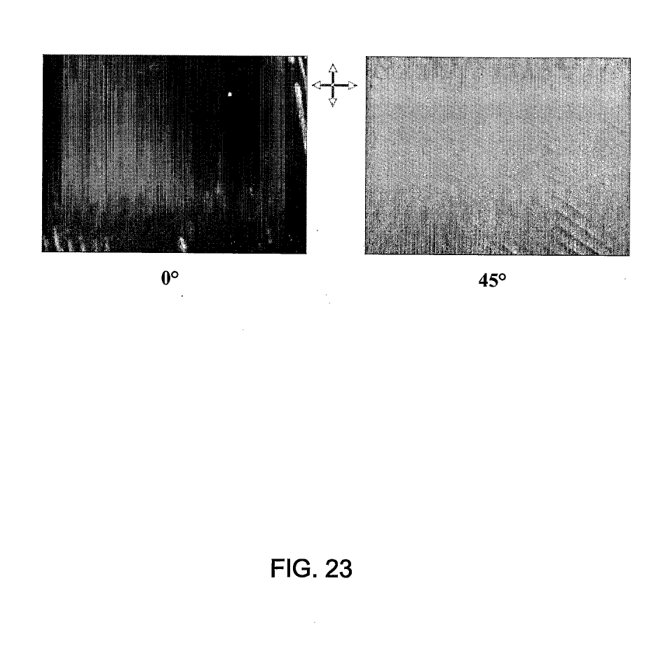

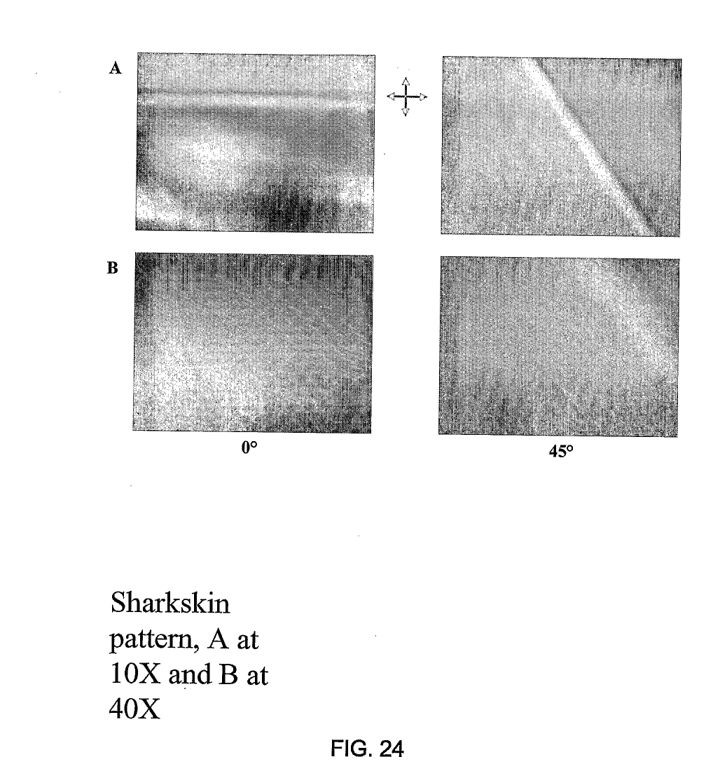

Referring now to FIGS. 21A and 21B, an alignment layer 2100 is shown (FIG. 21B) that has the mirror image of a pattern on patterned template 2102 (FIG. 21A). According to an embodiment of the presently disclosed subject matter, the pattern shown in FIGS. 21A and 21B resembles a “sharkskin” type design. Referring now to FIG. 22, parts A and B show atomic force microscopy images of a diffraction grating master and PFPE replica, the sinusoidal grooves of the diffraction grating are exactly replicated. FIG. 23 is a set of polarizing micrographs (left panel, 0°; right panel, 45°) of planar liquid crystal alignment on an embossed PFPE film shown in FIG. 22. FIGS. 24A and 24B (for each: left panel, 0°; right panel, 45°) each show a polarizing micrograph of planar liquid crystal alignment on a PFPE film embossed with a sharkskin pattern, such as the pattern represented in FIGS. 21A and 21B. Different magnifications of the patterned layer surface are provided in the different images of FIGS. 24A and 24B, e.g., FIG. 24A is 10× magnification and FIG. 24B is 40× magnification.

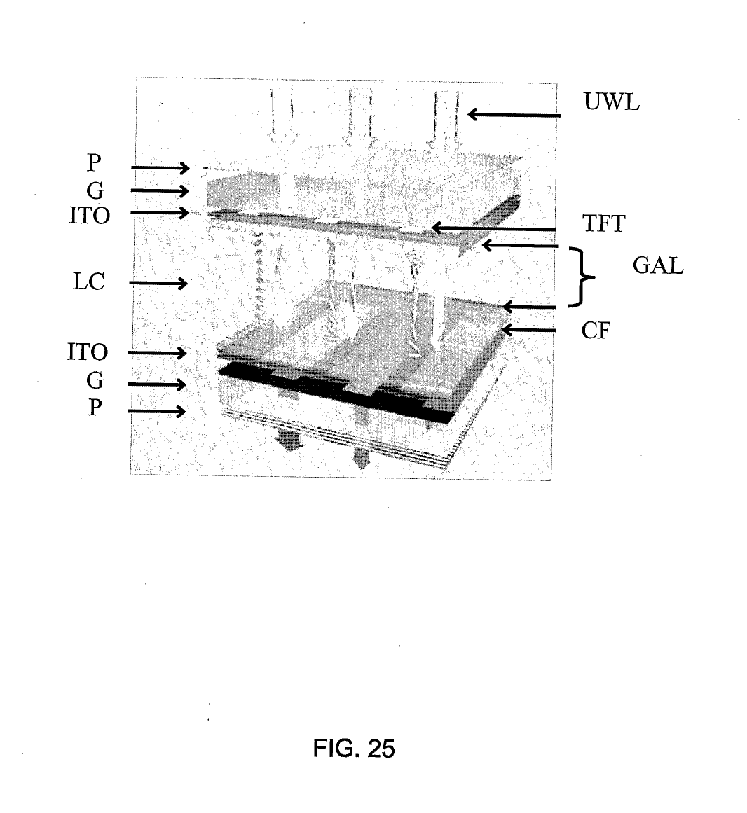

Referring now to FIG. 25, a schematic representation of a thin-film transistor TFT often used in color displays is shown. FIG. 25 illustrates components comprising unpolarized white light UWL, polarizer P, glass G, indium tin oxide ITO, TF transistor TFT, grooved alignment layers GAL, liquid crystal LC, and color filter CF in operative communication.

### XV. EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### General Considerations

A PFPE device has been previously reported by Rolland, J. et al. JACS 2004, 126, 2322-2323, which is incorporated herein by reference in its entirety. The specific PFPE material disclosed in Rolland, J. et al., was not chain extended and therefore did not possess the multiple hydrogen bonds that are present when PFPEs are chain extended with a diisocyanate linker. Nor did the material posses the higher molecular weights between crosslinks that are needed to improve mechanical properties such as modulus and tear strength which are critical to a variety of applications. Furthermore, this material was not functionalized to incorporate various moieties, such as a charged species, a biopolymer, or a catalyst.

Herein is described a variety of methods to address these issues. Included in these improvements are methods which describe chain extension, improved adhesion to multiple PFPE layers and to other substrates such as glass, silicon, quartz, and other polymers as well as the ability to incorporate functional monomers capable of changing wetting properties or of attaching catalysts, biomolecules or other species. Also described are improved methods of curing PFPE elastomers which involve thermal free radical cures, two-component curing chemistries, and photocuring using photoacid generators.

### Example 1

A liquid PFPE precursor having the structure shown below (where n=2) is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. Separately, a second master containing 100-μm features in the shape of channels is spin coated with a small drop of the liquid PFPE precursor over top of it at 3700 rpm for 1 minute to a thickness of about 20 μm. The wafer is then placed in a UV chamber and exposed to UV light (λ=365) for 10 minutes under a nitrogen purge. Thirdly, a smooth, flat PFPE layer is generated by drawing a doctor's blade across a small drop of the liquid PFPE precursor across a glass slide. The Slide is then placed in a UV chamber and exposed to UV light (λ=365) for 10 minutes under a nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 120° C. for 2 hours. The thin layer is then trimmed and the adhered layers are lifted from the master. Fluid inlet holes and outlet holes are punched using a luer stub. The bonded layers are then placed on the fully cured PFPE smooth layer on the glass slide and allowed to heat at 120° C. for 15 hours. Small needles can then be placed in the inlets to introduce fluids and to actuate membrane valves as reported by Unger, M. et al. Science. 2000, 288, 113-6.

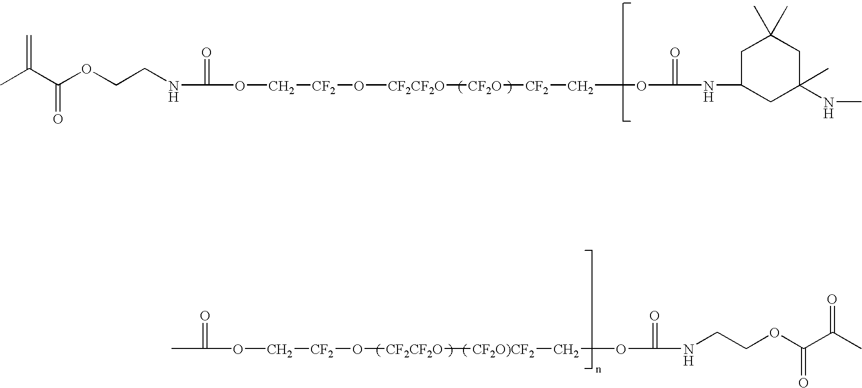

### Example 2

### Thermal Free Radical

### Glass

A liquid PFPE precursor encapped with methacrylate groups is blended with 1 wt % of 2,2-Azobisisobutyronitrile and poured over a microfluidics master containing 100-μm features in the shape of channels. A PDMS mold is used to contain the liquid in the desired area to a thickness of about 3 mm. The wafer is then placed in an oven at 65° C. for 20 hours under nitrogen purge. The cured layer is then removed, trimmed, and inlet holes are punched through it using a luer stub. The layer is then placed on top of a clean glass slide and fluids can be introduced through the inlet holes.

### Example 3

### Thermal Free Radical—Partial Cure

### Layer to Layer Adhesion

A liquid PFPE precursor encapped with methacrylate groups is blended with 1 wt % of 2,2-Azobisisobutyronitrile and poured over a microfluidics master containing 100-μm features in the shape of channels. A PDMS mold is used to contain the liquid in the desired area to a thickness of about 3 mm. The wafer is then placed in an oven at 65° C. for 2-3 hours under nitrogen purge. Separately, a second master containing 100-μm features in the shape of channels is spin coated with a small drop of the liquid PFPE precursor over top of it at 3700 rpm for 1 minute to a thickness of about 20 μm. The wafer is then placed in an oven at 65° C. for 2-3 hours under nitrogen purge. Thirdly, a smooth, flat PFPE layer is generated by drawing a doctor's blade across a small drop of the liquid PFPE precursor across a glass slide. The wafer is then placed in an oven at 65° C. for 2-3 hours under nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 65° C. for 10 hours. The thin layer is then trimmed and the adhered layers are lifted from the master. Fluid inlet holes and outlet holes are punched using a luer stub. The bonded layers are then placed on the partially cured PFPE smooth layer on the glass slide and allowed to heat at 65° C. for 10 hours. Small needles can then be placed in the inlets to introduce fluids and to actuate membrane valves as reported by Unger, M. et al. Science. 2000, 288, 113-6.

### Example 4

### Thermal Free Radical—Partial Cure

### Adhesion to Polyurethane

A photocurable liquid polyurethane precursor containing methacrylate groups is blended with 1 wt % of 2,2-Azobisisobutyronitrile and poured over a microfluidics master containing 100-μm features in the shape of channels. A PDMS mold is used to contain the liquid in the desired area to a thickness of approximately 3 mm. The wafer is then placed in an oven at 65° C. for 2-3 hours under nitrogen purge. Separately, a second master containing 100-μm features in the shape of channels is spin coated with a small drop of the liquid PFPE precursor over top of it at 3700 rpm for 1 minute to a thickness of approximately 20 μm. The wafer is then placed in an oven at 65° C. for 2-3 hours under nitrogen purge. Thirdly, a smooth, flat PFPE layer is generated by drawing a doctor's blade across a small drop of the liquid PFPE precursor across a glass slide. The wafer is then placed in an oven at 65° C. for 2-3 hours under nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 65° C. for 10 hours. The thin layer is then trimmed and the adhered layers are lifted from the master. Fluid inlet holes and outlet holes are punched using a luer stub. The bonded layers are then placed on the partially cured PFPE smooth layer on the glass slide and allowed to heat at 65° C. for 10 hours. Small needles can then be placed in the inlets to introduce fluids and to actuate membrane valves as reported by Unger, M. et al. Science. 2000, 288, 113-6.

### Example 5

### Thermal Free Radical—Partial Cure

### Adhesion to Silicone-Containing Polyurethane

A photocurable liquid polyurethane precursor containing PDMS blocks and methacrylate groups is blended with 1 wt % of 2,2-Azobisisobutyronitrile and poured over a microfluidics master containing 100-μm features in the shape of channels. A PDMS mold is used to contain the liquid in the desired area to a thickness of approximately 3 mm. The wafer is then placed in an oven at 65° C. for 2-3 hours under nitrogen purge. Separately, a second master containing 100-μm features in the shape of channels is spin coated with a small drop of the liquid PFPE precursor over top of it at 3700 rpm for 1 minute to a thickness of approximately 20 μm. The wafer is then placed in an oven at 65° C. for 2-3 hours under nitrogen purge. Thirdly, a smooth, flat PFPE layer is generated by drawing a doctor's blade across a small drop of the liquid PFPE precursor across a glass slide. The wafer is then placed in an oven at 65° C. for 2-3 hours under nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 65° C. for 10 hours. The thin layer is then trimmed and the adhered layers are lifted from the master. Fluid inlet holes and outlet holes are punched using a luer stub. The bonded layers are then placed on the partially cured PFPE smooth layer on the glass slide and allowed to heat at 65° C. for 10 hours. Small needles can then be placed in the inlets to introduce fluids and to actuate membrane valves as reported by Unger, M. et al. Science. 2000, 288, 113-6.

### Example 6

### Thermal Free Radical—Partial Cure

### Adhesion to PFPE-PDMS Block Copolymer

A liquid precursor containing both PFPE and PDMS blocks encapped with methacrylate groups is blended with 1 wt % of 2,2-Azobisisobutyronitrile and poured over a microfluidics master containing 100-μm features in the shape of channels. A PDMS mold is used to contain the liquid in the desired area to a thickness of approximately 3 mm. The wafer is then placed in an oven at 65° C. for 2-3 hours under nitrogen purge. Separately, a second master containing 100-μm features in the shape of channels is spin coated with a small drop of the liquid PFPE precursor over top of it at 3700 rpm for 1 minute to a thickness of approximately 20 μm. The wafer is then placed in an oven at 65° C. for 2-3 hours under nitrogen purge. Thirdly, a smooth, flat PFPE layer is generated by drawing a doctor's blade across a small drop of the liquid PFPE precursor across a glass slide. The wafer is then placed in an oven at 65° C. for 2-3 hours under nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 65° C. for 10 hours. The thin layer is then trimmed and the adhered layers are lifted from the master. Fluid inlet holes and outlet holes are punched using a luer stub. The bonded layers are then placed on the partially cured PFPE smooth layer on the glass slide and allowed to heat at 65° C. for 10 hours. Small needles can then be placed in the inlets to introduce fluids and to actuate membrane valves as reported by Unger, M. et al. Science. 2000, 288, 113-6.

### Example 7

### Thermal Free Radical—Partial Cure

### Glass Adhesion

A liquid PFPE precursor encapped with methacrylate groups is blended with 1 wt % of 2,2-Azobisisobutyronitrile and poured over a microfluidics master containing 100-μm features in the shape of channels. A PDMS mold is used to contain the liquid in the desired area to a thickness of about 3 mm. The wafer is then placed in an oven at 65° C. for 2-3 hours under nitrogen purge. The partially cured layer is removed from the wafer and inlet holes are punched using a luer stub. The layer is then placed on top of a glass slide treated with a silane coupling agent, trimethoxysilyl propyl methacrylate. The layer is then placed in an oven and allowed to heat at 65° C. for 20 hours, permanently bonding the PFPE layer to the glass slide. Small needles can then be placed in the inlets to introduce fluids.

### Example 8

### Thermal Free Radical—Partial Cure

### PDMS Adhesion

A liquid poly(dimethylsiloxane) precursor poured over a microfluidics master containing 100-μm features in the shape of channels. The wafer is then placed in an oven at 80° C. for 3 hours. Separately, a second master containing 100-μm features in the shape of channels is spin coated with a small drop of liquid PFPE precursor encapped with methacrylate units at 3700 rpm for 1 minute to a thickness of about 20 μm. The wafer is then placed in an oven at 65° C. for 2-3 hours under nitrogen purge. The PDMS layer is then removed, trimmed, and inlet holes are punched through it using a luer stub. The layer is then treated with an oxygen plasma for 20 minutes followed by treatment with a silane coupling agent, trimethoxysilyl propyl methacrylate. The treated PDMS layer is then placed on top of the partially cured PFPE thin layer and heated at 65° C. for 10 hours. The thin layer is then trimmed and the adhered layers are lifted from the master. Fluid inlet holes and outlet holes are punched using a luer stub. The bonded layers are then placed on the partially cured PFPE smooth layer on the glass slide and allowed to heat at 65° C. for 10 hours. Small needles can then be placed in the inlets to introduce fluids and to actuate membrane valves as reported by Unger, M. et al. Science. 2000, 288, 113-6.

### Example 9

### Thermal Free Radical

### PDMS Adhesion using SYLGARD 184® and Functional PDMS

A liquid poly(dimethylsiloxane) precursor is designed such that it can be part of the base or curing component of SYLGARD 184®. The precursor contains latent functionalities such as epoxy, methacrylate, or amines and is mixed with the standard curing agents and poured over a microfluidics master containing 100-μm features in the shape of channels. The wafer is then placed in an oven at 80° C. for 3 hours. Separately, a second master containing 100-μm features in the shape of channels is spin coated with a small drop of liquid PFPE precursor encapped with methacrylate units at 3700 rpm for 1 minute to a thickness of approximately 20 μm. The wafer is then placed in an oven at 65° C. for 2-3 hours under nitrogen purge. The PDMS layer is then removed, trimmed, and inlet holes are punched through it using a luer stub. The PDMS layer is then placed on top of the partially cured PFPE thin layer and heated at 65° C. for 10 hours. The thin layer is then trimmed and the adhered layers are lifted from the master. Fluid inlet holes and outlet holes are punched using a luer stub. The bonded layers are then placed on the partially cured PFPE smooth layer on the glass slide and allowed to heat at 65° C. for 10 hours. Small needles can then be placed in the inlets to introduce fluids and to actuate membrane valves as reported by Unger, M. et al. Science. 2000, 288, 113-6.

### Example 10

### Epoxy/Amine

A two-component liquid PFPE precursor system such as shown below containing a PFPE diepoxy and a PFPE diamine are blended together in a stoichiometric ratio and poured over a microfluidics master containing 100-μm features in the shape of channels. A PDMS mold is used to contain the liquid in the desired area to a thickness of about 3 mm. The wafer is then placed in an oven at 65° C. for 5 hours. The cured layer is then removed, trimmed, and inlet holes are punched through it using a luer stub. The layer is then placed on top of a clean glass slide and fluids can be introduced through the inlet holes.

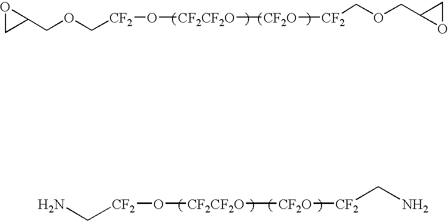

### Example 11

### Epoxy/Amine—Excess

### Adhesion to Glass

A two-component liquid PFPE precursor system such as shown below containing a PFPE diepoxy and a PFPE diamine are blended together in a 4:1 epoxy:amine ratio such that there is an excess of epoxy and poured over a microfluidics master containing 100-μm features in the shape of channels.

A PDMS mold is used to contain the liquid in the desired area to a thickness of about 3 mm. The wafer is then placed in an oven at 65° C. for 5 hours. The cured layer is then removed, trimmed, and inlet holes are punched through it using a luer stub. The layer is then placed on top of a clean glass slide that has been treated with a silane coupling agent, aminopropyltriethoxy silane. The slide is then heated at 65° C. for 5 hours to permanently bond the device to the glass slide. Fluids can then be introduced through the inlet holes.

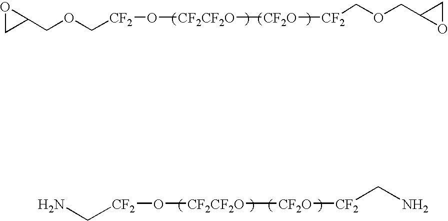

### Example 12

### Epoxy/Amine—Excess

### Adhesion to PFPE layers

A two-component liquid PFPE precursor system such as shown below containing a PFPE diepoxy and a PFPE diamine are blended together in a 1:4 epoxy:amine ratio such that there is an excess of amine and poured over a microfluidics master containing 100-μm features in the shape of channels. A PDMS mold is used to contain the liquid in the desired area to a thickness of about 3 mm. Separately, a second master containing 100-μm features in the shape of channels is coated with a small drop of liquid PFPE precursors blended in a 4:1 epoxy:amine ratio such that there is an excess of epoxy units and spin coated at 3700 rpm for 1 minute to a thickness of about 20 μm. The wafer is then placed in an oven at 65° C. for 5 hours. The thick layer is then removed, trimmed, and inlet holes are punched through it using a luer stub. The thick layer is then placed on top of the cured PFPE thin layer and heated at 65° C. for 5 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane and heated in an oven at 65° C. for 5 hours to adhere the device to the glass slide. Small needles can then be placed in the inlets to introduce fluids and to actuate membrane valves as reported by Unger, M. et al. Science. 2000, 288, 113-6.

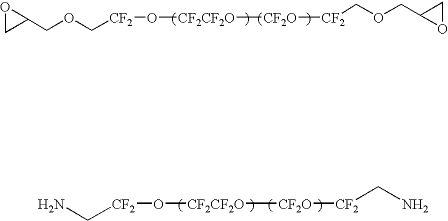

### Example 13

### Epoxy/Amine—Excess

### Adhesion to PDMS Layers

A liquid poly(dimethylsiloxane) precursor is poured over a microfluidics master containing 100-μm features in the shape of channels. The wafer is then placed in an oven at 80° C. for 3 hours. Separately, a second master containing 100-μm features in the shape of channels is coated with a small drop of liquid PFPE precursors blended in a 4:1 epoxy:amine ratio such that there is an excess of epoxy units and spin coated at 3700 rpm for 1 minute to a thickness of about 20 μm. The wafer is then placed in an oven at 65° C. for 5 hours. The PDMS layer is then removed, trimmed, and inlet holes are punched through it using a luer stub. The layer is then treated with an oxygen plasma for 20 minutes followed by treatment with a silane coupling agent, aminopropyltriethoxy silane. The treated PDMS layer is then placed on top of the PFPE thin layer and heated at 65° C. for 10 hours to adhere the two layers. The thin layer is then trimmed and the adhered layers are lifted from the master. Fluid inlet holes and outlet holes are punched using a luer stub. The bonded layers are then placed on a glass slide treated with aminopropyltriethoxy silane and allowed to heat at 65° C. for 10 hours. Small needles can then be placed in the inlets to introduce fluids and to actuate membrane valves as reported by Unger, M. et al. Science. 2000, 288, 113-6.

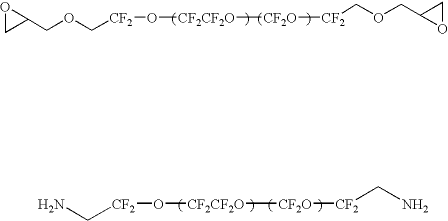

### Example 14

### Epoxy/Amine—Excess

### Adhesion to PFPE Layers, Attachment of a Biomolecule

A two-component liquid PFPE precursor system such as shown below containing a PFPE diepoxy and a PFPE diamine are blended together in a 1:4 epoxy:amine ratio such that there is an excess of amine and poured over a microfluidics master containing 100-μm features in the shape of channels. A PDMS mold is used to contain the liquid in the desired area to a thickness of about 3 mm. Separately, a second master containing 100-μm features in the shape of channels is coated with a small drop of liquid PFPE precursors blended in a 4:1 epoxy:amine ratio such that there is an excess of epoxy units and spin coated at 3700 rpm for 1 minute to a thickness of about 20 μm. The wafer is then placed in an oven at 65° C. for 5 hours. The thick layer is then removed, trimmed, and inlet holes are punched through it using a luer stub. The thick layer is then placed on top of the cured PFPE thin layer and heated at 65° C. for 5 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane and heated in an oven at 65° C. for 5 hours to adhere the device to the glass slide. Small needles can then be placed in the inlets to introduce fluids and to actuate membrane valves as reported by Unger, M. et al. Science. 2000, 288, 113-6. An aqueous solution containing a protein functionalized with a free amine is then flowed through the channel which is lined with unreacted epoxy moieties, in such a way that the channel is then functionalized with the protein.

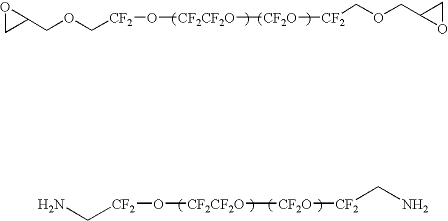

### Example 15

### Epoxy/Amine—Excess

### Adhesion to PFPE layers, Attachment of a Charged Species

A two-component liquid PFPE precursor system such as shown below containing a PFPE diepoxy and a PFPE diamine are blended together in a 1:4 epoxy:amine ratio such that there is an excess of amine and poured over a microfluidics master containing 100-μm features in the shape of channels. A PDMS mold is used to contain the liquid in the desired area to a thickness of about 3 mm. Separately, a second master containing 100-μm features in the shape of channels is coated with a small drop of liquid PFPE precursors blended in a 4:1 epoxy:amine ratio such that there is an excess of epoxy units and spin coated at 3700 rpm for 1 minute to a thickness of about 20 μm. The wafer is then placed in an oven at 65° C. for 5 hours. The thick layer is then removed, trimmed, and inlet holes are punched through it using a luer stub. The thick layer is then placed on top of the cured PFPE thin layer and heated at 65° C. for 5 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane and heated in an oven at 65° C. for 5 hours to adhere the device to the glass slide. Small needles can then be placed in the inlets to introduce fluids and to actuate membrane valves as reported by Unger, M. et al. Science. 2000, 288, 113-6. An aqueous solution containing a charged molecule functionalized with a free amine is then flowed through the channel which is lined with unreacted epoxy moieties, in such a way that the channel is then functionalized with the charged molecule.

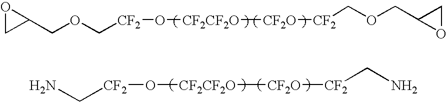

### Example 16

### Epoxy/Amine—Partial Cure

### Adhesion to Glass

A two-component liquid PFPE precursor system such as shown below containing a PFPE diepoxy and a PFPE diamine are blended together in a stoichiometric ratio and poured over a microfluidics master containing 100-μm features in the shape of channels. A PDMS mold is used to contain the liquid in the desired area to a thickness of about 3 mm. The wafer is then placed in an oven at 65° C. for 0.5 hours such that it is partially cured. The partially cured layer is then removed, trimmed, and inlet holes are punched through it using a luer stub. The layer is then placed on a glass slide treated with a silane coupling agent, aminopropyltriethoxy silane, and allowed to heat at 65° C. for 5 hours such that it is adhered to the glass slide. Small needles can then be placed in the inlets to introduce fluids.

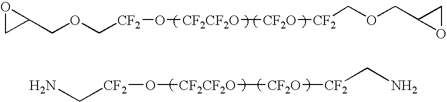

### Example 17

### Epoxy/Amine—Partial Cure

### Layer to Layer Adhesion

A two-component liquid PFPE precursor system such as shown below containing a PFPE diepoxy and a PFPE diamine are blended together in a stoichiometric ratio and poured over a microfluidics master containing 100-μm features in the shape of channels. A PDMS mold is used to contain the liquid in the desired area to a thickness of about 3 mm. The wafer is then placed in an oven at 65° C. for 0.5 hours such that it is partially cured. The partially cured layer is then removed, trimmed, and inlet holes are punched through it using a luer stub. Separately, a second master containing 100-μm features in the shape of channels is spin coated with a small drop of the liquid PFPE precursors over top of it at 3700 rpm for 1 minute to a thickness of about 20 μm. The wafer is then placed in an oven at 65° C. for 0.5 hours such that it is partially cured. The thick layer is then placed on top of the 20-μm thick layer and aligned in the desired area to form a seal. The layers are then placed in an oven and allowed to heat at 65° C. for 1 hour to adhere the two layers. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 10 hours. Small needles can then be placed in the inlets to introduce fluids and to actuate membrane valves as reported by Unger, M. et al. Science. 2000, 288, 113-6.

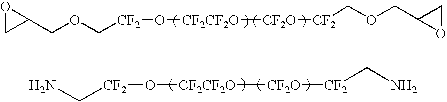

### Example 18

### Epoxy/Amine—Partial Cure

### PDMS Adhesion

A liquid poly(dimethylsiloxane) precursor is poured over a microfluidics master containing 100-μm features in the shape of channels. The wafer is then placed in an oven at 80° C. for 3 hours. The cured PDMS layer is then removed, trimmed, and inlet holes are punched through it using a luer stub. The layer is then treated with an oxygen plasma for 20 minutes followed by treatment with a silane coupling agent, aminopropyltriethoxy silane. Separately, a second master containing 100-μm features in the shape of channels is spin coated with a small drop of liquid PFPE precursors mixed in a stoichiometric ratio at 3700 rpm for 1 minute to a thickness of about 20 μm. The wafer is then placed in an oven at 65° C. for 0.5 hours. The treated PDMS layer is then placed on top of the partially cured PFPE thin layer and heated at 65° C. for 1 hour. The thin layer is then trimmed and the adhered layers are lifted from the master. Fluid inlet holes and outlet holes are punched using a luer stub. The bonded layers are then placed on a glass slide treated with aminopropyltriethoxy silane and allowed to heat at 65° C. for 10 hours. Small needles can then be placed in the inlets to introduce fluids and to actuate membrane valves as reported by Unger, M. et al. Science. 2000, 288, 113-6.

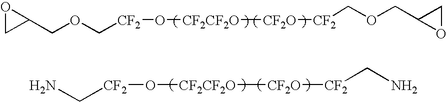

### Example 19

### Photocuring with Latent Functional Groups Available Post Cure

### Adhesion to Glass

A liquid PFPE precursor having the structure shown below (where R is an epoxy group, the curvy lines are PFPE chains, and the circle is a linking molecule) is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge.

The fully cured layer is then removed from the master and inlet holes are punched using a luer stub. The device is placed on a glass slide treated with a silane coupling agent, aminopropyltriethoxy silane, and allowed to heat at 65° C. for 15 hours permanently bonding the device to the glass slide. Small needles can then be placed in the inlets to introduce fluids.

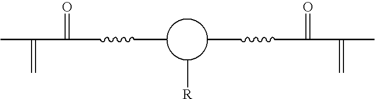

### Example 20

### Photocuring with Latent Functional Groups Available Post Cure

### Adhesion to PFPE

A liquid PFPE precursor having the structure shown below (where R is an epoxy group), the curvy lines are PFPE chains, and the circle is a linking molecule) is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. The fully cured layer is then removed from the master and inlet holes are punched using a luer stub. Separately a second master containing 100-μm features in the shape of channels is spin coated with a small drop of the liquid PFPE precursor (where R is an amine group) over top of it at 3700 rpm for 1 minute to a thickness of about 20 μm. The wafer is then placed in a UV chamber and exposed to UV light (λ=365) for 10 minutes under a nitrogen purge. The thicker layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6.

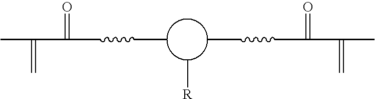

### Example 21

### Photocuring w/Latent Functional Groups Available Post Cure

### Adhesion to PDMS

A liquid poly(dimethylsiloxane) precursor is poured over a microfluidics master containing 100-μm features in the shape of channels. The wafer is then placed in an oven at 80° C. for 3 hours. The cured PDMS layer is then removed, trimmed, and inlet holes are punched through it using a luer stub. The layer is then treated with an oxygen plasma for 20 minutes followed by treatment with a silane coupling agent, aminopropyltriethoxy silane. Separately a second master containing 100-μm features in the shape of channels is spin coated with a small drop of the liquid PFPE precursor (where R is an epoxy) over top of it at 3700 rpm for 1 minute to a thickness of about 20 μm. The wafer is then placed in a UV chamber and exposed to UV light (λ=365) for 10 minutes under a nitrogen purge. The thicker PDMS layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6.

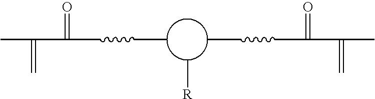

### Example 22

### Photocuring with Latent Functional Groups Available Post Cure

### Attachment of Biomolecule

A liquid PFPE precursor having the structure shown below (where R is an amine group), the curvy lines are PFPE chains, and the circle is a linking molecule) is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. The fully cured layer is then removed from the master and inlet holes are punched using a luer stub. Separately a second master containing 100-μm features in the shape of channels is spin coated with a small drop of the liquid PFPE precursor (where R is an epoxy group) over top of it at 3700 rpm for 1 minute to a thickness of about 20 μm. The wafer is then placed in a UV chamber and exposed to UV light (λ=365) for 10 minutes under a nitrogen purge. The thicker layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6. An aqueous solution containing a protein functionalized with a free amine is then flowed through the channel which is lined with unreacted epoxy moieties, in such a way that the channel is then functionalized with the protein.

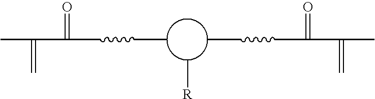

### Example 23

### Photocuring with Latent Functional Groups Available Post Cure Attachment of Charged Species

A liquid PFPE precursor having the structure shown below (where R is an amine group), the curvy lines are PFPE chains, and the circle is a linking molecule) is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. The fully cured layer is then removed from the master and inlet holes are punched using a luer stub. Separately a second master containing 100-μm features in the shape of channels is spin coated with a small drop of the liquid PFPE precursor (where R is an epoxy group) over top of it at 3700 rpm for 1 minute to a thickness of about 20 μm. The wafer is then placed in a UV chamber and exposed to UV light (λ=365) for 10 minutes under a nitrogen purge. The thicker layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6. An aqueous solution containing a charged molecule functionalized with a free amine is then flowed through the channel which is lined with unreacted epoxy moieties, in such a way that the channel is then functionalized with the charged molecule.

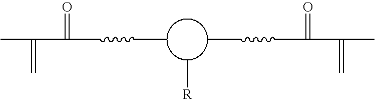

### Example 24

### Photocuring with Functional Monomers Available Post Cure Adhesion to Glass

A liquid PFPE dimethacrylate precursor or a monomethacrylate PFPE macromonomer is blended with a monomer having the structure shown below (where R is an epoxy group) and blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. The fully cured layer is then removed from the master and inlet holes are punched using a luer stub. The device is placed on a glass slide treated with a silane coupling agent, aminopropyltriethoxy silane, and allowed to heat at 65° C. for 15 hours permanently bonding the device to the glass slide. Small needles can then be placed in the inlets to introduce fluids.

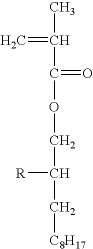

### Example 25

### Photocuring with Functional Monomers Available Post Cure Adhesion to PFPE

A liquid PFPE dimethacrylate precursor is blended with a monomer having the structure shown below (where R is an epoxy group) and blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. The fully cured layer is then removed from the master and inlet holes are punched using a luer stub. Separately a second master containing 100-μm features in the shape of channels is spin coated with a small drop of the liquid PFPE precursor plus functional (where R is an amine group) over top of it at 3700 rpm for 1 minute to a thickness of about 20 μm. The wafer is then placed in a UV chamber and exposed to UV light (λ=365) for 10 minutes under a nitrogen purge. The thicker layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6.

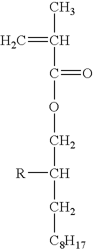

### Example 26

### Photocuring with Functional Monomers Available Post Cure Adhesion to PDMS

A liquid poly(dimethylsiloxane) precursor is poured over a microfluidics master containing 100-μm features in the shape of channels. The wafer is then placed in an oven at 80° C. for 3 hours. The cured PDMS layer is then removed, trimmed, and inlet holes are punched through it using a luer stub. The layer is then treated with an oxygen plasma for 20 minutes followed by treatment with a silane coupling agent, aminopropyltriethoxy silane. Separately a second master containing 100-μm features in the shape of channels is spin coated with a small drop of a liquid PFPE dimethacrylate precursor plus functional monomer (where R is an epoxy) plus a photoinitiator over top of it at 3700 rpm for 1 minute to a thickness of about 20 μm. The wafer is then placed in a UV chamber and exposed to UV light (λ=365) for 10 minutes under a nitrogen purge. The thicker PDMS layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6.

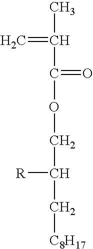

### Example 27

### Photocuring with Functional Monomers Available Post Cure Attachment of a Biomolecule

A liquid PFPE dimethacrylate precursor is blended with a monomer having the structure shown below (where R is an amine group) and blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. The fully cured layer is then removed from the master and inlet holes are punched using a luer stub. Separately a second master containing 100-μm features in the shape of channels is spin coated with a small drop of the liquid PFPE precursor plus functional (where R is an epoxy group) over top of it at 3700 rpm for 1 minute to a thickness of about 20 μm. The wafer is then placed in a UV chamber and exposed to UV light (λ=365) for 10 minutes under a nitrogen purge. The thicker layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6.

An aqueous solution containing a protein functionalized with a free amine is then flowed through the channel which is lined with unreacted epoxy moieties, in such a way that the channel is then functionalized with the protein.

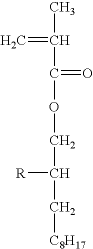

### Example 28

### Photocuring with Latent Functional Groups Available Post Cure Attachment of Charged Species

A liquid PFPE dimethacrylate precursor is blended with a monomer having the structure shown below (where R is an amine group) and blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. The fully cured layer is then removed from the master and inlet holes are punched using a luer stub. Separately a second master containing 100-μm features in the shape of channels is spin coated with a small drop of the liquid PFPE precursor plus functional (where R is an epoxy group) over top of it at 3700 rpm for 1 minute to a thickness of about 20 μm. The wafer is then placed in a UV chamber and exposed to UV light (λ=365) for 10 minutes under a nitrogen purge. The thicker layer is then placed on top of the 20-μm thick layer and aligned in the desired area to form a seal. The layers are then placed in an oven and allowed to heat at 65° C. for 2 hours. The thin layer is then trimmed and the adhered layers are lifted from the master. Fluid inlet holes and outlet holes are punched using a luer stub. The bonded layers are then placed on a glass slide treated with a silane coupling agent, aminopropyltriethoxy silane, and allowed to heat at 65° C. for 15 hours permanently bonding the device to the glass slide. Small needles can then be placed in the inlets to introduce fluids and to actuate membrane valves as reported by Unger, M. et al. Science. 2000, 288, 113-6. An aqueous solution containing a charged molecule functionalized with a free amine is then flowed through the channel which is lined with unreacted epoxy moieties, in such a way that the channel is then functionalized with the charged molecule.

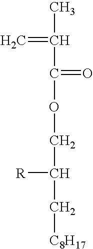

### Example 29

### Fabrication of a PFPE Microfluidic Device using Sacrificial Channels

A smooth, flat PFPE layer is generated by drawing a doctor's blade across a small drop of the liquid PFPE dimethacrylate precursor across a glass slide. The Slide is then placed in a UV chamber and exposed to UV light (λ=365) for 10 minutes under a nitrogen purge. A scaffold composed of poly(lactic acid) in the shape of channels is laid on top of the flat, smooth layer of PFPE. A liquid PFPE dimethacrylate precursor is with 1 wt % of a free radical photoinitiator and poured over the scaffold. A PDMS mold is used to contain the liquid in the desired area to a thickness of about 3 mm. The apparatus is then placed in a UV chamber and exposed to UV light (λ=365) for 10 minutes under a nitrogen purge. The device can then be heated at 150° C. for 24 hours to degrade the poly(lactic acid) thus revealing voids left in the shape of channels.

### Example 30

### Adhesion of a PFPE Device to Glass Using 185-nm Light

A liquid PFPE dimethacrylate precursor is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. Separately a second master containing 100-μm features in the shape of channels is spin coated with a small drop of the liquid PFPE precursor over top of it at 3700 rpm for 1 minute to a thickness of about 20 μm. The wafer is then placed in a UV chamber and exposed to UV light (λ=365) for 10 minutes under a nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 120° C. for 2 hours. The thin layer is then trimmed and the adhered layers are lifted from the master. Fluid inlet holes and outlet holes are punched using a luer stub. The bonded layers are then placed on a clean, glass slide in such a way that it forms as seal. The apparatus is exposed to 185 nm UV light for 20 minutes, forming a permanent bond between the device and the glass. Small needles can then be placed in the inlets to introduce fluids and to actuate membrane valves as reported by Unger. M. et al. Science. 2000, 288, 113-6.

### Example 31

### “Epoxy Casing” Method to Encapsulate Devices

A liquid PFPE dimethacrylate precursor is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. Separately a second master containing 100-μm features in the shape of channels is spin coated with a small drop of the liquid PFPE precursor over top of it at 3700 rpm for 1 minute to a thickness of about 20 μm. The wafer is then placed in a UV chamber and exposed to UV light (λ=365) for 10 minutes under a nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 120° C. for 2 hours. The thin layer is then trimmed and the adhered layers are lifted from the master. Fluid inlet holes and outlet holes are punched using a luer stub. The bonded layers are then placed on a clean, glass slide in such a way that it forms as seal. Small needles can then be placed in the inlets to introduce fluids and to actuate membrane valves as reported by Unger, M. et al. Science. 2000, 288, 113-6. The entire apparatus can then be encased in a liquid epoxy precursor which is poured over the device allowed to cure. The casing serves to mechanically bind the device the substrate.

### Example 32

### Fabrication of a PFPE Device from a Three-Armed PFPE Precursor

A liquid PFPE precursor having the structure shown below (where the circle represents a linking molecule) is blended with 1 wt % of a free radical photoinitiator and poured over a microfluidics master containing 100-μm features in the shape of channels. A PDMS mold is used to contain the liquid in the desired area to a thickness of about 3 mm. The wafer is then placed in a UV chamber and exposed to UV light (λ=365) for 10 minutes under a nitrogen purge. Separately a second master containing 100-μm features in the shape of channels is spin coated with a small drop of the liquid PFPE precursor over top of it at 3700 rpm for 1 minute to a thickness of about 20 μm. The wafer is then placed in a UV chamber and exposed to UV light (λ=365) for 10 minutes under a nitrogen purge. Thirdly a smooth, flat PFPE layer is generated by drawing a doctor's blade across a small drop of the liquid PFPE precursor across a glass slide. The Slide is then placed in a UV chamber and exposed to UV light (λ=365) for 10 minutes under a nitrogen purge. The thicker layer is then removed, trimmed, and inlet holes are punched through it using a luer stub. The layer is then placed on top of the 20-μm thick layer and aligned in the desired area to form a seal. The layers are then placed in an oven and allowed to heat at 120° C. for 2 hours. The thin layer is then trimmed and the adhered layers are lifted from the master. Fluid inlet holes and outlet holes are punched using a luer stub. The bonded layers are then placed on the fully cured PFPE smooth layer on the glass slide and allowed to heat at 120° C. for 15 hours. Small needles can then be placed in the inlets to introduce fluids and to actuate membrane valves as reported by Unger, M. et al. Science. 2000, 288, 113-6.

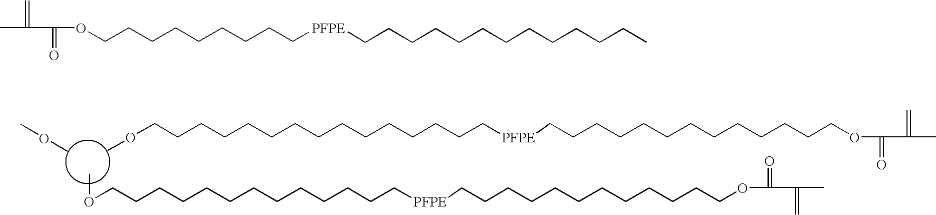

### Example 33

### Photocured PFPE/PDMS Hybrid

A master containing 100-μm features in the shape of channels is spin coated with a small drop of the liquid PFPE dimethacrylate precursor containing photoinitiator over top of it at 3700 rpm for 1 minute to a thickness of about 20 μm. A PDMS dimethacrylate containing photoinitiator is then poured over top of the thin PFPE layer to a thickness of 3 mm. The wafer is then placed in a UV chamber and exposed to UV light (λ=365) for 10 minutes under a nitrogen purge. The layer is then removed, trimmed, and inlet holes are punched through it using a luer stub. The hybrid device is then placed on a glass slide and a seal is formed. Small needles can then be placed in the inlets to introduce fluids.

### Example 34

### Microfluidic Device Formed From Blended Thermally and PhotoCurable Materials

Firstly, a predetermined amount, e.g., 5 grams, of a chain-extended PFPE dimethacrylate containing a small amount of photoinitiator, such as hydroxycyclohexylphenyl ketone, is measured. Next, a 1:1 ratio by weight, e.g., 5 grams, of a chain-extended PFPE diisocyanate is added. Next, an amount, e.g., 0.3 mL, of a PFPE tetrol (Mn˜2000 g/mol) is then added such that there is a stoichiometric amount of —N(C═O)— and —OH moieties. The three components are then mixed thoroughly and degassed under vacuum.

Master templates are generated using photolithography and are coated with a thin layer of metal, e.g., Gold/Palladium, using an Argon plasma. Thin layers for devices are spin coated at 1500 rpm from the PFPE blend onto patterned substrates. A thin, flat (non patterned), layer also is spin coated. Separately, thicker layers are cast onto the metal-coated master templates, typically by pooling the material inside, for example, a PDMS gasket. All layers are then placed in a UV chamber, purged with nitrogen for 10 minutes, and photocured for ten minutes into solid rubbery pieces under a thorough nitrogen purge. The layers can then be trimmed and inlet/outlet holes punched. Next the layers are stacked and aligned in registered positions such that they form a conformal seal. The stacked layers are then heated, at 105° C. for 10 minutes. The heating step initiates the thermal cure of the thermally curable material which is physically entangled in the photocured matrix. Because the layers are in conformal contact, strong adhesion is obtained. The two adhered layers can then be peeled from the patterned master or lifted off with a solvent, such as dimethyl formamide, and placed in contact with a third flat, photocured substrate which has not yet been exposed to heat. The three-layer device is then baked for 15 hours at 110° C. to fully adhere all three layers.

According to another embodiment, the thermal cure is activated at a temperature of between about 20 degrees Celsius (C) and about 200 degrees C. According to yet another embodiment, the thermal cure is activated at a temperature of between about 50 degrees Celsius (C) and about 150 degrees C. Further still, the thermal cure selected such that it is activated at a temperature of between about 75 degrees Celsius (C) and about 200 degrees C.

According to yet another embodiment, the amount of photocure substance added to the material is substantially equal to the amount of thermal cure substance. In a further embodiment, the amount of thermal cure substance added to the material is about 10 percent of the amount of photocure substance. According to another embodiment, the amount of thermal cure substance is about 50 percent of the amount of the photocure substance.

### Example 35

### Multicomponent Material for Fabricating Microfluidic Devices

The chemical structure of each component will be described below. In the following example, the first component (Component 1) is a chain extended, photocurable PFPE liquid precursor. The synthesis includes the chain extension of a commercially available PFPE diol (ZDOL) with a common diisocyanate, isophorone diisocyanate (IPDI), using classic urethane chemistry with an organo-tin catalyst. Following chain extension, the chain is end-capped with a methacrylate-containing diisocyanate monomer (EIM).

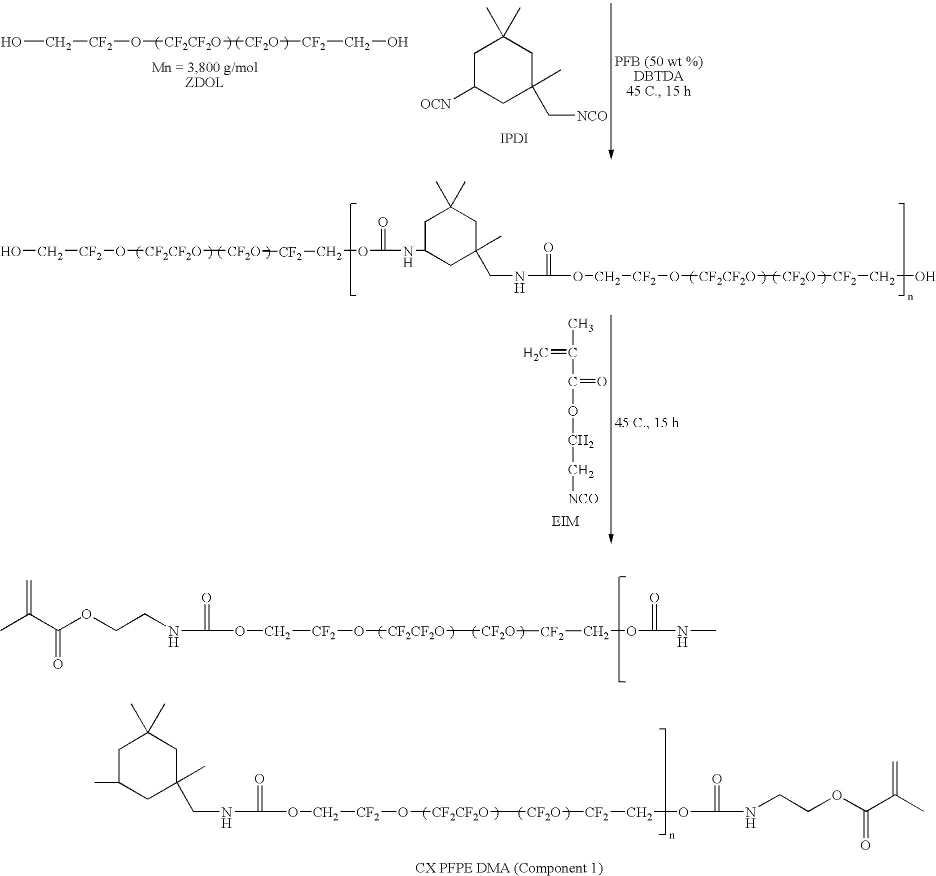

The second component is a chain-extended PFPE diisocyanate. It is made by the reaction of ZDOL with IPDI in a molar ratio such that the resulting polymer chain is capped with isocyanate groups (Component 2a). The reaction again makes use of classic urethane chemistry with an organo-tin catalyst.

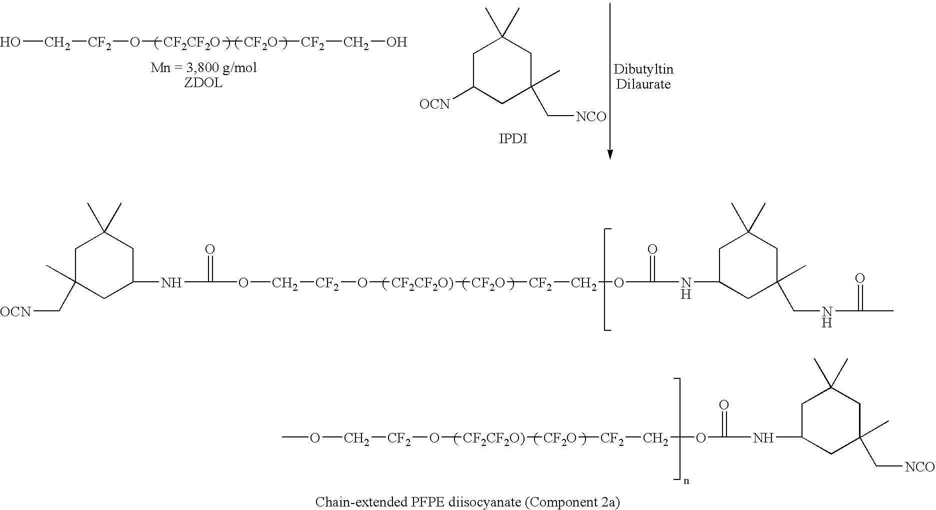

The second part of the thermally curable component is a commercially available perfluoropolyether tetraol with a molecular weight of 2,000 g/mol (Component 2b).

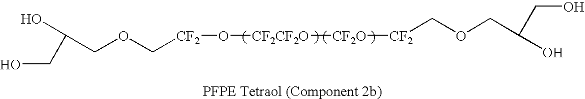

### Example 36

### Thin Film PFPE Alignment Layers

Liquid crystal optical cells were fabricated to examine the alignment characteristics of PFPE. The alignment layers were fabricated in accordance with the method shown in FIG. 9. Conductive glass substrates (coated with indium tin oxide (ITO)) were cleaned by sonication in ethanol for 30 min followed by UVO treatment for 20 min. A thin film of PFPE was deposited onto the clean substrate by spin-coating at 1000 RPM for 1 min. The PFPE film was cured by UV exposure under continuous nitrogen purge. The UV chamber was purged with nitrogen for 10 min. before curing, after which the film was exposed to UV radiation for 20 min. Upon curing, two PFPE coated substrates were sandwiched together, separated by a 40 μm spacer, and sealed with epoxy. The optical cell was then filled with a nematic LC, either 5CB (Δε>0) or MLC-6608 (Δε<0), by capillary action at a temperature above the nematic to isotropic transition temperature. These optical cells were then examined by transmitted polarized light microscopy between crossed polarizers. Images of the birefringent textures were then recorded by a CCD camera.

It was noted that PFPE generated spontaneous homeotropic alignment of the positive dielectric liquid crystal SCB, as shown in FIG. 14. This alignment was uniform over large length scales (several centimeters). The alignment of 5CB on PFPE was compared to that of MLC-6608, a negative dielectric liquid crystal, as shown in FIG. 15, parts A and B. Part A of FIG. 15 shows a polarizing micrograph showing homeotropic alignment of 5CB, while part B of FIG. 15 shows the spontaneous planar alignment of the negative dielectric LC MLC-6608. This alignment was not uniform, but exhibited domains of planar alignment. These alignment characteristics were confirmed to be unique to fluorinated materials. Control experiments using Teflon-AF and perfluorosilane alignment layers showed homeotropic alignment of 5CB and planar alignment of MLC-6608.

Similar experiments were carried out on bare glass substrates with the result being planar alignment, having random domains, of both 5CB and MLC-6608.

### Example 37

### Surface Energy measurement of Thin Film PFPE Alignment Layers

Thin films of PFPE were prepared for use in contact angle experiments. Conductive glass substrates (coated with indium tin oxide (ITO)) were cleaned by sonication in ethanol for 30 min followed by UVO treatment for 20 min. A thin film of PFPE was deposited onto the clean substrate by spin-coating at 1000 RPM for 1 min. The PFPE film was cured by UV exposure under continuous nitrogen purge. The UV chamber was purged with nitrogen for 10 min. before curing, after which the film was exposed to UV radiation for 20 min.

The static contact angles of water and ethylene glycol were measured for thin films of PFPE as well as thin films of Teflon-AF and polyimide, self-assembled monolayers of perfluorosilane, DMOAP and CTAB, and clean ITO coated glass using a standard goniometer. The surface energies of these materials were then calculated using the Owens-Wendt equation. A summary of the calculated surface energies is given in FIG. 13. It should be noted that the surface energy of fluorinated materials and specifically PFPE is much lower than that of standard alignment layers such as DMOAP and polyimide.

### Example 38

### Pretreatment or “Pickling” of Thin Film PFPE Alignment Layers

The influence of polar and non-polar environments on the LC alignment capabilities of PFPE was examined by means of pretreating or “pickling” thin films of PFPE. Conductive glass substrates (coated with indium tin oxide (ITO)) were cleaned by sonication in ethanol for 30 min followed by UVO treatment for 20 min. A thin film of PFPE was deposited onto the clean substrate by spin-coating at 1000 RPM for 1 min. The PFPE film was cured by UV exposure under continuous nitrogen purge. The UV chamber was purged with nitrogen for 10 min. before curing, after which the film was exposed to UV radiation for 20 min. Upon curing, the PFPE coated substrate was immersed in either toluene or water overnight and dried by one of three methods: with stream of nitrogen gas, in air overnight, or under vacuum. All drying methods yielded the same alignment results. Once dry, two PFPE coated substrates “pickled” in the same solvent were sandwiched together, separated by a 40 μm spacer, and sealed with epoxy. The optical cell was then filled with a nematic LC, either 5CB (Δε>0) or MLC-6608 (Δε<0), by capillary action at a temperature above the nematic to isotropic transition temperature. These optical cells were then examined by transmitted polarized light microscopy between crossed polarizers. Images of the birefringent textures were then recorded by a CCD camera.

The LC birefringent textures of optical cells using PFPE alignment layers “pickled” in toluene are shown in FIG. 16, parts A and B. Homeotropic alignment of both positive and negative dielectric LCs is achieved with these substrates. PFPE alignment layers “pickled” in water have a very different orienting effect on the LC director, as shown in FIG. 17, parts A and B. In FIG. 17, parts A and B show planar alignment of both the positive and negative dielectric LCs. However, this planar alignment appears to have a high pretilt angle, thus the decrease in contrast between the dark and bright states.

Similar experiments were carried out on bare glass substrates with the result being planar alignment, having random domains, of both 5CB and MLC-6608.

### Example 39

### PFPE Langmuir-Blodgett Films Alignment Layers

Liquid crystal optical cells were fabricated to examine the alignment characteristics of Langmuir-Blodgett (LB) films of PFPE, as shown in FIG. 18, parts A, B, and C. Conductive glass substrates (coated with indium tin oxide (ITO)) were cleaned by sonication in ethanol for 30 min followed by UVO treatment for 20 min. A standard Langmuir-Blodgett trough (KSV Instruments) was cleaned with butyl acetate and calibrated by standard method. A solution of 0.5 wt % PFPE in Solkane was prepared and deposited dropwise on the water layer in the trough. LB films of one, five and ten layer thicknesses were prepared at a surface pressure of 2 mN/m and dipping rate of 1.0 mm/min. The PFPE LB films were cured by UV exposure under continuous nitrogen purge. The UV chamber was purged with nitrogen for 10 min. before curing, after which the film was exposed to UV radiation for 20 min. Upon curing, two PFPE LB films, having the same number of layers, were sandwiched together, separated by a 40 μm spacer, and sealed with epoxy. The optical cell was then filled with a nematic LC, either 5CB (Δε>0) or MLC-6608 (Δε<0), by capillary action at a temperature above the nematic to isotropic transition temperature. These optical cells were then examined by transmitted polarized light microscopy between crossed polarizers. Images of the birefringent textures were then recorded by a CCD camera. FIG. 18, parts A, B, and C show the LC alignment behavior of PFPE LB films. LB films of one, five and ten layer thicknesses all exhibited fairly uniform planar alignment of both positive (5CB) and negative (MLC-6608) dielectric LCs.

FIG. 19 is a tabular summary of the LC alignment results of the experiments discussed above.

### Example 40

### Embossed PFPE Alignment Layers

Liquid crystal optical cells were fabricated to examine the alignment characteristics of embossed films of PFPE. Conductive glass substrates (coated with indium tin oxide (ITO)) were cleaned by sonication in ethanol for 30 min followed by UVO treatment for 20 min. Several drops of PFPE were sandwiched between the clean substrate and the master, a holographic diffraction grating having a sinusoidal profile, as shown in FIG. 20. The PFPE film was cured by UV exposure under continuous nitrogen purge. The UV chamber was purged with nitrogen for 10 min. before curing, after which the film was exposed to UV radiation for 20 min. Upon curing, the diffraction grating was removed and both the diffraction grating and the PFPE films were examined by atomic force microscopy (AFM). AFM images confirm that the sinusoidal pattern of the diffraction grating was perfectly embossed in the PFPE film, as shown in FIG. 22. Two embossed PFPE films, having the same pattern, were sandwiched together, separated by a 40 μm spacer, and sealed with epoxy. The optical cell was then filled with a nematic LC 5CB (Δε>0) by capillary action at a temperature above the nematic to isotropic transition temperature. These optical cells were then examined by transmitted polarized light microscopy between crossed polarizers. Images of the birefringent textures were recorded by a CCD camera.

FIG. 23 shows that macroscopic, uniform planar alignment is achieved using an embossed alignment layer with a groove spacing of 3600 grooves per mm. Planar alignment was also achieved with a grooved alignment layer of the spacing 1200 grooves per mm. FIG. 24 shows planar alignment achieved using a PFPE film embossed with a sharkskin pattern. Theoretically, PFPE films embossed with any pattern having ideal groove spacing would generate planar alignment of nematic LCs.

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A liquid crystal display comprising a layer of a low surface energy polymeric material, wherein a surface of the layer comprises a molded pattern.

2. The liquid crystal display of claim 1, wherein the low surface energy polymeric material comprises a first alignment layer.

3. The liquid crystal display of claim 1, wherein the low surface energy polymeric material further comprises a photo-curable agent.

4. The liquid crystal display of claim 1, wherein the low surface energy polymeric material further comprises a thermal-curable agent

5. The liquid crystal display of claim 1, wherein the low surface energy polymeric material further comprises photo-curable and thermal-curable agents.

6. The liquid crystal display of claim 1, wherein the low surface energy polymeric material comprises perfluoropolyether (PFPE).

7. The liquid crystal display of claim 1, wherein the low surface energy polymeric material comprises fluoroolefin-based fluoroelastomers.

8. The liquid crystal display of claim 1, wherein the low surface energy polymeric material is poly(dimethylsiloxane) (PDMS), poly(tetramethylene oxide), poly(ethylene oxide), poly(oxetanes), polyisoprene, polybutadiene, or mixtures thereof.

9. The liquid crystal display of claim 1, further comprising a metal oxide distributed throughout the low surface energy polymeric material.

10. The liquid crystal display of claim 9, wherein the metal oxide is distributed substantially uniformly within the low surface energy polymeric material.

11. The liquid crystal display of claim 2, further comprising a second alignment layer, wherein the second alignment layer is coupled with the first alignment layer.

12. The liquid crystal display of claim 11, further comprising liquid crystal dispersed between the first alignment layer and the second alignment layer.

13. The liquid crystal display of claim 11, further comprising low-molar-mass liquid crystal dispersed between the first alignment layer and the second alignment layer.

14. The liquid crystal display of claim 13, wherein the liquid crystal comprises a molar mass of between about 100 and about 2000.

15. The liquid crystal display of claim 11, wherein the first alignment layer is spaced apart from the second alignment layer less than 100 μm.

16. The liquid crystal display of claim 11, wherein the first alignment layer is spaced apart from the second alignment layer between about 5 μm and about 80 μm.

17. The liquid crystal display of claim 11, wherein the first alignment layer is spaced apart from the second alignment layer about 40 μm.

18. The liquid crystal display of claim 11, wherein the first alignment layer and the second alignment layer are positioned at an angle with respect to one another.

19. The liquid crystal display of claim 11, wherein the first alignment layer and the second alignment layer are oriented at about a 90 degree angle with respect to one another.

20. The liquid crystal display of claim 1, wherein the molded pattern comprises grooves.

21. The liquid crystal display of claim 20, wherein the grooves are between about 0.1 μm and about 2 μm in width.

22. The liquid crystal display of claim 20, wherein the grooves are between about 0.3 μm and about 0.7 μm in width.

23. The liquid crystal display of claim 1, wherein the layer is less than about 2 m in length and less than about 2 m in height.

24. The liquid crystal display of claim 20, wherein the grooves are less than about 2 meters in length.

25. The liquid crystal display of claim 20, wherein the grooves are less than about 2 cm in length.

26. The liquid crystal display of claim 1, wherein the molded pattern comprises a regular grid pattern.

27. The liquid crystal display of claim 1, wherein the low surface energy polymeric material defines a plurality of through-holes.

28. The liquid crystal display of claim 27, wherein the through-holes have an average diameter of less than about 20 μm.

29. The liquid crystal display of claim 27, wherein the through-holes have an average diameter of between about 20 nm and about 10 μm.

30. The liquid crystal display of claim 27, wherein the through-holes have an average diameter of between about 0.1 μm and about 7 μm.

31. The liquid crystal display of claim 1, wherein the layer is between about 10 angstroms and about 1,000 angstroms thick.

32. The liquid crystal display of claim 1, wherein the layer is between about 5 angstroms and about 200 angstroms thick.

33. The liquid crystal display of claim 2, further comprising a second alignment layer, wherein the first and second alignment layers have a molded pattern configured on a surface thereof.

34. The liquid crystal display of claim 33, wherein the molded pattern on the first alignment layer is different from the molded pattern on the second alignment layer.

35. The liquid crystal display of claim 34, wherein the first alignment layer comprises no molded pattern and is in communication with a surface of the second alignment layer that includes the molded pattern.

36. The liquid crystal display of claim 2, wherein the alignment layer is configured as a Langmuir-Blodgett film and comprises multiple thin film layers of a fluorinated polymer.

37. The liquid crystal display of claim 1, wherein the molded pattern includes between about 1000 grooves per mm and about 4000 grooves per mm.

38. The liquid crystal display of claim 1, wherein the molded pattern includes between about 1200 grooves per mm and about 3600 grooves per mm.

39. The liquid crystal display of claim 1, wherein the molded pattern includes more than about 1200 grooves per mm.

40. The liquid crystal display of claim 1, wherein the molded pattern includes less than about 3600 grooves per mm.

41. The liquid crystal display of claim 1, wherein the low surface energy polymeric material has a surface energy of less than about 30 mN/m.

42. The liquid crystal display of claim 1, wherein the low surface energy polymeric material has a surface energy of between about 7 mN/m and about 20 mN/m.

43. The liquid crystal display of claim 1, wherein the low surface energy polymeric material has a surface energy of between about 5 mN/m and about 15 mN/m.

44. The liquid crystal display of claim 1, further comprising:
a microphase separated structure;
a copolymer; and
a block copolymer.

45. A liquid crystal display, comprising:
a layer of molded low surface energy polymeric material, wherein the layer is treated with a treatment selected from the group consisting of an electrical conductor, metal nanoparticles, metal oxide, conducting polymer, toluene, and water.

46. A display screen comprising a low surface energy polymeric alignment layer, wherein the display screen is flexible up to a radius of curvature of about 90 degrees.

47. A display screen, comprising:
a low surface energy polymeric alignment layer;
a molded pattern configured on a surface of the alignment layer;
liquid crystals disposed on the molded pattern, wherein the liquid crystals undergo spontaneous alignment on the low surface energy polymeric alignment layer.

48. The display screen of claim 47, wherein the alignment of the liquid crystals changes with an applied voltage.

49. A method of fabricating a display screen alignment layer, comprising:
providing a patterned template;
depositing a liquid low surface energy polymeric material onto the patterned template, wherein the liquid polymer comprises a curing agent;
activating the curing agent to cure the liquid low surface energy polymeric material; and
removing the cured low surface energy polymeric material from the patterned template, wherein a replica of the patterned template is embossed on a surface of the cured low surface energy polymeric material.

50. The method of claim 49, wherein the curing agent comprises a photo-curing agent.

51. The method of claim 49, wherein the curing agent comprises a thermal-curing agent.

52. The method of claim 49, wherein the curing agent comprises photo-curable and thermal-curable agents.

53. The method of claim 49, wherein the low surface energy polymeric material has a surface energy of less than about 30 mN/m.

54. The method of claim 49, wherein the low surface energy polymeric material has a surface energy of between about 7 mN/m and about 20 mN/m.

55. The method of claim 49, wherein the low surface energy polymeric material has a surface energy of between about 5 mN/m and about 15 mN/m.

56. The method of claim 49, wherein the low surface energy polymeric material comprises perfluoropolyether (PFPE).

57. The method of claim 49, further comprising depositing a low-molar-mass liquid crystal into communication with the embossed pattern of the cured low surface energy polymeric material.

58. The method of claim 49, wherein the embossed pattern comprises grooves.

59. The method of claim 58, wherein the grooves are between about 0.1 μm and about 2 μm in width.

60. The method of claim 58, wherein the grooves are between about 0.3 μm and about 0.7 μm in width.

61. The method of claim 58, wherein the grooves are less than about 2 meters in length.

62. The method of claim 58, wherein the grooves are less than about 2 cm in length.

63. The method of claim 58, wherein the embossed pattern comprises a regular pattern.

64. The method of claim 49, wherein the embossed pattern defines a plurality of through-holes.

65. The method of claim 64, wherein the through-holes have an average diameter of less than about 20 μm.

66. The method of claim 49, wherein the layer is between about 10 angstroms and about 1,000 angstroms thick.

67. The method of claim 49, wherein the layer is between about 5 angstroms and about 200 angstroms thick.

68. The method of claim 49, wherein the embossed pattern includes between about 1000 grooves per mm and about 4000 grooves per mm.

69. The method of claim 49, wherein the embossed pattern includes between about 1200 grooves per mm and about 3600 grooves per mm.

70. A pixel, comprising a layer of low surface energy polymeric material, wherein a surface of the layer comprises a molded pattern configured thereon.

71. The pixel of claim 70, wherein the low surface energy polymer material further comprising a photo-curing agent.

72. The pixel of claim 70, wherein the low surface energy polymer material further comprising a thermal-curing agent.

73. The pixel of claim 70, wherein the low surface energy polymer material further comprising a photo-curable and thermal-curable agent.

74. The pixel of claim 70, wherein the low surface energy polymeric material has a surface energy of between about 7 mN/m and about 20 mN/m.

75. The pixel of claim 70, wherein the low surface energy polymeric material comprises perfluoropolyether (PFPE).

76. The pixel of claim 70, further comprising a low-molar-mass liquid crystal in communication with the molded pattern of the low surface energy polymeric material.

77. The pixel of claim 70, wherein the molded pattern comprises grooves.

78. The pixel of claim 77, wherein the grooves are between about 0.1 μm and about 2 μm in width.

79. The pixel of claim 70, wherein the molded pattern defines a plurality of through-holes.

80. The pixel of claim 79, wherein the through-holes have an average diameter of less than about 20 μm.

81. The pixel of claim 70, wherein the layer is between about 10 angstroms and about 1,000 angstroms thick.

82. The pixel of claim 70, wherein the layer is between about 5 angstroms and about 200 angstroms thick.

83. The pixel of claim 70, wherein the molded pattern includes between about 1000 grooves per mm and about 4000 grooves per mm.

84. A liquid crystal display comprising a first alignment layer formed from a PFPE liquid precursor.

85. The liquid crystal display of claim 84, wherein the PFPE liquid precursor includes a photo-curable agent.

86. The liquid crystal display of claim 84, wherein the PFPE liquid precursor includes a thermal-curable agent

87. The liquid crystal display of claim 84, wherein the PFPE liquid precursor includes a photo-curable and a thermal-curable agent.

88. The liquid crystal display of claim 84, wherein the PFPE liquid precursor further comprises a metal oxide.

89. The liquid crystal display of claim 88, wherein the metal oxide is distributed substantially uniformly within the PFPE liquid precursor.

90. The liquid crystal display of claim 84, further comprising a second alignment layer, wherein the second alignment layer is coupled with the first alignment layer.

91. The liquid crystal display of claim 90, further comprising liquid crystal dispersed between the first alignment layer and the second alignment layer.

92. The liquid crystal display of claim 90, further comprising low-molar-mass liquid crystal dispersed between the first alignment layer and the second alignment layer.

93. The liquid crystal display of claim 92, wherein the liquid crystal comprises a molar mass of between about 100 and about 2000.

94. The liquid crystal display of claim 90, wherein the first alignment layer is spaced apart from the second alignment layer between about 5 μm and about 100 μm.

95. The liquid crystal display of claim 90, wherein the first alignment layer and the second alignment layer are positioned at an angle with respect to one another.

96. The liquid crystal display of claim 84, further comprising a molded pattern on a surface on the first alignment layer.

97. The liquid crystal display of claim 96, wherein the molded pattern comprises grooves.

98. The liquid crystal display of claim 97, wherein the grooves are between about 0.1 μm and about 2 μm in width.

99. The liquid crystal display of claim 84, wherein the first alignment layer is less than about 2 m in length and less than about 2 m in height.

100. The liquid crystal display of claim 97, wherein the grooves are less than about 2 meters in length.

101. The liquid crystal display of claim 97, wherein the grooves are less than about 2 cm in length.

102. The liquid crystal display of claim 84, wherein the first alignment layer defines a plurality of through-holes.

103. The liquid crystal display of claim 102, wherein the through-holes have an average diameter of less than about 20 μm.

104. The liquid crystal display of claim 102, wherein the through-holes have an average diameter of between about 20 nm and about 10 μm.

105. The liquid crystal display of claim 102, wherein the through-holes have an average diameter of between about 0.1 μm and about 7 μm.

106. The liquid crystal display of claim 84, wherein the first alignment layer is between about 10 angstroms and about 1,000 angstroms thick.

107. The liquid crystal display of claim 84, wherein the first alignment layer is between about 5 angstroms and about 200 angstroms thick.

108. The liquid crystal display of claim 84, further comprising a second alignment layer formed from a PFPE liquid precursor, wherein the first and second alignment layers have a molded pattern configured on a surface thereof.

109. The liquid crystal display of claim 84, further comprising a second alignment layer, wherein a surface of the second alignment layer comprises a molded pattern.

110. The liquid crystal display of claim 84, wherein the first alignment layer is configured as a Langmuir-Blodgett film and comprises multiple layers.

111. The liquid crystal display of claim 96, wherein the molded pattern includes between about 1000 grooves per mm and about 4000 grooves per mm.

112. The liquid crystal display of claim 84, wherein the molded pattern includes more than about 3600 grooves per mm.

113. The liquid crystal display of claim 84, wherein the first alignment layer has a surface energy of between about 5 mN/m and about 15 mN/m.

114. A liquid crystal display comprising a first PFPE alignment layer, wherein the PFPE comprises a curable agent.

115. The liquid crystal display of claim 114, wherein the curable agent comprises a photo-curable agent.

116. The liquid crystal display of claim 114, wherein the curable agent comprises a thermal-curable agent.

117. The liquid crystal display of claim 114, wherein the curable agent comprises a photo-curable agent and a thermal-curable agent.

118. The liquid crystal display of claim 114, wherein the PFPE liquid precursor further comprises a metal oxide.

119. The liquid crystal display of claim 114, further comprising a second alignment layer, wherein the second alignment layer is coupled with the first alignment layer.

120. The liquid crystal display of claim 119, further comprising low-molar-mass liquid crystal positioned between the first PFPE alignment layer and the second alignment layer.

121. The liquid crystal display of claim 119, wherein the first PFPE alignment layer is spaced apart from the second alignment layer between about 5 μm and about 100 μm.

122. The liquid crystal display of claim 119, wherein the first PFPE alignment layer and the second alignment layer are positioned at an angle with respect to one another.

123. The liquid crystal display of claim 114, further comprising a molded pattern on a surface on the first PFPE alignment layer.

124. The liquid crystal display of claim 123, wherein the molded pattern comprises grooves.

125. The liquid crystal display of claim 124, wherein the grooves are between about 0.1 μm and about 2 μm in width.

126. The liquid crystal display of claim 114, wherein the first PFPE alignment layer is less than about 2 m in length and less than about 2 m in height.

127. The liquid crystal display of claim 124, wherein the grooves are less than about 2 meters in length.

128. The liquid crystal display of claim 124, wherein the grooves are less than about 2 cm in length.

129. The liquid crystal display of claim 123, wherein the molded pattern comprises a regular grid pattern.

130. The liquid crystal display of claim 114, wherein the first PFPE alignment layer defines a plurality of through-holes.

131. The liquid crystal display of claim 130, wherein the through-holes have an average diameter of between about 20 nm and about 10 μm.

132. The liquid crystal display of claim 130, wherein the through-holes have an average diameter of between about 0.1 μm and about 7 μm.

133. The liquid crystal display of claim 114, wherein the first PFPE alignment layer is between about 10 angstroms and about 1,000 angstroms thick.

134. The liquid crystal display of claim 114, wherein the first PFPE alignment layer is between about 5 angstroms and about 200 angstroms thick.

135. The liquid crystal display of claim 114, further comprising a second alignment layer formed from a PFPE liquid precursor, wherein the first and second alignment layers have a molded pattern configured on surfaces thereof.

136. The liquid crystal display of claim 114, further comprising a second alignment layer, wherein a surface of the second alignment layer comprises a molded pattern.

137. The liquid crystal display of claim 123, wherein the molded pattern includes between about 1000 grooves per mm and about 4000 grooves per mm.

138. The liquid crystal display of claim 114, wherein the first PFPE alignment layer has a surface energy of between about 5 mN/m and about 15 mN/m.

139. A method of fabricating a display screen alignment layer, comprising:
forming an alignment layer from a PFPE liquid precursor, wherein the PFPE liquid precursor includes a curing agent.

140. The method of claim 139, wherein the curing agent is selected from the group consisting of a photo-curing agent, a thermal-curing agent, and a combination of photo-curing and thermal-curing agents.
